(19) United States
(12) Patent Application Publication
(10) Pub. No.: US 2011/0246791 A1
(43) Pub. Date: Oct. 6, 2011

(54) MEMORY CHIP, INFORMATION STORING SYSTEM, AND READING DEVICE

(75) Inventors: Toru Kambayashi, Kanagawa (JP); Taku Kato, Kanagawa (JP); Hiroshi Sukegawa, Tokyo (JP); Yoshihiko Hirose, Kanagawa (JP); Koichi Fujisaki, Kanagawa (JP)

(73) Assignee: KABUSHIKI KAISHA TOSHIBA, Tokyo (JP)

(21) Appl. No.: 12/880,513

(22) Filed: Sep. 13, 2010

(30) Foreign Application Priority Data
Mar. 31, 2010 (JP) 2010-084335

(51) Int. Cl. G06F 12/14

(52) U.S. Cl. 713/193

(57) ABSTRACT

According to one embodiment, a memory chip, which is connected to a writing device that writes data and to a reading device that reads data, includes: a memory including a first area that is a predetermined data storage area; a second encryption key generating unit that receives second key information stored in the reading device and generates a third key; and a sending unit that transmits, to the reading device, second encrypted data obtained by encrypting data stored in the memory using the third key. The second encrypted data is received by the reading device and is decrypted by using a fourth key that is stored in the reading device and that corresponds to the third key.

### CROSS-REFERENCE TO RELATED APPLICATIONS

This application is based upon and claims the benefit of priority from Japanese Patent Application No. 2010-084335, filed on Mar. 31, 2010; the entire contents of which are incorporated herein by reference.

### FIELD

Embodiments described herein relate generally to a memory chip, an information storing system, and a reading device.

### BACKGROUND

A semiconductor memory chip provided on a semiconductor die is not usually used by itself, but is used while being electrically connected to a controller provided on the outside thereof. An external device (e.g., a writing device, a reading device, or a playback device) accesses data stored in a memory included in the semiconductor memory chip via a controller. In some situations, a controller and a semiconductor memory chip are combined together and sold as a memory product. For instance, examples of such memory products include merchandise such as Secure Digital (SD) memory cards. In some other situations, a product obtained by adhering a semiconductor memory chip to a controller with the use of a resin is provided as a System In Package (SIP). Further, in the case where a semiconductor memory chip is employed in an audio player or the like for the purpose of storing music data therein, the controller may be incorporated in a part of another semiconductor that is different from the semiconductor memory chip. In any of these situations, the semiconductor memory chip is directly connected to the controller, so that the access to the data stored in the memory included in the semiconductor memory chip is always made via the controller.

The controller not only intermediates the access to the data stored in the semiconductor memory chip, but also provides a security function in some situations. For example, for SD memory cards, a copyright protecting function has been introduced to the controller. The controller is configured so as to authenticate a host device such as a player or a writing device, so that, only if the host device has successfully been authenticated, the controller allows the data stored in the semiconductor memory chip to be transferred to the host device. Further, only if a writing device has successfully been authenticated, the controller records the data received from the writing device into the semiconductor memory chip. With these arrangements, an illegitimate player that has not been authenticated, for example, is not able to access the data stored in the memory card. Accordingly, it is possible to protect the data stored in the memory card from being stolen by the illegitimate player.

Even in the situation where the copyright protecting function is realized by the controller for the memory card, other types of attacks may occur. For example, let us assume that video data is stored in a memory card. The video data stored in the memory card is protected from being read by an illegitimate player because of the copyright protecting function of the controller for the memory card. Thus, the video data is protected from illegitimate copying that uses an illegitimate player.

Writing target data is stored (written) into the semiconductor memory chip and is read by a reading device.

To read the writing target data by using the reading device and utilize the read data, it is desirable if the authenticity of the data is guaranteed.

### BRIEF DESCRIPTION OF THE DRAWINGS

FIG. 1AA is a diagram of an example of a trust chain;

FIG. 1AB is a diagram of a data flow in the trust chain;

FIG. 1B is a block diagram of a semiconductor memory chip, a controller, and a writing device according to a first embodiment;

FIG. 1C is a block diagram of details of the first embodiment;

FIG. 1D is a flowchart of a flow in a writing process according to the first embodiment;

FIG. 1EA is a diagram of a data flow according to a specific mode of use;

FIG. 1EB is a diagram of an example of a trust chain according to the specific mode of use;

FIG. 1F is a block diagram of details of a specific mode of use;

FIG. 1G is a diagram of exemplary configurations of encryption key sharing units;

FIG. 1H is a flowchart of an operation performed by the encryption key sharing units;

FIG. 1J is a block diagram of a sending control unit and a reading control unit;

FIG. 1K is a flowchart of an operation performed by the sending control unit and the reading control unit;

FIG. 1L is a flowchart of an operation that is performed when a game computer-program is executed;

FIG. 1M is a block diagram of a configuration according to a mode in which a Media Key Block (MKB) is used;

FIG. 1N is a block diagram of encryption key sharing units according to the mode in which an MKB is used;

FIG. 1P is a block diagram of a data transmitting unit and a data converting unit according to the mode in which an MKB is used;

FIG. 1Q is a flowchart of an operation according to the mode in which an MKB is used;

FIG. 1R is a block diagram of an example of a configuration of the data converting unit included in a semiconductor memory chip;

FIG. 1S is a flowchart of an operation performed by an example of the data converting unit;

FIG. 1TA is a drawing explaining a structure of electronic book data;

FIG. 1TB is a block diagram of an exemplary configuration of a semiconductor memory package and a writing device;

FIG. 1TC is a diagram of an example of a writing target page;

FIG. 1TD is a diagram of exemplary configurations of encryption key sharing units;

FIG. 1TE is a diagram of an exemplary configuration of a second data converting unit;

FIG. 1TF is a diagram of an exemplary configuration of data to be transmitted to a memory chip interface;

FIG. 1TG is a diagram of an exemplary configuration of data to be transmitted to a first converting unit;

FIG. 1TH is a diagram of an exemplary configuration of the first data converting unit;

FIG. 1TJ is a diagram of an exemplary configuration of a data sending unit;

FIG. 1TK is a drawing explaining a generating process of data to be transmitted to the memory chip interface;

FIG. 1TL is a flowchart of a writing operation;

FIG. 1TM is a flowchart of an example of a procedure to share a key;

FIG. 1UA is a diagram of an example of a trust chain in a situation where an embodiment is applied to a smart grid;

FIG. 1UB is a diagram of an example of a data flow in the situation where the embodiment is applied to a smart grid;

FIG. 1UC is a diagram of an example of a data flow in the situation where the embodiment is applied to a smart grid;

FIG. 1V is a diagram of an exemplary configuration of a semiconductor memory chip, a Meter Data Management System (MDMS), and a meter;

FIG. 1WA is a diagram of exemplary configurations of encryption key sharing units;

FIG. 1WB is a diagram of exemplary configurations of a sending control unit and a reading control unit;

FIG. 1XA is a diagram of exemplary configurations of encryption key sharing units that are respectively included in a semiconductor memory chip and a meter;

FIG. 1XB a diagram of exemplary configurations of a data converting unit and a data transmitting unit;

FIG. 1YA is a diagram of an example of a reading procedure performed by an MDMS;

FIG. 1YB is another diagram of the example of the reading procedure performed by the MDMS;

FIG. 2A is a diagram of an example of a trust chain;

FIG. 2B is a block diagram of a semiconductor memory chip and a controller according to a second embodiment;

FIG. 3A is a diagram of exemplary configurations of encryption key sharing units;

FIG. 3B is a diagram of an example of a mechanism in which a media key is updated;

FIG. 4A is a flowchart of an entire flow in an encryption key sharing process according to the second embodiment;

FIG. 4B is a chart of an example of an operation to update a media key;

FIG. 5 is a diagram of exemplary configurations of a sending control unit and a reading control unit;

FIG. 6 is a flowchart of an entire flow in a data reading process according to the second embodiment;

FIG. 7 is a diagram of modification examples of encryption key sharing units;

FIG. 8 is a flowchart of an entire flow in an encryption key sharing process according to a modification example of the second embodiment;

FIG. 9 is a diagram of a modification example of a sending control unit and a reading control unit;

FIG. 10 is a flowchart of an entire flow in a data reading process according to a modification example of the second embodiment;

FIG. 11A is a diagram of another modification example of the sending control unit and the reading control unit;

FIG. 11B is a flowchart of an entire flow in a data reading process according to another modification example of the second embodiment;

FIG. 12A is a diagram of an exemplary configuration of an encryption key sharing unit included in a semiconductor memory chip in a situation where an authentication process is performed by using a public key;

FIG. 12B is a diagram of an exemplary configuration of an encryption key sharing unit included in a controller in the situation where an authentication process is performed by using a public key;

FIG. 12C is a flowchart of an example of an operation performed by encryption key sharing units;

FIG. 12D is a diagram of an exemplary configuration of a sending control unit included in a semiconductor memory chip;

FIG. 12E is a diagram of an exemplary configuration of a reading control unit included in a controller;

FIG. 12F is a diagram of an example of a format of data to be transmitted to the controller;

FIG. 12G is a chart of an example of an operation performed by a sending control unit included in the semiconductor memory chip and a reading control unit included in the controller;

FIG. 12H is another chart of the example of the operation performed by the sending control unit included in the semiconductor memory chip and the reading control unit included in the controller;

FIG. 12J is a diagram of an exemplary configuration in a situation where a utilizing device is authenticated by a semiconductor memory chip;

FIG. 12K is a diagram of a trust chain in the situation where the utilizing device is authenticated by the semiconductor memory chip;

FIG. 13 is a diagram explaining a manner in which data is written into a writing special area;

FIG. 14 is a diagram of exemplary configurations of a writing control unit and a data converting unit;

FIG. 15 is a flowchart of an entire flow in a writing process according to the second embodiment;

FIG. 16 is a drawing explaining changes in data in a configuration where only minimum data is encrypted and decrypted;

FIG. 17A is a diagram of modification examples of the writing control unit and the data converting unit;

FIG. 17B is a diagram of an exemplary configuration in which a writing device writes data via a controller;

FIG. 17C is a flowchart of an example of an operation to write data;

FIG. 17D is another flowchart of the example of the operation to write data;

FIG. 18 is a drawing of an example of a data structure of a key storage unit;

FIG. 19 is a flowchart of an entire flow in a writing process according to a modification example;

FIG. 20 is a drawing of a modification example of version information;

FIG. 21 is a block diagram of a semiconductor memory chip according to a third embodiment;

FIG. 22 is a diagram of exemplary configurations of a receiving control unit and a writing device according to the third embodiment;

FIG. 23 is a flowchart of an entire flow in a writing process according to the third embodiment;

FIG. 24 is a diagram of an exemplary configuration of a data converting unit according to the third embodiment;

FIG. 25 is a flowchart of an entire flow in a data reading process according to the third embodiment;

FIG. 26 is a block diagram of a player and a memory card according to a fourth embodiment;

FIG. 27 is a flowchart of an entire flow in a playback process according to the fourth embodiment;

FIG. 28 is a block diagram of a player and a memory card according to a fifth embodiment;

FIG. 29 is a flowchart of an entire flow in a playback process according to the fifth embodiment;

FIG. 30 is a diagram of an exemplary configuration of a next-generation electric power grid according to a sixth embodiment; and

FIG. 31 is a block diagram of an exemplary configuration of a meter.

### DETAILED DESCRIPTION

In general, according to one embodiment, a memory chip, which is connected to a writing device that writes data and to a reading device that reads data, includes: a memory including a first area that is a predetermined data storage area; a second encryption key generating unit that receives second key information stored in the reading device and generates a third key; and a sending unit that transmits, to the reading device, second encrypted data obtained by encrypting data stored in the memory using the third key. The second encrypted data is received by the reading device and is decrypted by using a fourth key that is stored in the reading device and that corresponds to the third key.

Exemplary embodiments of a memory chip will be explained in detail with reference to the accompanying drawings.

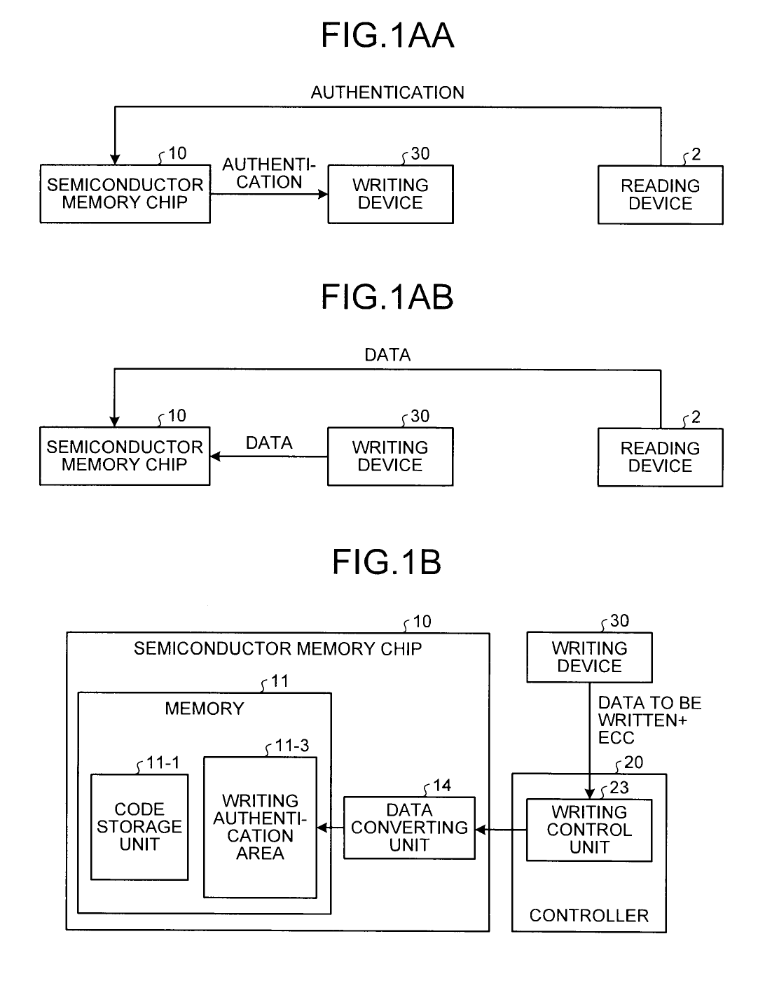

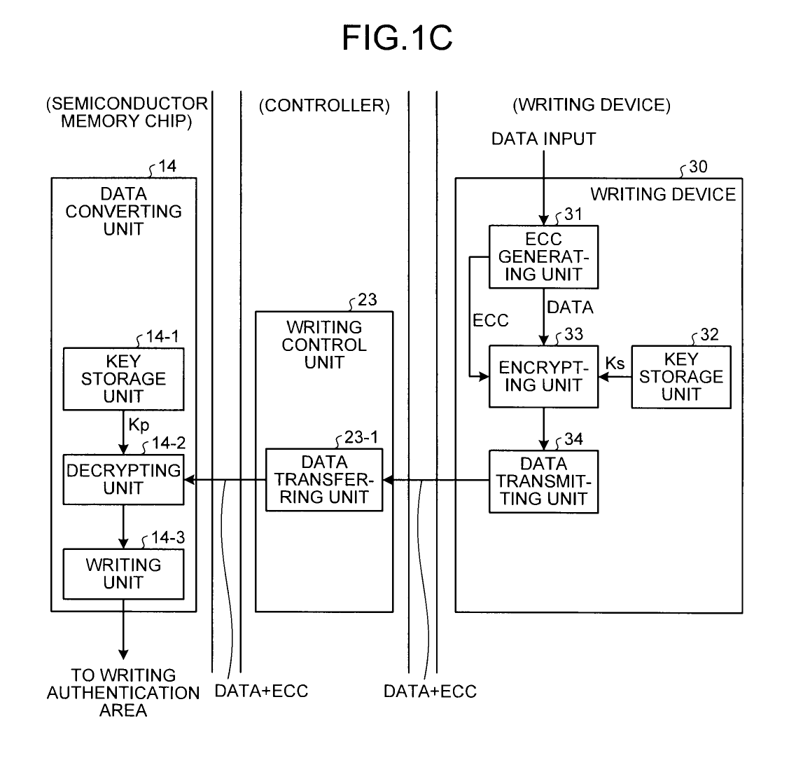

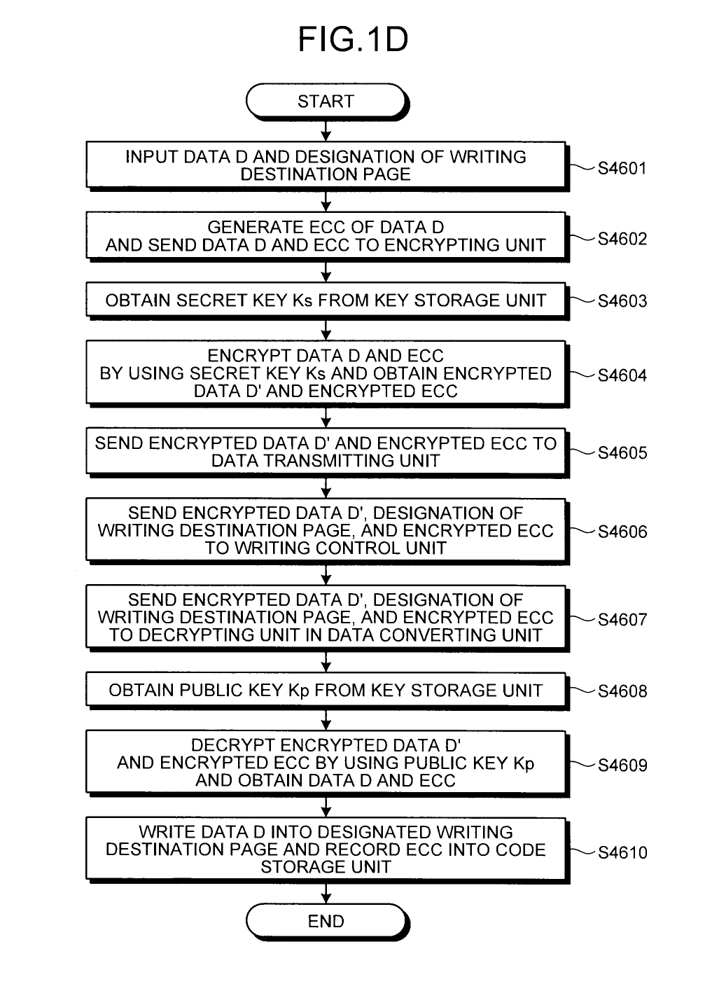

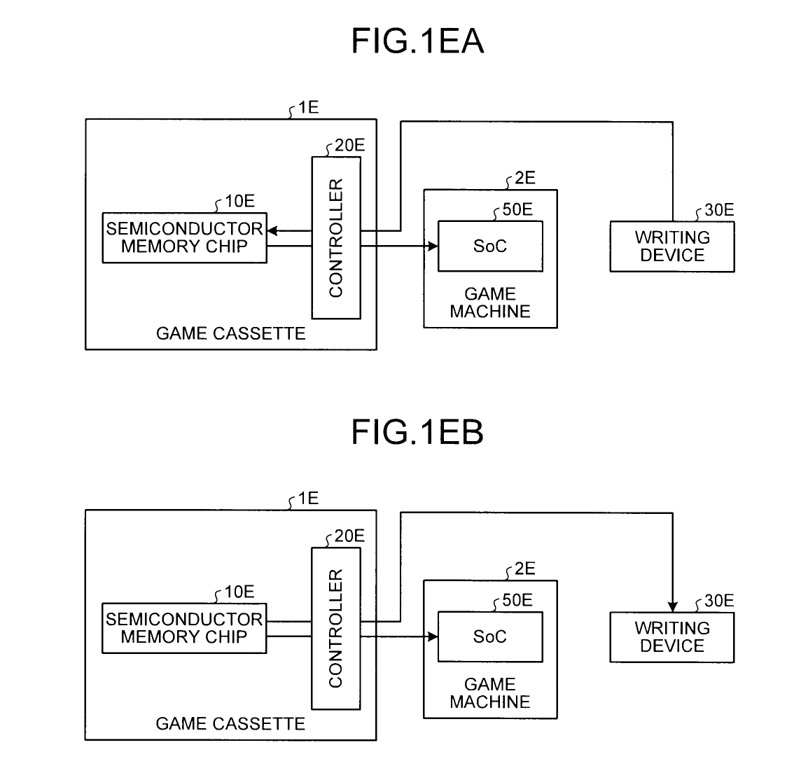

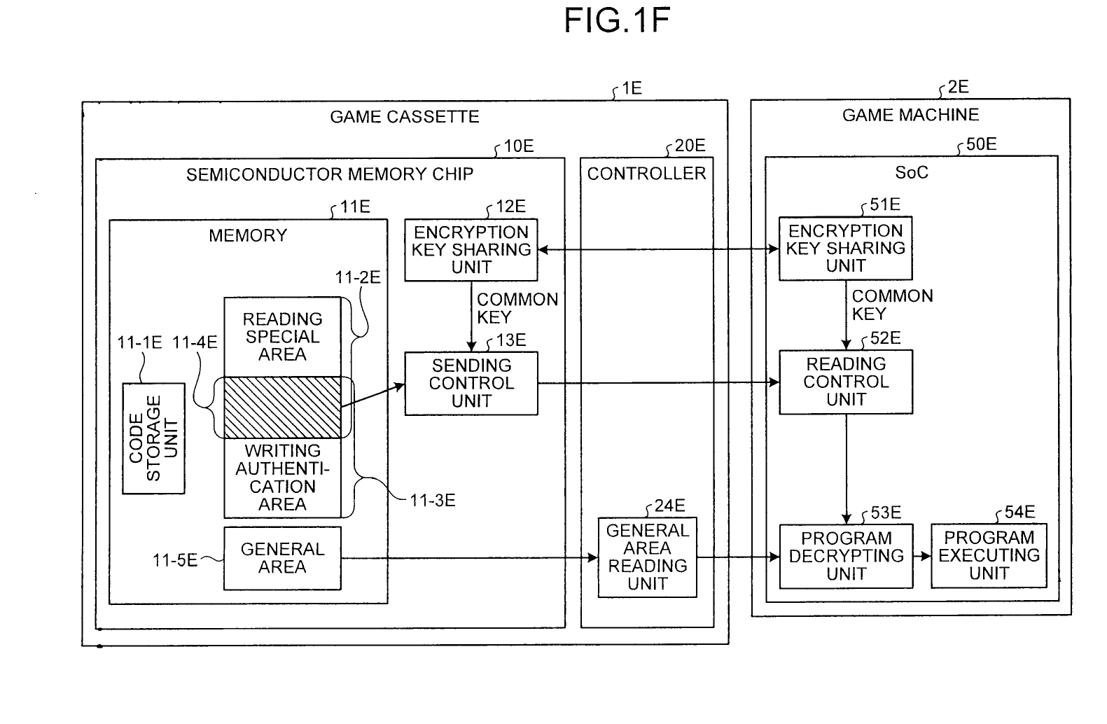

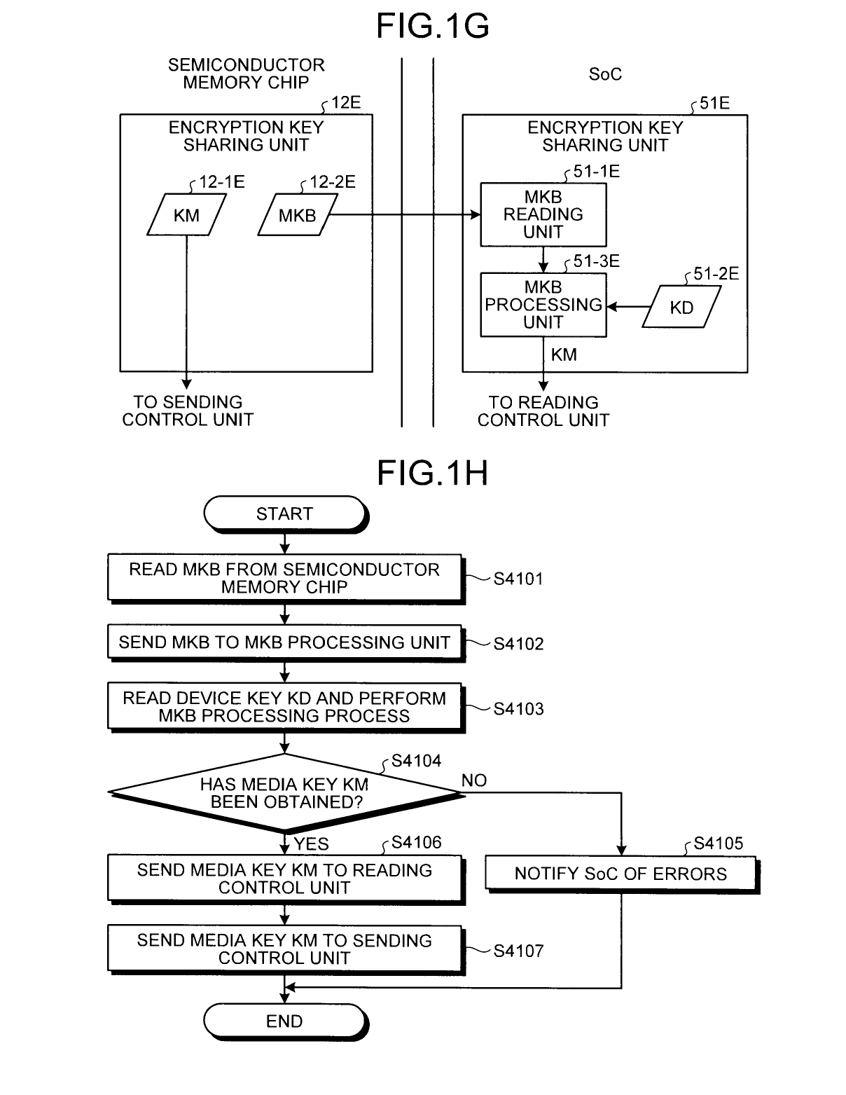

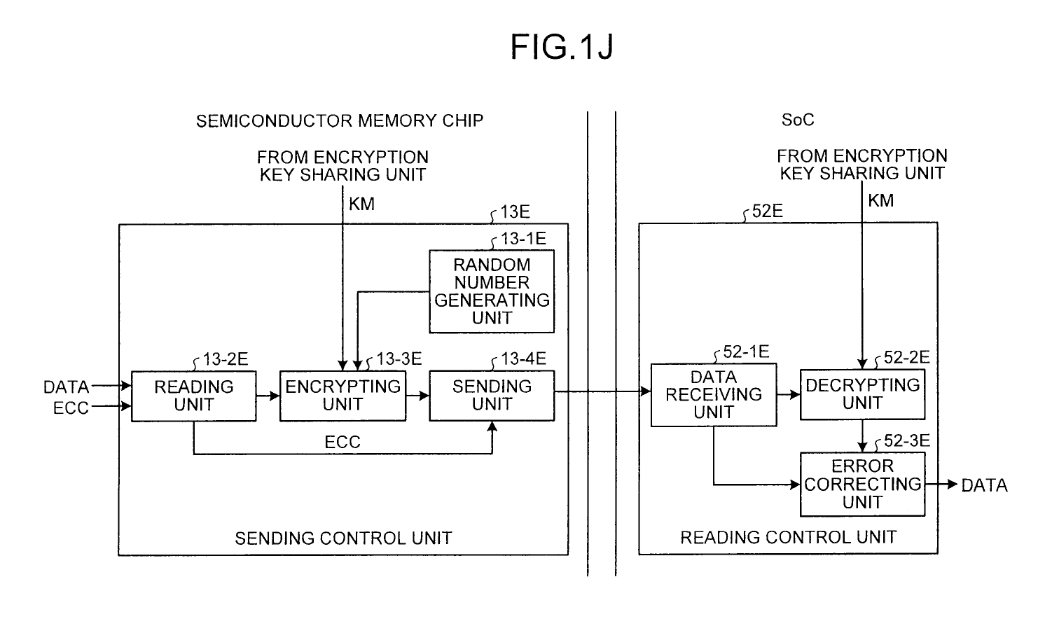

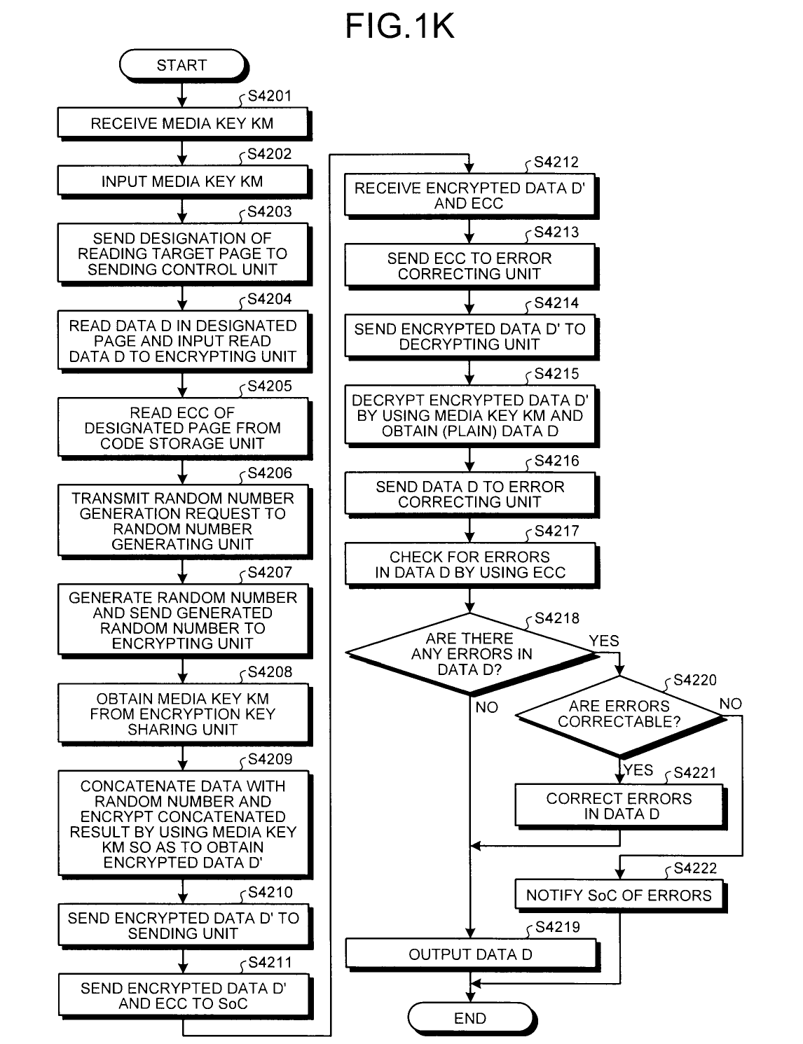

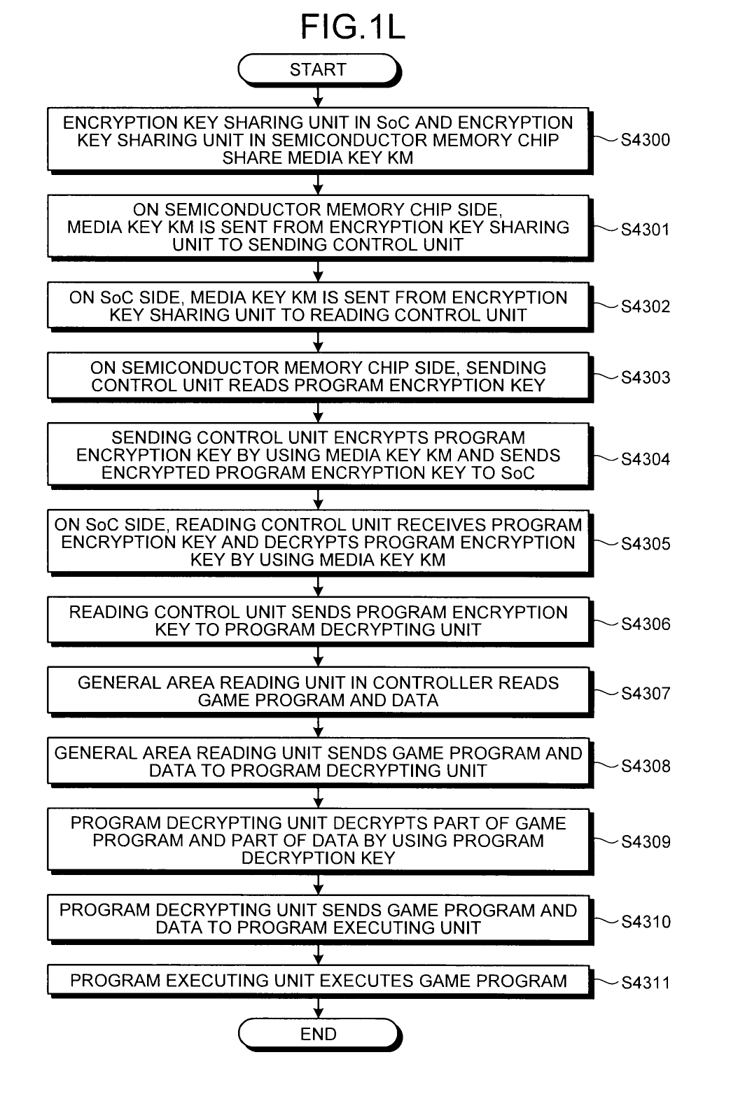

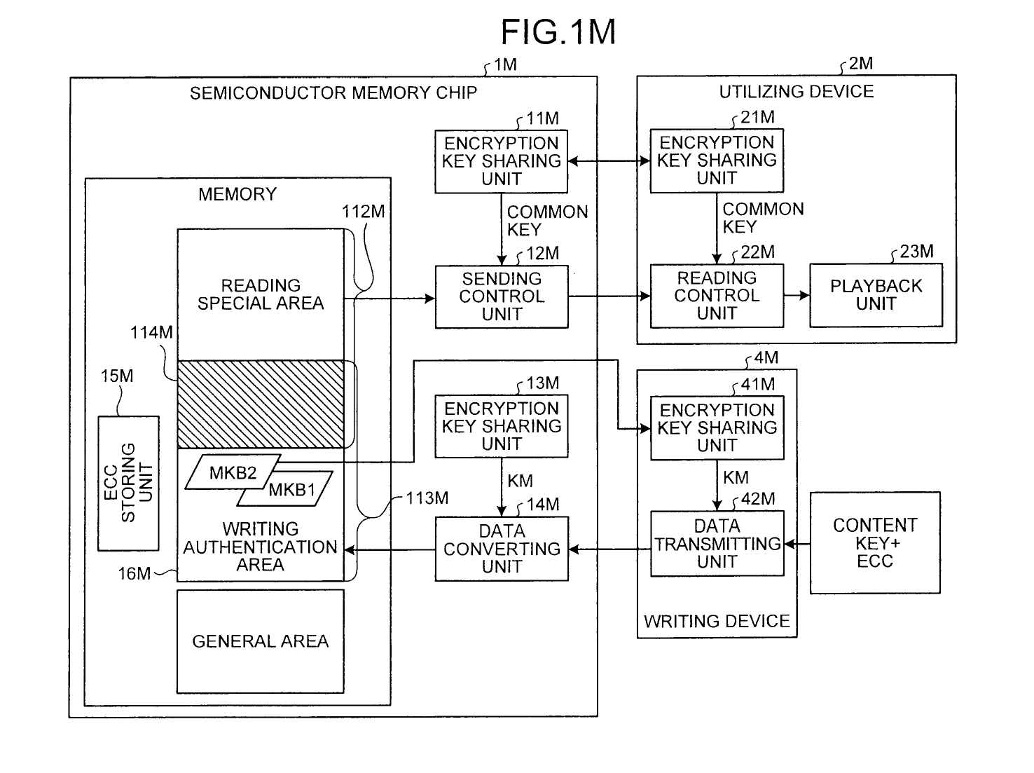

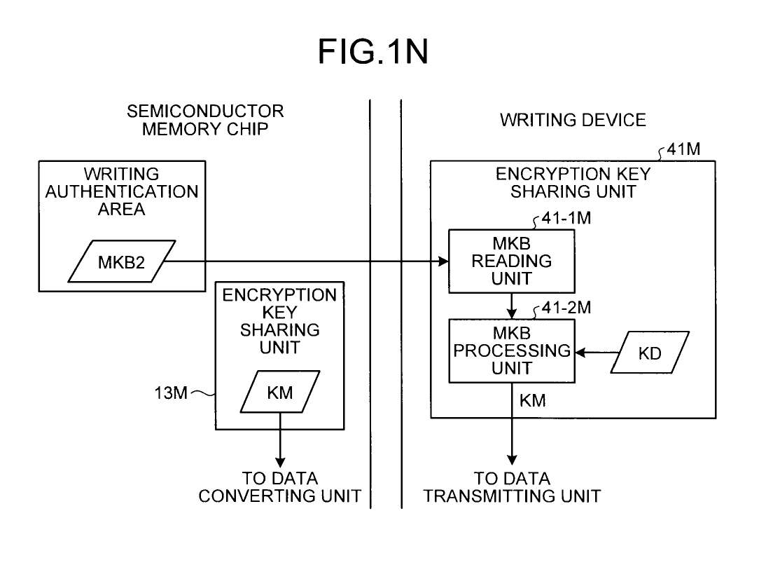

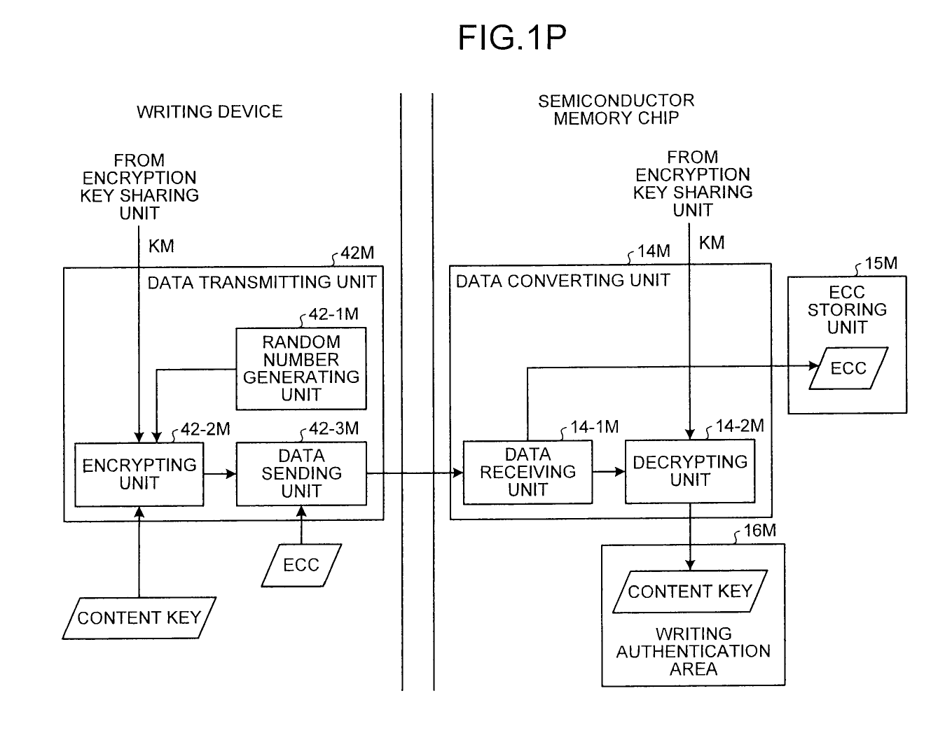

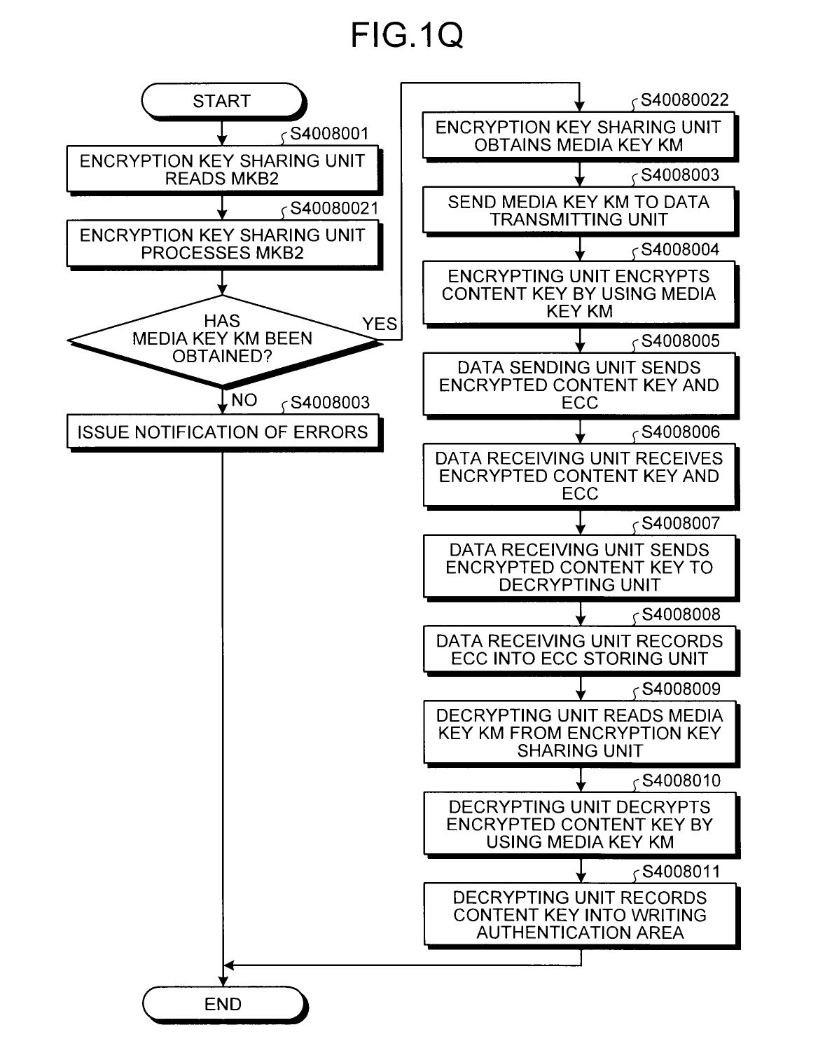

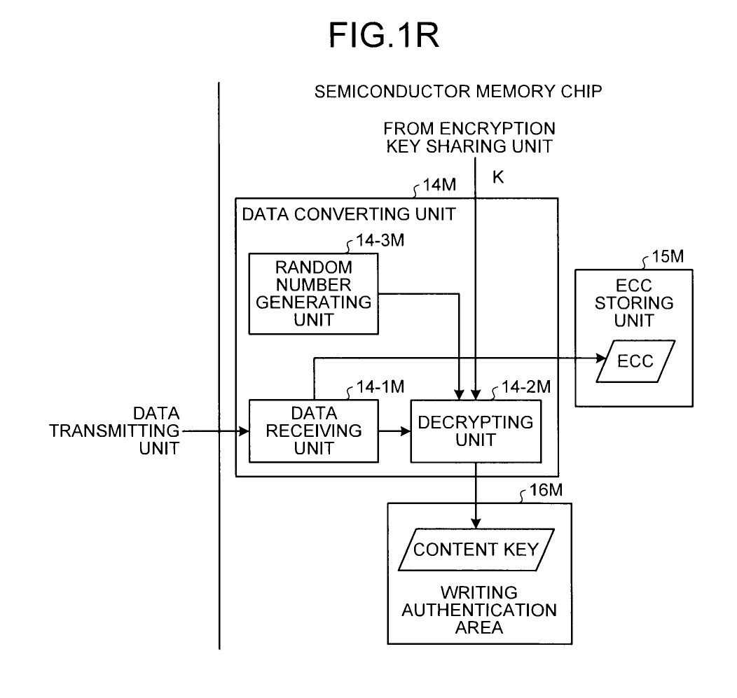

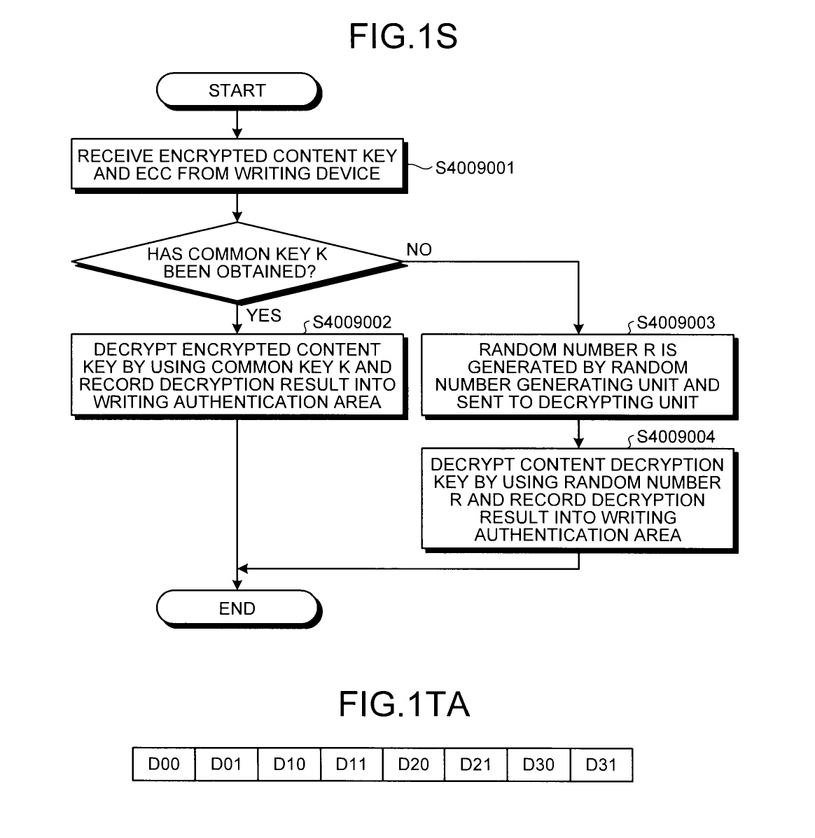

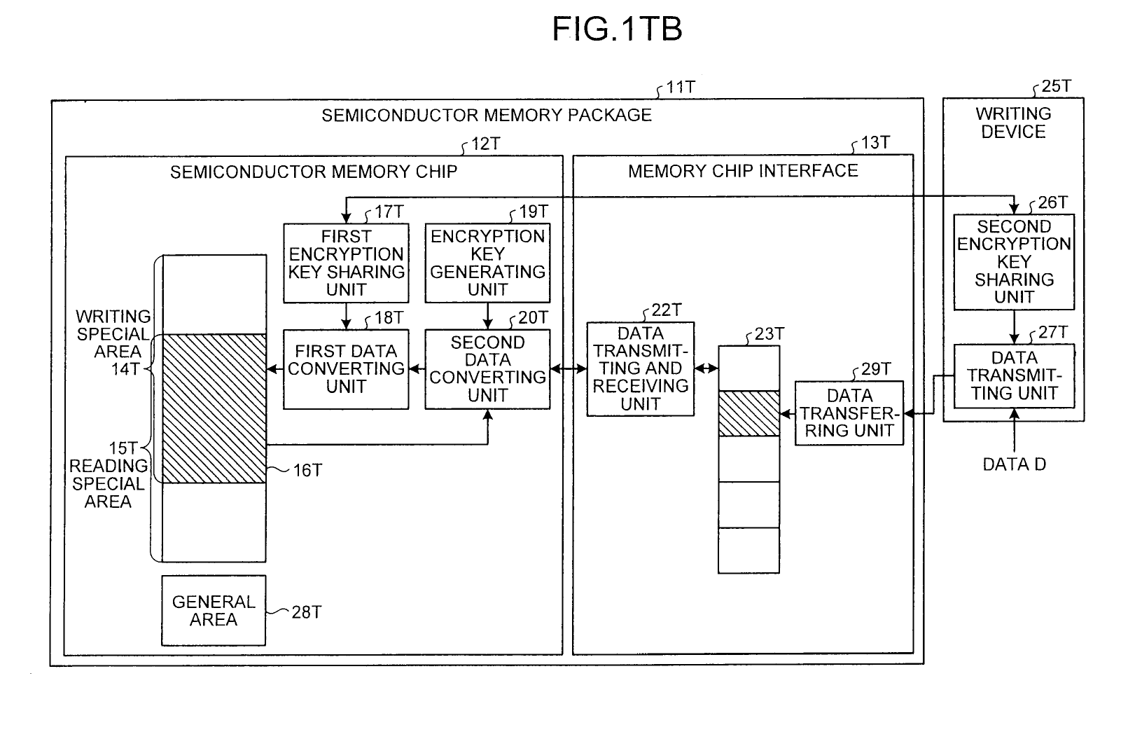

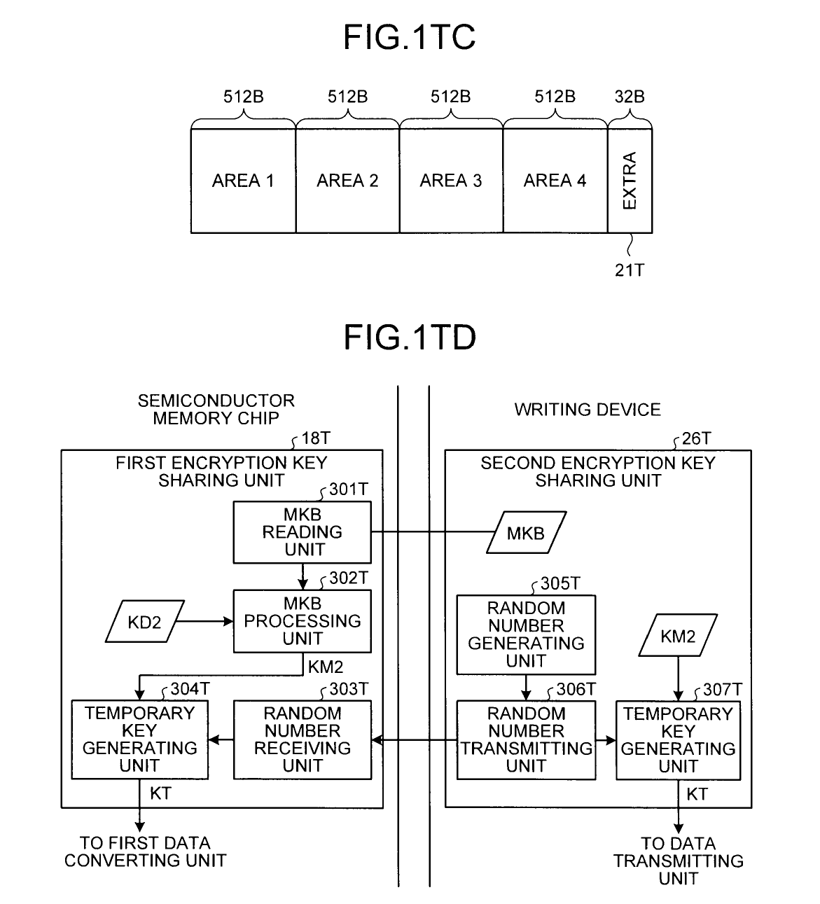

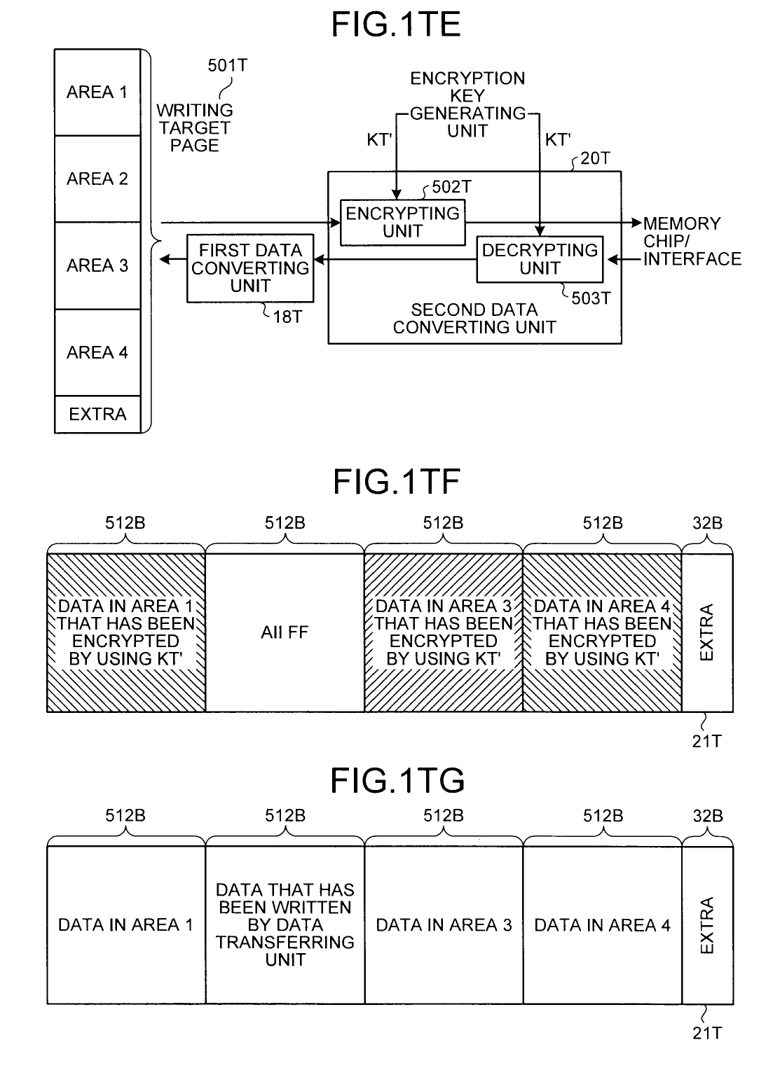

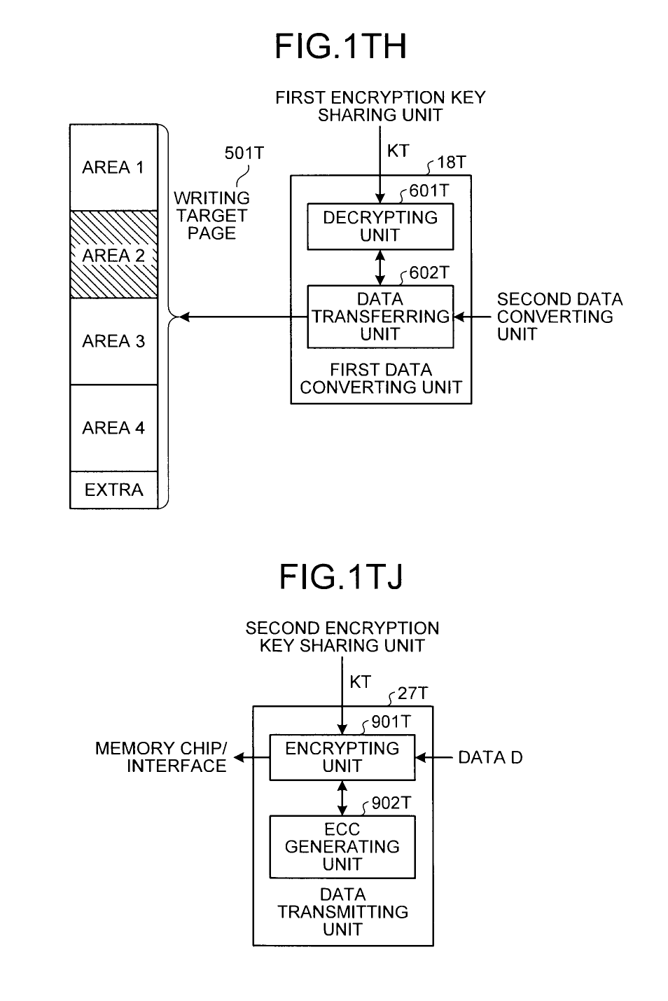

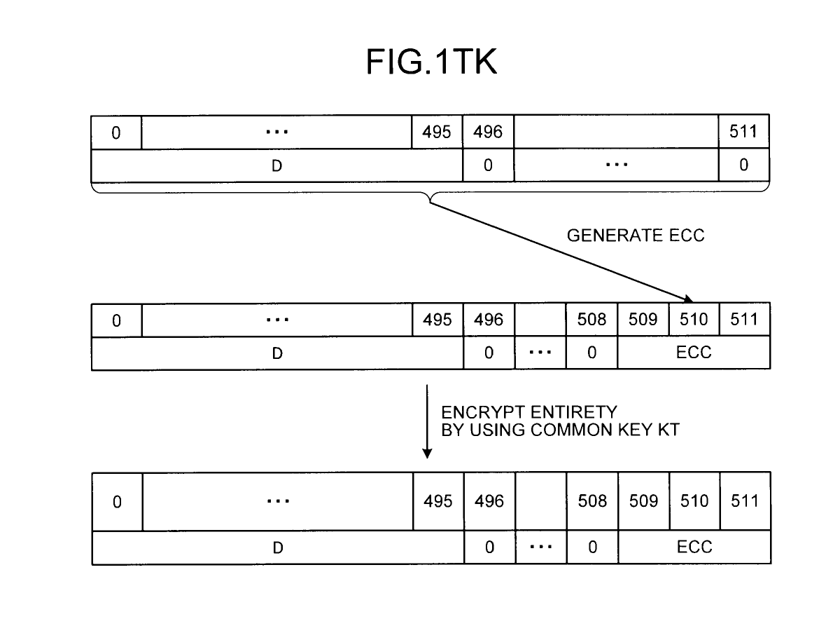

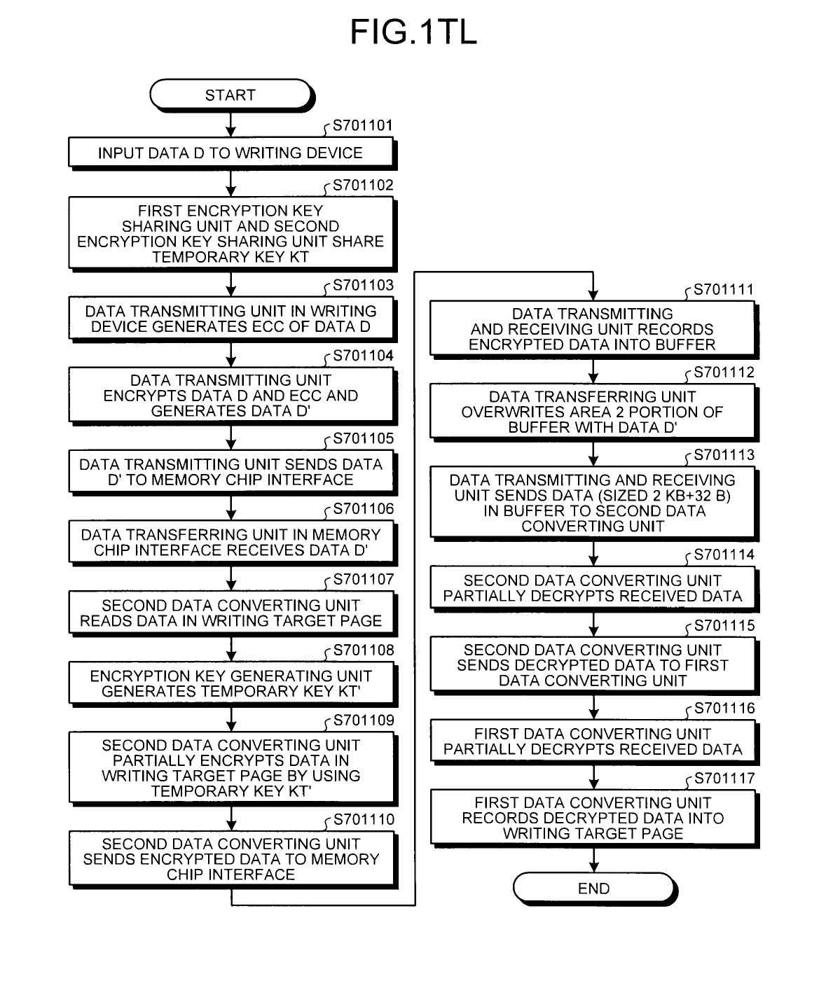

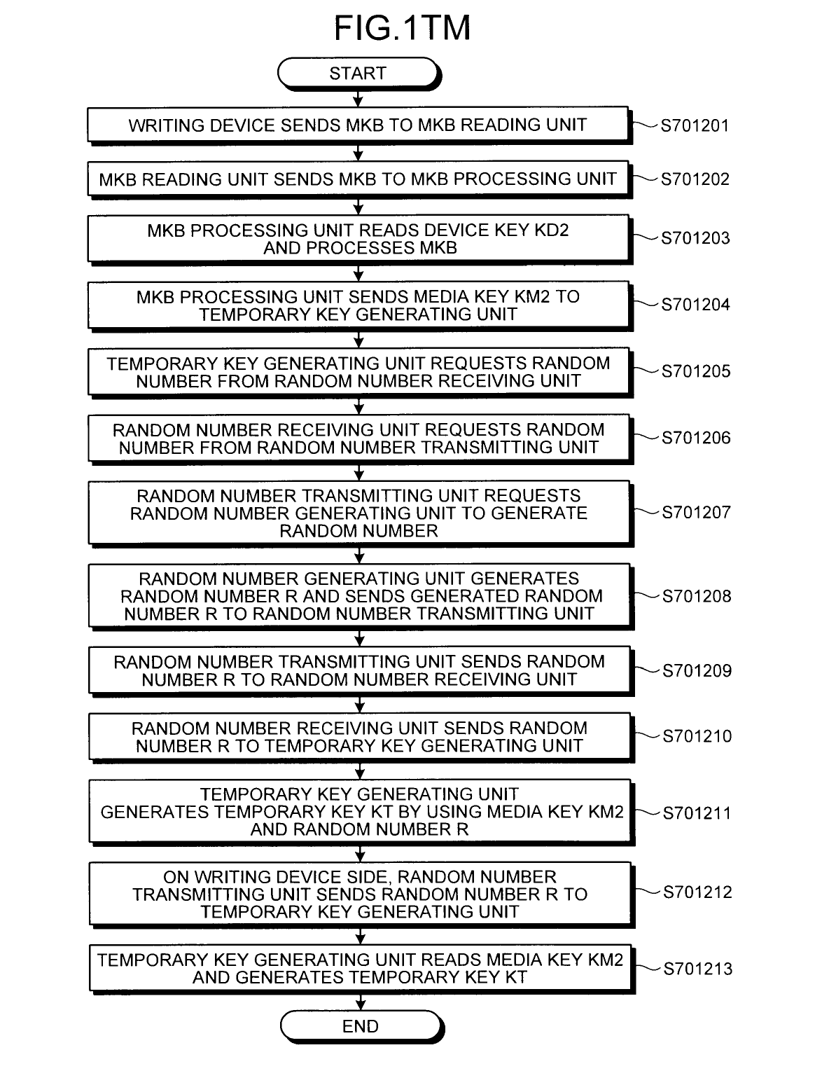

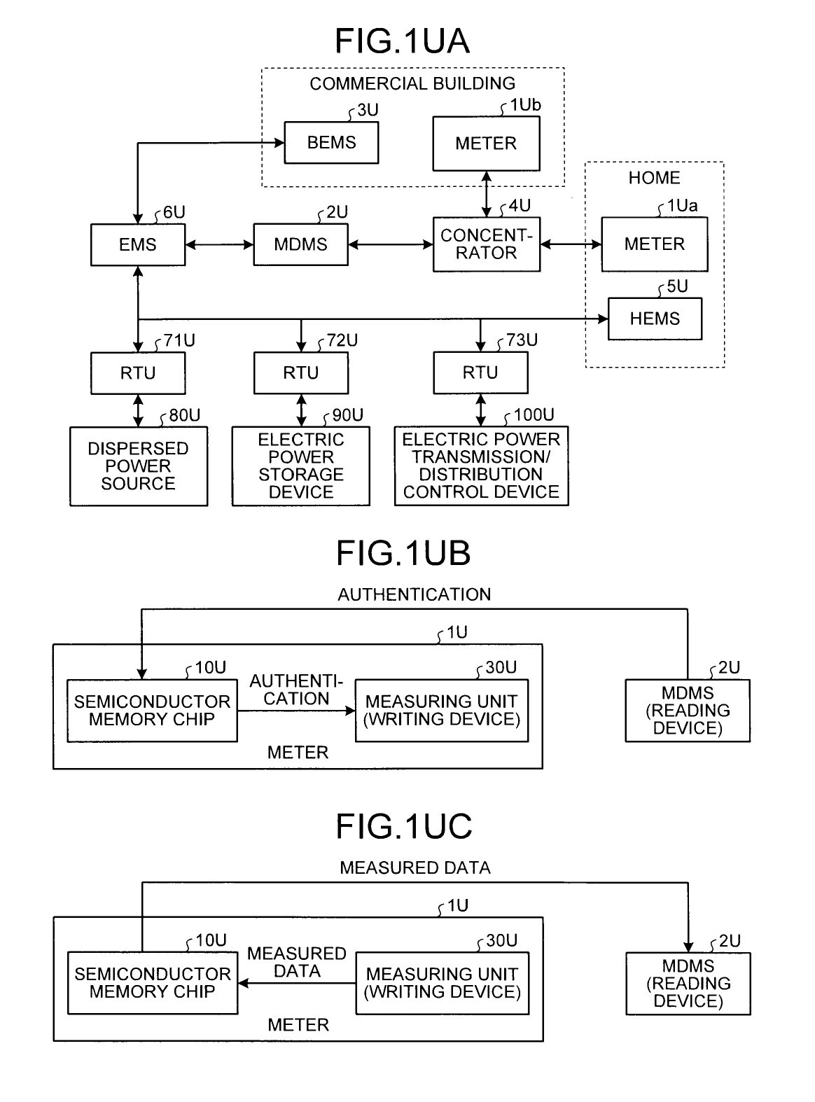

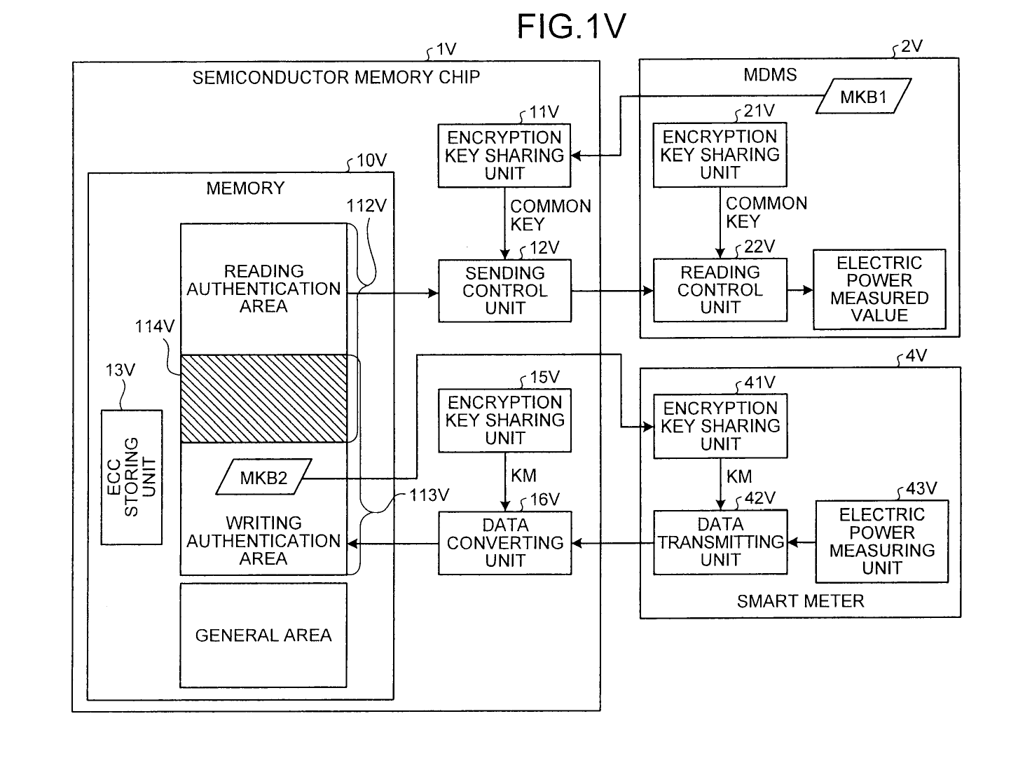

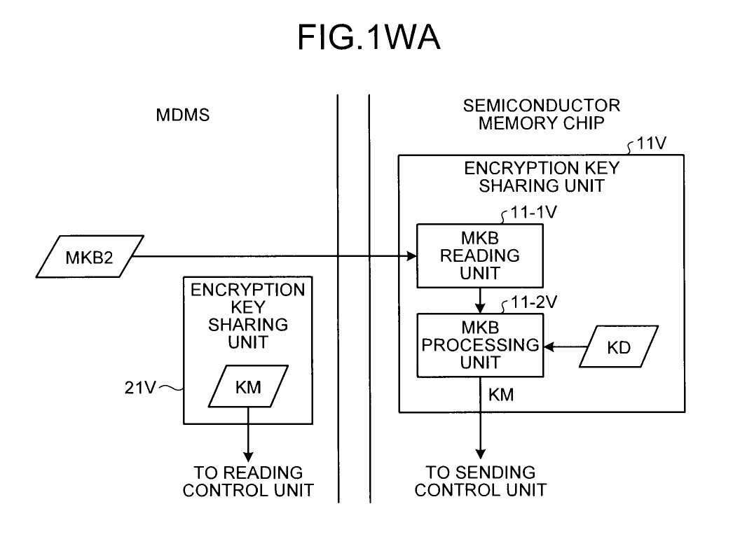

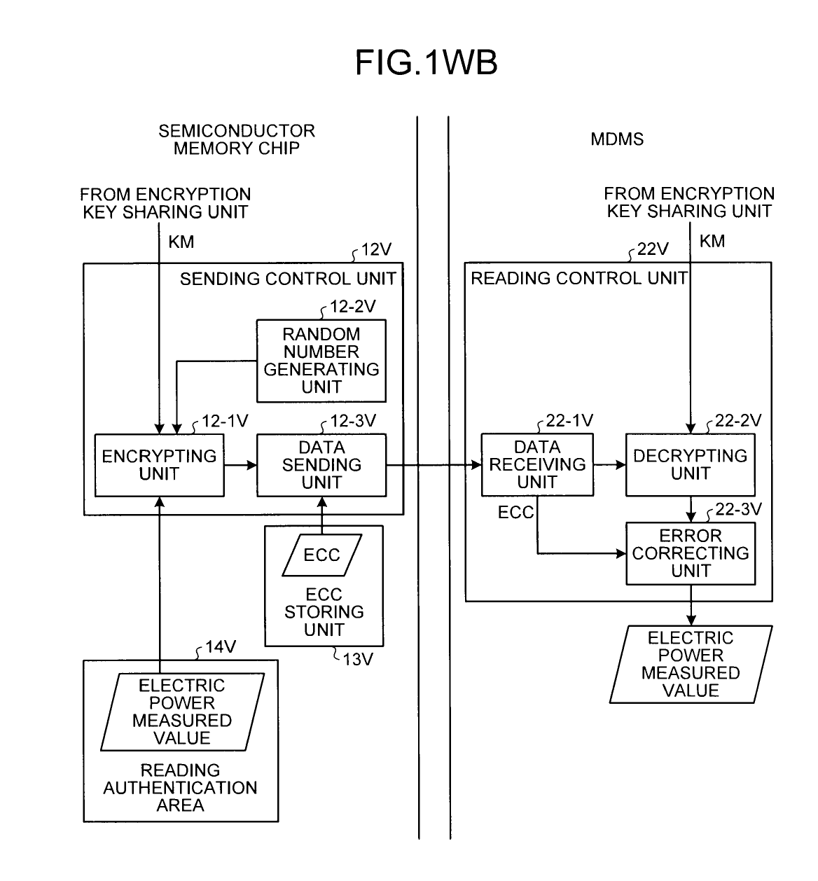

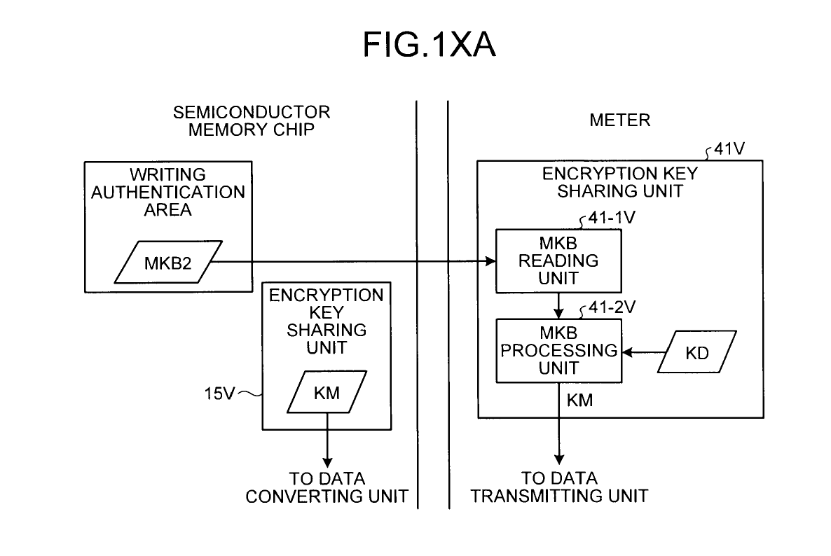

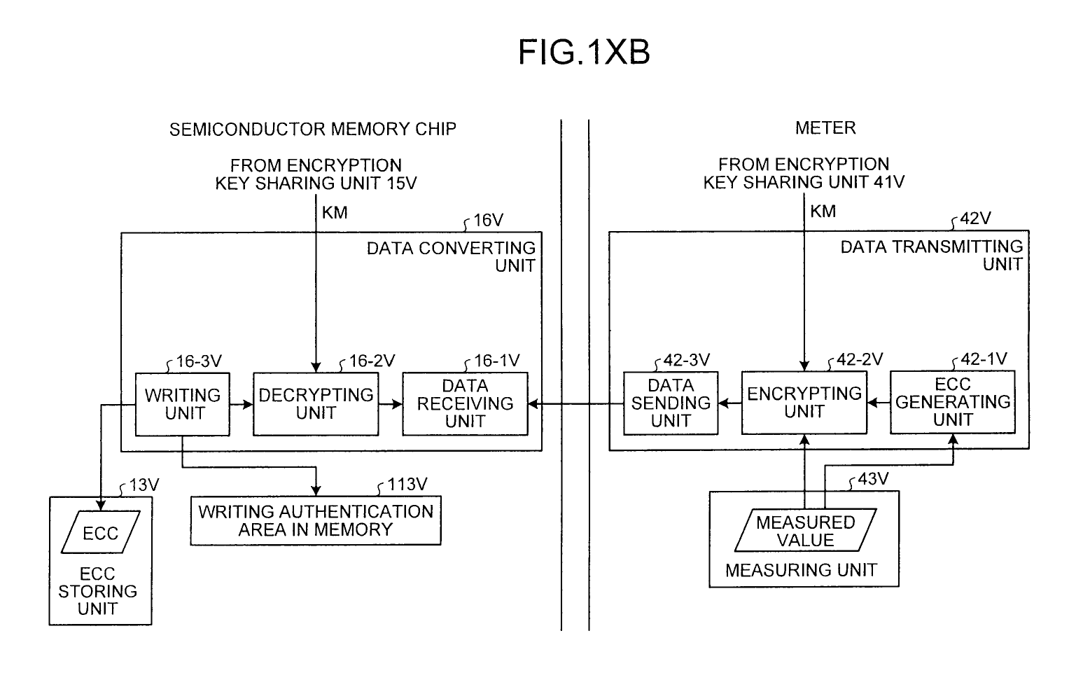

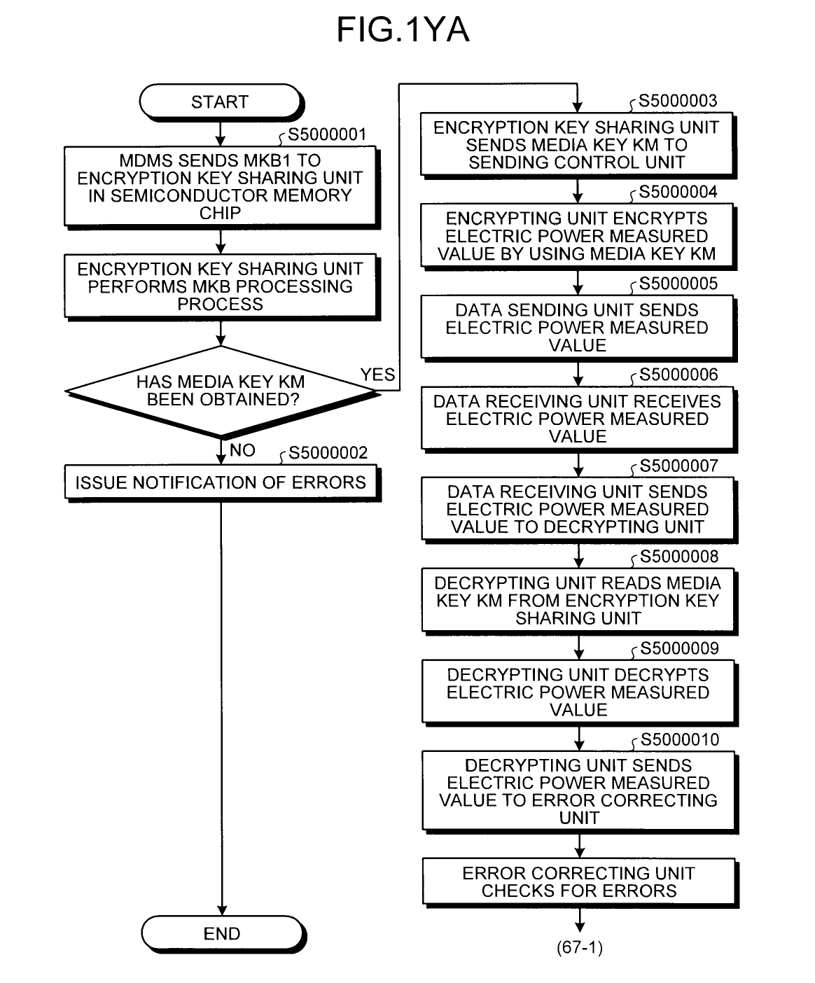

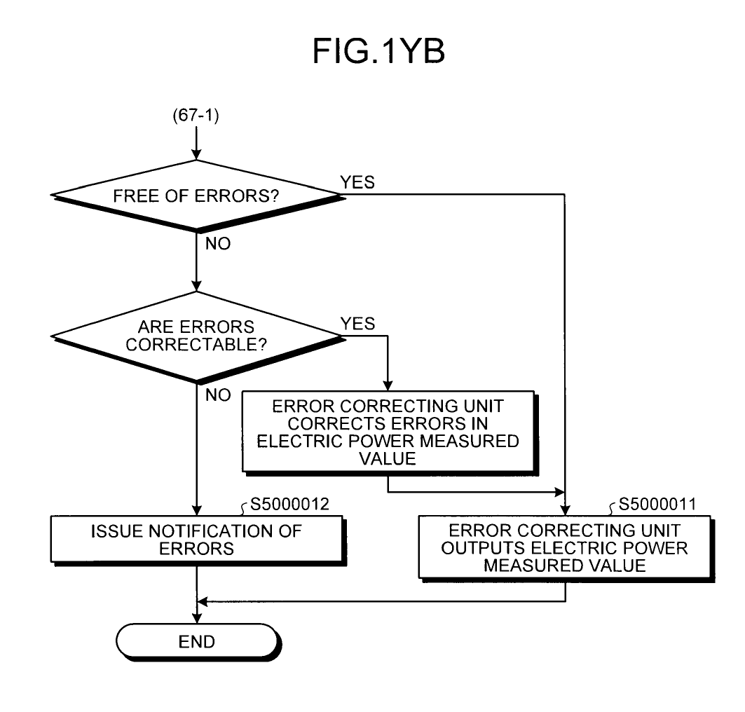

As shown in FIG. 1AA, a memory chip (i.e., a semiconductor memory chip) according to a first embodiment is configured such that a reading device authenticates the semiconductor memory chip, whereas the semiconductor memory chip authenticates a writing device.

It should be noted that, as shown in FIG. 1AB, the flow of data is in a direction that is opposite from the direction of the authentication. In other words, the writing device that has been authenticated writes data into the semiconductor memory chip that has authenticated the writing device. The reading device reads data stored in the semiconductor memory chip. The semiconductor memory chip according to the first embodiment constructs a trust chain shown in FIG. 1AA.

FIG. 1B is a block diagram corresponding to a situation where the writing device 30 writes data into a writing authentication area 11-3 in the semiconductor memory chip 10, via a controller 20.

The writing authentication area is a predetermined memory area into which only writing devices that have been authenticated by the semiconductor memory chip are able to record correct data. Alternatively, the writing authentication area is a predetermined memory area from which it is possible to correctly read only such data that has been written by writing devices that have been authenticated by the semiconductor memory chip.

FIG. 1B is a diagram depicting the manner in which the writing device 30 is connected to the controller 20 so that data is written into the writing authentication area 11-3 in the semiconductor memory chip 10. It should be noted that only the part that is related to the writing process is shown in FIG. 1B.

First, the writing device 30 transmits, to the controller 20, encrypted data obtained by encrypting data for which a writing process has been requested (i.e., data to be written), a designation of a writing destination page, and an Error Correction Code (ECC) with respect to the data to be written. A writing control unit 23 included in the controller 20 sends the encrypted data and the ECC to a data converting unit 14 included in the semiconductor memory chip 10. The data converting unit 14 converts (i.e., decrypts) the encrypted data, writes the obtained converted data (i.e., the data to be written) into the writing authentication area 11-3, and writes the ECC into a code storage unit 11-1.

FIG. 1C is a diagram of the writing device 30 and the data converting unit 14 in further details. Exemplary configurations of the writing device 30, the writing control unit 23 included in the controller 20, and the data converting unit 14 included in the semiconductor memory chip 10 will be explained with reference to FIG. 1C. As shown in FIG. 1C, the writing device 30 includes an ECC generating unit 31, a key storage unit 32, an encrypting unit 33, and a data transmitting unit 34.

The ECC generating unit 31 generates the ECC of the data to be written that has been input as the data that needs to be written. The key storage unit 32 stores therein a data conversion key (i.e., a first key) that is used for converting the data to be written. According to the first embodiment, the key storage unit 32 stores therein a secret key Ks according to a public key method, as the data conversion key. The secret key Ks is a secret key that corresponds to a public key Kp, which is a data conversion key (i.e., a second key) stored in a key storage unit 14-1 (explained later) included in the semiconductor memory chip 10.

The encrypting method that is applicable is not limited to the public key method. In the following sections, an example will be explained in which the writing device 30 encrypts the data to be written by using the data conversion key (i.e., the secret key Ks), whereas the semiconductor memory chip 10 decrypts the data to be written by using the corresponding data conversion key (i.e., the public key Kp) and stores the decrypted data into the memory 11. As long as the writing device 30 converts the data by using the data conversion key (i.e., the first key), whereas the semiconductor memory chip 10 converts the converted data by using the data conversion key (i.e., the second key) corresponding to the first key, it is acceptable to apply any other converting method. For example, another arrangement is acceptable in which the writing device 30 performs a converting process being equivalent to a decrypting process by using the first key, whereas the semiconductor memory chip 10 performs a converting process being equivalent to an encrypting process by using the second key that corresponds to the first key.

The encrypting unit 33 encrypts the data to be written by using the secret key Ks. Also, the encrypting unit 33 generates a code (i.e., a converted code) obtained by encrypting the ECC by using the secret key Ks. In the following sections, the data to be written that has been encrypted may be referred to as “encrypted data”, whereas the converted code obtained by encrypting the ECC may be referred to as “encrypted ECC”. The data transmitting unit 34 transmits the encrypted data, the encrypted ECC, and a designation of the writing destination page to the writing control unit 23 included in the controller 20.

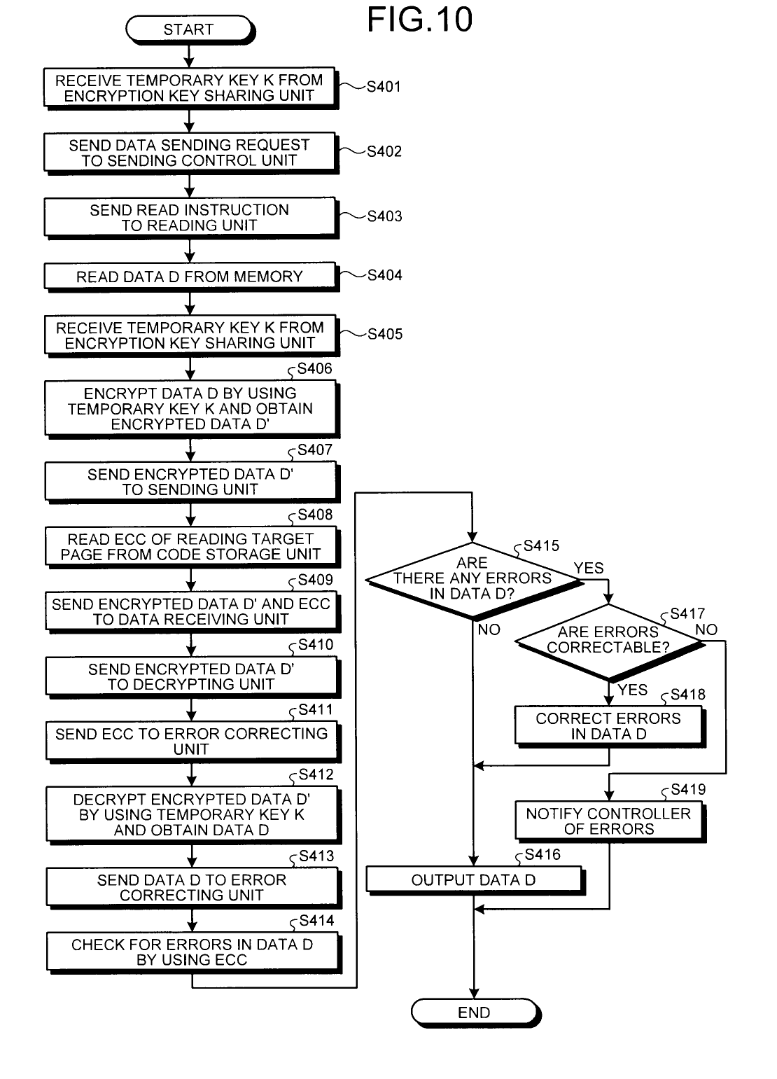

Next, an exemplary configuration of the writing control unit 23 included in the controller 20 will be explained. As shown in FIG. 10, the writing control unit 23 includes a data transferring unit 23-1. The data transferring unit 23-1 receives the encrypted data, the encrypted ECC, and the designation of the writing destination page and transmits these pieces of information to the data converting unit 14 included in the semiconductor memory chip 10.

Next, an exemplary configuration of the data converting unit 14 will be explained. As shown in FIG. 10, the data converting unit 14 includes a key storage unit 14-1, a decrypting unit 14-2, and a writing unit 14-3.

The key storage unit 14-1 stores therein the public key Kp according to the public key method. The decrypting unit 14-2 decrypts the encrypted data and the encrypted ECC by using the public key Kp stored in the key storage unit 14-1. The data to be written that has been obtained by decrypting the encrypted data corresponds to the converted data. The writing unit 14-3 records the data to be written that has been decrypted into the designated page in the writing authentication area 11-3 in the memory 11. Also, the writing unit 14-3 stores the decrypted ECC into the code storage unit 11-1 in the memory 11.

An operation in the writing process is shown in FIG. 1D. First, the data D and the designation of the writing destination page are input to the writing device 30 (step S4601). The data D passes through the ECC generating unit 31 where the ECC is generated. The data D and the ECC of the data D are sent to the encrypting unit 33 (step S4602). The encrypting unit 33 obtains the secret key Ks from the key storage unit 32 (step S4603). The encrypting unit 33 encrypts the data D and the ECC by using the secret key Ks and obtains encrypted data D′ and an encrypted ECC (step S4604). The encrypting unit 33 sends the encrypted data D′ and the encrypted ECC to the data transmitting unit 34 (step S4605). The data transmitting unit 34 transmits the encrypted data D′, the designation of the writing destination page, and the encrypted ECC to the writing control unit 23 included in the controller (step S4606). The data transferring unit 23-1 included in the writing control unit 23 transfers the encrypted data D′, the designation of the writing destination page, and the encrypted ECC to the data converting unit 14 (step S4607). The decrypting unit 14-2 included in the data converting unit 14 receives the encrypted data D′, the designation of the writing destination page, and the encrypted ECC. The decrypting unit 14-2 obtains the public key Kp from the key storage unit 14-1 (step S4608). The public key Kp corresponds to the secret key Ks stored in the key storage unit 32. The decrypting unit 14-2 decrypts the encrypted data D′ and the encrypted ECC by using the public key Kp and obtains the data D and the ECC (step S4609). The decrypting unit 14-2 sends the designation of the writing destination page, the data D, and the ECC to the writing unit 14-3. The writing unit 14-3 records the data D into the designated writing destination page (in the writing authentication area) in the semiconductor memory chip, and also, records the ECC into an appropriate location (i.e., a location that corresponds to the designated writing destination page) in the code storage unit (step S4610).

Next, an application of the first embodiment to a game machine will be explained. An exemplary application of the semiconductor memory chip according to the embodiment is shown in FIG. 1EA. A semiconductor memory chip 10E according to the embodiment is mounted on a game cassette 1E. At a manufacturing stage of the game cassette 1E, a writing device 30E records game data (i.e., data that is necessary for executing the game, such as a computer program and moving pictures) into the game cassette 1E. The game cassette 1E and the writing device may be connected to each other via the Internet or the like. When the game cassette 1E is to be used, the game cassette 1E is disconnected from the writing device and connected to a game machine. A game machine 2E has installed therein a System on Chip (SoC) 50E including a Central Processing Unit (CPU) and the like. In the present example, the SoC 50E is being used; however, a chip set that includes a CPU can generally be used. The SoC 50E reads the game data that has been recorded in the semiconductor memory chip 10E and executes the computer program. The arrow shown in FIG. 1EA indicates the flow of the data. In contrast, the direction of the authentication in FIG. 1EA is shown in FIG. 1EB. In FIGS. 1EA and 1EB, a controller 20E provides a function of electrically relaying the data. The controller 20E does not process the data logically. Also, the controller 20E is not subjected to an authentication process.

To realize the authentication between the writing device and the semiconductor memory chip 10E described above, an area called a writing authentication area 11-3E is additionally provided in the semiconductor memory chip 10E. The writing authentication area 11-3E is a predetermined memory area into which only the writing device 30E that has been authenticated by the semiconductor memory chip 10E is able to record correct data. Alternatively, the writing authentication area 11-3E is a predetermined memory area from which it is possible to correctly read only such data that has been written by the writing device 30E that has been authenticated by the semiconductor memory chip 10E. In the following sections, a specific method for structuring the writing authentication area 11-3E will be explained.

To write data into the writing authentication area 11-3E correctly, the writing device 30 needs to store therein the secret key that corresponds to the public key stored in the semiconductor memory chip 10E. In other words, only the writing device 30E that has been authenticated by the semiconductor memory chip 10E is able to write the correct data into the writing authentication area 11-3E. With this arrangement, according to the flow of the data (see FIG. 1EA) from the writing device 30E to the semiconductor memory chip 10E, the authentication of the writing device 30E by the semiconductor memory chip 10E (see FIG. 1EB) is established.

FIG. 1F is a block diagram of an exemplary application of the present embodiment. First, an overview of functions of a semiconductor memory chip 10E will be explained. As shown in FIG. 1F, the semiconductor memory chip 10E includes a memory 11E, an encryption key sharing unit 12E, and a sending control unit 13E.

The memory 11E is a storage unit that stores various types of data therein. The memory 11E may be configured with, for example, a NAND flash memory. The configuration of the memory 11E is not limited to this example; an arbitrary semiconductor memory that is configured with a semiconductor element (including any other type of flash memory) is applicable. The memory 11E includes a code storage unit 11-1E, a reading special area 11-2E, a writing authentication area 11-3E, a common area 11-4E, and a general area 11-5E. The code storage unit 11-1E stores therein an Error Correction Code (ECC) of the data for which a writing process has been requested by the writing device 30E. The code storage unit 11-1E may be provided on the outside of the memory 11E, as a storage unit that is independent from the memory 11E.

In FIG. 1F, an example is shown in which the reading special area 11-2E and the writing authentication area 11-3E each include an area other than the common area 11-4E; however, as long as at least the common area 11-4E is present, it is possible to configure each of the areas in an arbitrary manner. For example, an arrangement is acceptable in which the reading special area 11-2E and the writing authentication area 11-3E coincide with each other (i.e., both the reading special area 11-2E and the writing authentication area 11-3E coincide with the common area 11-4E). The general area 11-5E is an area to and from which the controller 20E is able to write and read data directly, without an intermediation of the sending control unit 13E. The encryption key sharing unit 12E stores therein or generates an encryption key to be shared with the game machine 2E. The sending control unit 13E controls the process of sending the data that has been read from the memory 11E to the game machine 2E. Next, an overview of functions of the controller 20E will be explained. The controller 20E includes a general area reading unit 24E. The general area reading unit 24E controls the reading of data from the general area 11-5E. In other words, when data is to be read from the general area 11-5E, the reading device inputs a designation of a reading target page to the general area reading unit 24E included in the controller 20E. Next, an overview of functions of the game machine 2E will be explained. The game machine 2E includes an encryption key sharing unit 51E, a reading control unit 52E, a computer program decrypting unit (hereinafter, the “program decrypting unit”) 53E, and a computer program executing unit (hereinafter, the “program executing unit”) 54E. The encryption key sharing unit 51E stores therein or generates an encryption key to be shared with the semiconductor memory chip 10E. The reading control unit 52E controls the process of reading data from the common area 11-4E in the semiconductor memory chip 10E, in response to a request from an external device (not shown) such as a reading device or a playback device. The program decrypting unit 53E obtains a computer program encryption key (hereinafter, the “program encryption key”) from the reading control unit 52E and decrypts a part of the game computer program (hereinafter, the “game program”) and a part of the data that have been read from the semiconductor memory chip by the general area reading unit 24E. The program decrypting unit 53E sends the game program and the data to the program executing unit 54E. The program executing unit 54E executes the program that has been decrypted by the program decrypting unit 53E.

FIG. 1G is a block diagram of encryption key sharing units that are respectively included in the semiconductor memory chip and the SoC shown in FIG. 1F. As shown in FIG. 1G, the encryption key sharing unit 12E stores therein a KM 12-1E (hereinafter, the “media key KM”) denoting a media key and a media key block (MKB) 12-2E. For example, the MKB 12-2E is described in the following document: 4C Entity, LLC. “Content Protection for Recordable Media Specification, SD Memory Card Book, Common Part”, Revision 0.961, May 3, 2007. Further, the encryption key sharing unit 51E stores therein a KD 51-2E denoting a device key. Also, the encryption key sharing unit 51E includes an MKB reading unit 51-1E and an MKB processing unit 51-3E. The MKB reading unit 51-1E reads the MKB 12-2E from the encryption key sharing unit 12E included in the semiconductor memory chip 10E. By processing the read MKB while using the device key KD 51-2E, the MKB processing unit 51-3E performs an MKB processing to derive the media key KM.

An operation performed by the encryption key sharing units in FIG. 1G is shown in FIG. 1H. The MKB reading unit 51-1E included in the encryption key sharing unit 51E in the SoC reads the MKB 12-2E stored in the encryption key sharing unit 12E included in the semiconductor memory chip 10E (step S4101). The MKB reading unit 51-1E sends the read MKB to the MKB processing unit 51-3E (step S4102). The MKB processing unit 51-3E reads the device key KD 51-2E and performs MKB processing (step S4103). In the case where the correct media key KM has not been obtained as a result of the MKB processing, the MKB processing unit 51-3E notifies the SoC 50E of an error (step S4105). When the SoC 50E has received the notification of an error, the SoC 50E cancels the reading process thereafter. In contrast, in the case where the correct media key KM has been obtained, the MKB processing unit 51-3E sends the media key KM to the reading control unit 52E (step S4106). Also, the encryption key sharing unit 12E included in the semiconductor memory chip sends the media key KM 12-1E to the sending control unit 13E included in the semiconductor memory chip (step S4107).

FIG. 1J is a block diagram of the sending control unit 13E and the reading control unit 52E that are shown in FIG. 1F. Exemplary configurations of the sending control unit 13E included in the semiconductor memory chip 10E and the reading control unit 22E included in the SoC 50E will be explained with reference to FIG. 1J. As shown in FIG. 1J, the sending control unit 13E includes a random number generating unit 13-1E, a reading unit 13-2E, an encrypting unit 13-3E, and a sending unit 13-4E. The random number generating unit 13-1E generates a random number in response to a request from the encrypting unit 13-3E. The reading unit 13-2E reads the data in the designated reading target page and the ECC of the data from the memory 11E. The encrypting unit 13-3E encrypts the read data by using the media key KM. The sending unit 13-4E sends the data that has been encrypted (i.e., the encrypted data) and the ECC to a data receiving unit 52-1E included in the SoC 50E. As shown in FIG. 1J, the reading control unit 52E includes the data receiving unit 52-1E, a decrypting unit 52-2E, and an error correcting unit 52-3E. The data receiving unit 52-1E receives the encrypted data and the ECC from the sending unit 13-4E included in the semiconductor memory chip 10E. The decrypting unit 52-2E decrypts the received encrypted data by using the media key KM. The error correcting unit 52-3E checks to see if there are any errors in the decrypted data and corrects the errors by using the received ECC.

FIG. 1K is a flow of an operation performed by the sending control unit 13E and the reading control unit 52E. The reading control unit 52E receives the media key KM from the encryption key sharing unit 51E (step S4201). The reading control unit 52E inputs the media key KM to the decrypting unit 52-2E (step S4202). The reading control unit 52E sends the designation of the reading target page to the sending control unit 13E (step S4203). The reading unit 13-2E reads the data D in the designated page and inputs the read data D to the encrypting unit 13-3E (step S4204). The reading unit further reads the ECC that corresponds to the designated page from the code storage unit and inputs the read ECC to the encrypting unit 13-3E (step S4205). The encrypting unit 13-3E receives the random number R from the random number generating unit 13-1E (step S4207). The encrypting unit 13-3E receives the media key KM from the encryption key sharing unit 12E (step S4208). The encrypting unit 13-3E concatenates the data D with the random number R and encrypts the concatenated result by using the media key KM so as to obtain encrypted data D′(step S4209). The sending unit 13-4E sends the encrypted data D′ and the ECC to the SoC 50E (step S4211.

On the SoC 50E side, the data receiving unit 52-1E included in the reading control unit 52E receives the encrypted data D′ and the ECC (step S4212). Although this communication is performed via the controller, the controller only relays the signals in the communication. Subsequently, the data receiving unit 52-1E sends the ECC to the error correcting unit 52-3E (step S4213). The data receiving unit sends the encrypted data D′ to the decrypting unit 52-2E (step S4214). The decrypting unit 52-2E decrypts the encrypted data D′ by using the media key KM and obtains the data D, which is plain data (step S4215). The decrypting unit 52-2E sends the data D to the error correcting unit 52-3E (step S4216). The error correcting unit 52-3E checks for errors in the data D by using the ECC (step S4217). In the case where there is no error in the data D, the error correcting unit 52-3E outputs the data D (step S4219). In the case where there are one or more errors in the data D and the errors are correctable, the error correcting unit 52-3E corrects the errors in the data D and outputs the data D (step S4219). Otherwise, the error correcting unit notifies the SoC 50E that the errors have occurred (step S4222), and the process ends.

When the game program is executed, the system shown in FIG. 1F operates in the manner described below. The operation will be explained with reference to FIG. 1L. A part of the game program and a part of the data used by the game program have been encrypted, and a key used in the encrypting process (which could be more than one key; hereinafter, the “program encryption key”) has been written by the writing device into an area where the writing authentication area and the reading special area overlap each other. The game program and the data itself that is used by the game program have been recorded into the general area in the semiconductor memory chip 10E. To execute the game program, the game machine 2E reads the game program into the SoC 50E. The SoC 50E first reads the MKB stored in the semiconductor memory chip 10E and shares the media key KM with the semiconductor memory chip 10E by performing the procedure described above (step S4300). After that, as a result of the procedure described above, the program encryption key is read from the reading special area via the sending control unit 13E (step S4303). The program encryption key is encrypted in the sending control unit 13E (step S4304) and is decrypted in the reading control unit 52E (step S4305). The game machine 2E reads the game program and the data to be used by the game program from the game cassette 1E. The game program and the data that have been read are sent to the program decrypting unit 53E included in the SoC 50E (step S4308). The program decrypting unit 53E obtains the program encryption key from the reading control unit 52E and decrypts the part of the game program and the part of the data (step S4309). The program decrypting unit 53E sends the game program and the data to the program executing unit 54E (step S4310). The program executing unit 54E executes the game program (step S4311).

In the example described above, the public key in the semiconductor memory chip is employed as a means for structuring the writing authentication area. To have the writing device authenticated by the semiconductor memory chip, it is also acceptable to employ an MKB as a means for structuring the writing authentication area. An example according to this method is shown in FIG. 1M. An MKB1 is used for a utilizing device revoking purpose. An MKB2 is used for a writing device revoking purpose. The processes performed on the common key and the reading control with respect to the utilizing device are the same as those in the example with the game machine 2E.

Configurations of encryption key sharing units included in a writing device and in a semiconductor memory chip are shown in FIG. 1N. Also, a data writing unit included in the writing device and a data converting unit included in the semiconductor memory chip are shown in FIG. 1P.

Each of the modules operates in the manner described below. The operation will be explained with reference to FIG. 1Q. An encryption key sharing unit 41M included in a writing device 4M reads the MKB2 stored in the writing authentication area (step S4008001). The encryption key sharing unit 41M causes the MKB processing unit 41M2 to process the MKB2 by using the stored device key KD (step S40080021) and obtains the media key KM (step S40080022). In the case where the MKB2 has revoked the device key KD, the encryption key sharing unit 41M notifies the writing device 4M of an error, and the operation is ended (step S4008003). After the encryption key sharing unit 41M has obtained the media key KM, the media key KM is sent to a data transmitting unit 42M (step S4008003). The data transmitting unit 42M causes a random number generating unit 42M1 to generate a random number R and inputs a content key and the random number R to an encrypting unit 42M2. The encrypting unit 42M2 encrypts data obtained by concatenating the content key with the random number R, while using the media key KM (step S4008004). The content key (with the random number) that has been encrypted is sent to a data sending unit 42M3. The data sending unit 42M3 reads the ECC of the content key and sends the encrypted content key and the ECC to the semiconductor memory chip (step S4008005). A data receiving unit 14M1 included in a data converting unit 14M in the semiconductor memory chip receives the encrypted content key and the ECC (step S4008006). The data receiving unit 14M1 sends the encrypted content key to a decrypting unit 14M2 (step S4008007) and records the ECC into an ECC storing unit 15M (step S4008008). The decrypting unit 14M2 reads a media key KM from an encryption key sharing unit 13M included in the semiconductor memory chip (step S4008009) and decrypts the encrypted content key by using the media key KM (step S4008010). The encrypted content key that has now been decrypted is concatenated with the random number R. The decrypting unit 14M2 discards the random number R and records only the content key into a writing authentication area 16M in the semiconductor memory chip (step S4008011).

There may be situations in which the writing device writes data into a writing special area or a writing authentication area without performing an authentication procedure such as sharing the key. In those situations, there are, in general, two possible operations that can be performed. One operation is to reject the writing process because the authentication procedure has not been performed. In that situation, the semiconductor memory chip may notify the writing device of an error. The other operation is to accept the writing process and to have the writing process actually performed. However, because the authentication process and the key sharing process have not been performed, a random number is generated on the semiconductor memory chip side, so that the random number is used as a key shared by the encryption key sharing units and so that the data received from the writing device is encrypted (decrypted) by using the random number and recorded into a memory. An example of a configuration of the data converting unit included in the semiconductor memory chip is shown in FIG. 1R. An operation performed by the data converting unit is shown in FIG. 1S. The data receiving unit 14M1 receives the encrypted content key and the ECC from the data transmitting unit included in the writing device (step S4009001). The data receiving unit 14M1 records the ECC into the ECC storing unit 15M. The data receiving unit 14M1 sends the encrypted content key to the decrypting unit 14M2. The decrypting unit 14M2 obtains the common key K that has resulted from an authentication process from the encryption key sharing unit. In the case where the common key K has been obtained from the encryption key sharing unit, the encrypted content key is decrypted by using the common key K, and the content key is recorded into the writing authentication area 16M (step S4009002). In the case where it is not possible to obtain the common key K from the encryption key sharing unit, a random number R is generated by the random number generating unit 14M3 and sent to the decrypting unit 14M2 (step S4009003). The decrypting unit 14M2 decrypts the content key by using the random number R and records the decrypted content key into the writing authentication area 16M (step S4009004). Needless to say, because the random number R is not the correct common key, it is not possible to correctly decrypt the content decryption key. In other words, when data is recorded into the writing authentication area without performing a proper authentication process, it is not possible to record the data correctly.

In the following sections, an embodiment in which content data that has been read from a semiconductor memory chip is configured so as to be distinguishable for each of utilizing devices will be explained. A structure of electronic book data is shown in FIG. 1TA. The size of the data is 8 megabytes (MB). The data is equally divided into eight sections. For the sake of convenience, the sections will be referred to by using reference symbols D00, D01, . . . , and D31. As for the text data of the electronic book, the two sections in each of the pairs (i.e., D00 and D01; D10 and D11; D20 and D21; and D30 and D31) have the same text data as each other. However, the electronic watermark embedded in the background image is different between the two sections in each of the pairs (i.e., D00 and D01; D10 and D11; D20 and D21; and D30 and D31). Each of the sections D00 through D31 has been encrypted by using a different one of mutually different content keys. These content keys will be referred to as K00, K01, . . . , and K31. For example, the section D21 in the data is encrypted by using the content key K21: D21′=Enc(K21, D21).

A reader of the electronic book stores therein four device keys that are namely KD0, KD1, KD2, and KD3. Further, a reader ID is assigned to each reader. The reader ID is an eight-digit number using the decimal notation. Each reader stores therein the reader ID thereof. In the present embodiment, the semiconductor memory chip includes eight reading special areas. These eight reading special areas will be referred to as A00, A01, A10, A11, A20, A21, A30, and A31. The content keys K00, K01, K10, K11, K20, K21, K30, and K31 have been recorded in the reading special areas, respectively, in advance. Further, an assignment rule has been recorded in the semiconductor memory chip. For example, a numerical value 0 is recorded as the assignment rule. This rule is interpreted by the electronic book reader in the following manner: The eight-digit reader ID is divided into four sections each having two digits, so that four numerical value n0, n1, n2, and n3 are obtained. If n0 is an even number, the content key K00 is read from A00, so that the data section D00′ is decrypted therewith. If n0 is an odd number, the content key K01 is read from A01, so that the data section D01′ is decrypted therewith. Similarly, if n1 is an even number, the content key K10 is read from A10, so that the data section D10′ is decrypted therewith. If n1 is an odd number, the content key K11 is read from A11, so that the data section D11′ is decrypted therewith. The same applies to the rest. An important point is that, when an electronic book reader of which n1 is an even number has processed the MKB in the semiconductor memory chip by using the device key KD0 stored in the electronic book reader, it is possible to derive the common key with which it is possible to correctly read the data from the reading special area A00. It means that the MKB is designed with such an arrangement.

As explained above, the electronic book reader reads the content keys K00 or K01, K10 or K11, K20 or K21, and K30 or K31 from the reading special areas A00 or A01, A10 or A11, A20 or A21, and A30 or A31, depending on the reader ID stored in the reader, so as to decrypt and display the data sections D00′ or D01′, D10′ or D11′, D20′ or D21′, and D30′ or D31′. Let us imagine a situation in which a piece of electronic book reader software has illegitimately been cracked, and the book data has been leaked. By looking at the leaked data, it is possible to obtain information related to the ID of the electronic book reader that has been leaked. For example, in the case where a set (D00, D11, D20, D31) has been leaked, it is understood that, in the reader ID, n0 is an even number, n1 is an odd number, n2 is an even number, and n3 is an odd number.

It should be noted that the assignment rule may be provided together with the MKB. In that situation, there is no need to use the device ID. It is possible to specify the reading special areas by combinations of the device keys KD0, . . . , and KD3 themselves. More specifically, it is possible to design the MKB so that, when the MKB has been decrypted by using the device key KD0, a value 0 or 1 is output in addition to the media key KM0.

Semiconductor memory chips are usually sold while being enclosed in a package together with a memory chip interface that processes an interface. In some situations, the units of Input/Output (I/O) used by the memory chip interface are different from the units of I/O (i.e., pages) used by the semiconductor memory chip. In the following sections, a configuration and a procedure will be disclosed with which, with respect to data that has been encrypted by a writing device, it is possible to have the correct data written into a semiconductor memory chip, without the need to provide a memory chip interface with the data stored in the writing special area in the form of plain data. Because the memory chip interface only relays the encrypted data, the memory chip interface does not know the correct data to be written into the semiconductor memory chip. Accordingly, the memory chip interface is not able to process the ECC. Thus, the writing device needs to provide the data to be written with the ECC.

A system configuration is shown in FIG. 1TB. A semiconductor memory chip 12T is enclosed in a semiconductor memory package 11T, together with a memory chip interface 13T. Semiconductor memory chips are usually sold in the form of semiconductor memory packages like this. The semiconductor memory chip includes one encryption key sharing unit and two data converting units that are namely a first encryption key sharing unit 17T, a first data converting unit 18T, and a second data converting unit 20T.

The first encryption key sharing unit 17T and the first data converting unit 18T form a mechanism that allows the semiconductor memory chip to be authenticated by a writing device 25T. The second data converting unit 20T is a means for keeping secret the data to be given to the memory chip interface 13T. The second data converting unit 20T included in the semiconductor memory chip 12T has an input and an output. The size of the data that goes through the input and the output is fixed and is, for example, “2 kilobytes (KB)+32 bytes (B)”.

The memory chip interface 13T includes a data transmitting and receiving unit 22T and a data transferring unit 29T. The units of data that are exchanged at a time between the memory chip interface 13T and the writing device 25T are different from the units of data (i.e., 2 kilobytes+32 bytes) that are exchanged between the memory chip interface 13T and the semiconductor memory chip 12T. The size of the units of data used in the former is 512 bytes (B). The memory chip interface includes a buffer 23T used for absorbing the difference in the data sizes. The size of the buffer is equal to or larger than “2 kilobytes+32 bytes”.

The writing device 25T includes a second encryption key sharing unit 26T and a data transmitting unit 27T. The second encryption key sharing unit 26T and the data transmitting unit 27T form a mechanism that allows the semiconductor memory chip 12T to be authenticated so that the data can be written therein. The size of the data that is written by the writing device 25T into the memory chip interface at a time is 512 bytes. The data transferring unit 29T included in the memory chip interface 13T receives the data to be written and rewrites 512 bytes that are a part of the buffer 23T with the received data.

The writing target page in the special area in the semiconductor memory chip has a data structure as shown in FIG. 1TC. Areas 1 to 4 correspond to mutually different applications, respectively. More specifically, each of the areas corresponds to a different one of mutually different device keys stored in the semiconductor memory chip. In other words, the device keys that are used by the semiconductor memory chip when recording data into the areas 1 to 4 are KD1, . . . , and KD4, respectively. These device keys are stored in the first encryption key sharing unit 17T. Control-purpose data with respect to the areas 1 to 4 is recorded in an “extra” area 21T.

The writing device 25T shown in FIG. 1TB is a writing device for an application that uses the area 2. The writing device 25T stores an MKB therein. During a writing process, the MKB is processed by the first encryption key sharing unit 17T by using the device key KD2. As a result of this processing, the media key KM2 is obtained (if the device key KD2 has not been revoked by the MKB). Similarly, media keys KM1, KM3, and KM4 are obtained, as a result of processes that use the device keys KD1, KD3, and KD4. The media keys KM1, . . . , and KM4 may be mutually different.

Configurations of the first encryption key sharing unit 17T and the second encryption key sharing unit 26T in FIG. 1TB are shown in FIG. 1TD. The second encryption key sharing unit 26T included in the writing device 25T stores therein the MKB used for authenticating the semiconductor memory chip. The first encryption key sharing unit 17T included in the semiconductor memory chip 12T stores the device key KD2 therein. The writing device 25T is a writing device for the application that uses the area 2. Thus, it is necessary to authenticate the device key KD2 that corresponds to the area 2.

A configuration of the second data converting unit 20T is shown in FIG. 1TE. The second data converting unit 20T transfers data in two directions. One is a reading process to read the writing target page in the writing special area in the semiconductor memory chip, to encrypt the read data, and to send the encrypted data to the memory chip interface. A temporary key KT′ that has been generated by an encryption key generating unit 19T is used in the encrypting process. The operation performed by an encrypting unit 502T has a major characteristic as follows: The encrypting unit 502T reads the writing target page from the head thereof and, while encrypting the read data by using the temporary key KT′, the encrypting unit 502T sends the data to the memory chip interface; however, the encrypting unit 502T does not transfer the data in the portion corresponding to the area 2 to the memory chip interface. Instead, the encrypting unit 502T sends, for example, FF. As a result, the data that is transmitted from the second data converting unit to the memory chip interface is structured as shown in FIG. 1TF. The “extra” portion is not encrypted and is sent to the memory chip interface as it is.

The other data flow is for a writing process. A decrypting unit 503T included in the second data converting unit 20T decrypts the data that has been received from the memory chip interface and has the size of “2 kilobytes+32 bytes” by using the temporary key KT′ that has been received from the encryption key generating unit 19T and sends the decrypted data to the first data converting unit 18T. The temporary key KT′ used in the decrypting process is the same as the temporary key KT′ used in the encrypting process during the reading process. The operation performed by the decrypting unit 503T also has a characteristic. The decrypting unit 503T sends the pieces of data that have been received from the memory chip interface to the first data converting unit 18T, while sequentially decrypting the received pieces of data from the head thereof by using the temporary key KT′; however, the decrypting unit 503T transfers the data in the portion corresponding to the area 2 as it is (without decrypting the data portion). As a result, the data transmitted from the second data converting unit 20T to the first data converting unit 18T is structured as shown in FIG. 1TG. The “extra” portion is not decrypted, either, and is sent to the memory chip interface as it is. The portion that corresponds to the area 2 (i.e., the offsets 512-1023) remains to be the 512-byte data that has been written by the data transferring unit 29T. As explained below, the data coincides with the encrypted data that includes the ECC and that has been transmitted by the writing device 25T.

FIG. 1TH is a block diagram of the first data converting unit 18T. The first data converting unit 18T writes the data that has been sent for the writing purpose from the second data converting unit 20T into the writing target page. At that time, the first data converting unit 18T decrypts the portion corresponding to the area 2, because the data in the area 2 has been encrypted by the writing device 25T. A temporary key KT that is used in the decrypting process is generated when the first encryption key sharing unit 17T is authenticated by the second encryption key sharing unit 26T. The first data converting unit 18T writes the data other than the data in the area 2 into the writing target page as it is. The data in the area 2 is equivalent to the data before the writing device 25T performs the encrypting process by using the temporary key KT. The data includes, as explained below, the data D and the ECC.

A configuration of the data transmitting unit 27T included in the writing device 25T is shown in FIG. 1TJ. An encrypting unit 901T receives the data D having the size of 496 bytes (=512 bytes−16 bytes). The encrypting unit 901T generates data having the size of 512 bytes by appending 0's corresponding to 16 bytes to the rear of the data D and sends the generated data to an ECC generating unit 902T. The ECC generating unit 902T generates an ECC related to the 512-byte data and returns the generated ECC to the encrypting unit 901T. The encrypting unit 901T overwrites the last three bytes in the 512-byte data with the ECC that has been received from the ECC generating unit 902T. Further, the encrypting unit 901T encrypts the 512-byte data including the data D and the ECC by using the temporary key KT. The temporary key KT is the key that has been generated when the writing device 25T authenticates the semiconductor memory chip 12T. The temporary key KT is shared with the first encryption key sharing unit included in the semiconductor memory chip 12T. The encrypting unit 901T sends data obtained by encrypting the 496-byte data D and the ECC to the memory chip interface. The manner in which the data to be sent to the memory chip interface is generated is shown in FIG. 1TK. In FIG. 1TK, the numerical values in the first line of the table indicate the byte offsets. An important point in this situation is that only the writing device 25T is able to generate the ECC of the data D recorded in the semiconductor memory chip 12T. The memory chip interface, which only relays the encrypted data, is not able to generate the value of the ECC. For this reason, the writing device needs to append the ECC.

An operation that is performed by the writing device 25T to write data into the semiconductor memory chip 12T is shown in FIG. 1TL. The procedure performed by the first encryption key sharing unit 17T and the second encryption key sharing unit 26T to share the temporary key KT is the same as the procedure explained in other parts of the present patent application (see FIG. 1TM). More specifically, the writing device 25T sends the MKB to an MKB reading unit 301T (step S701201). The MKB reading unit 301T sends the MKB to an MKB processing unit 302T (step S701202). The MKB processing unit 302T reads the device key KD2 stored in the encryption key sharing unit and processes the MKB (step S701203). In the case where the device key KD2 has not been revoked by the MKB, the media key KM2 is obtained. The MKB processing unit 302T sends the media key KM2 to a temporary key generating unit 304T (step S701204). The temporary key generating unit 304T requests a random number from a random number receiving unit 303T (step S701205). The random number receiving unit 303T requests a random number from a random number transmitting unit 306T included in the writing device (step S701206). The random number transmitting unit 306T requests a random number generating unit 305T that a random number should be generated (step S701207). The random number generating unit 305T generates a random number R and sends the generated random number R to the random number transmitting unit 306T (step S701208). The random number transmitting unit 306T sends the random number R to the random number receiving unit 303T (step S701209). When having received the random number R, the random number receiving unit 303T sends the random number R to the temporary key generating unit 304T (step S701210). The temporary key generating unit 304T generates the temporary key KT by using the media key KM2 and the random number R (step S701211). Further, the random number transmitting unit 306T sends the random number R to a temporary key generating unit 307T (step S701212). The temporary key generating unit 307T reads the media key KM2 stored in the second encryption key sharing unit and generates the temporary key KT by performing the same procedure as the one performed by the temporary key generating unit 304T (step S701213).

Returning to the description of FIG. 1TL, after the first encryption key sharing unit 17T and the second encryption key sharing unit 26T have shared the temporary key KT with each other (step S701102), the data transmitting unit 27T generates transmission-purpose data D′ (step S701104) and sends the generated data D′ to the memory chip interface 13T (step S701105). The method for generating the encrypted data D′ is described above. When the memory chip interface has received the encrypted data D′, the second data converting unit reads the writing target page (step S701107). The encryption key generating unit 19T generates the temporary key KT′ (step S701108). This temporary key KT′ is, for example, a random number. The second data converting unit 20T reads the temporary key KT′ and partially encrypts the writing target page that has been read (step S701109). The characteristic encrypting method used in this situation is described above. Subsequently, the data in the writing target page that has been encrypted by the second data converting unit 20T is recorded into the buffer 23T (step S701111). The data transferring unit 29T overwrites the portion corresponding to the area 2 in the buffer 23T with the 512-byte data that has been received from the writing device 25T (step S701112). The structure of the data is described above. After that, the data in the buffer (the portion corresponding to “2 kilobytes+32 bytes” from the head of the data) is sent to the second data converting unit 20T again. The second data converting unit 20T partially decrypts the data (step S701114). The characteristic decrypting method used in this situation is described above. The second data converting unit 20T sends the decrypted data to the first data converting unit 18T (step S701115). The first data converting unit decrypts only the portion that corresponds to the area 2 out of the received data by using the temporary key KT (step S701116). As a result, the portion that corresponds to the area 2 is plain data that is made up of the data D and the ECC. In other words, the data that is shown in the middle section of FIG. 1TK has been obtained. The data converting unit records the data in the buffer that has partially been decrypted into the writing target page.

As a result of the configuration and the operation described above, the data that was intended by the writing device 25T has been recorded in the writing target page in the semiconductor memory chip. In the example described above, the writing operation performed for the application that uses the area 2 has been explained; however, the same applies to any of the other applications that use the other areas. It should be noted that the memory chip interface is not able to process the ECC with respect to the data written in the manner described in the present embodiment. The device that utilizes the application needs to check the ECC. The present embodiment is characterized by the configuration in which the semiconductor memory chip includes the two data converting units. One of the data converting units is used in the authentication process with the writing device, whereas the other data converting unit is in charge of keeping the data secret from the memory chip interface.

Next, an application of the first embodiment to a smart grid will be explained. FIG. 1UA is a diagram of an exemplary configuration of a next-generation electric power grid according to the first embodiment. In the next-generation electric power grid, a meter 1Ua that counts an electric power usage amount and a Home Energy Management System (HEMS) 5U that is a home server that manages electric home appliances are installed at each household. Further, as for commercial buildings, a Building Energy Management System (BEMS) 3U that is a server that manages electric devices in the building is installed for each of the buildings. For each of the commercial buildings, a meter 1Ub that is configured like the meter 1Ua is installed. In the following sections, the meters 1Ua and 1Ub will be simply referred to as the “meters 1U”.

The meters 1U are organized into groups each made up of a number of meters by relay devices called concentrators (e.g., a concentrator 4U). The meters 1U communicate with a Meter Data Management System (MDMS) 2U via a communication network. The MDMS 2U receives and stores therein electric power usage amounts at predetermined time intervals from the meters 1U installed at the households. An Energy Management System (EMS) 6U exercises electric-power control by, for example, requesting the meters 1U installed at the households and the HEMS 5U that the electric power consumption should be reduced, based on the electric power usage amounts of a plurality of households that have been gathered in the MDMS 2U or information collected from sensors that are installed in electric-power systems. Further, the EMS 6U exercises control to stabilize the voltage and the frequency of the entire grid, by controlling the following elements: a dispersed power source 80U for solar power generation or wind power generation that is connected to a Remote Terminal Unit (RTU) 71U; an electric power storage device 90U that is similarly connected to an RTU 72U; and an electric power transmission/distribution control device 100U that is connected to an RTU 73U and exercises control over the operation between the power generation side.

FIG. 1UB is a diagram of an example of a smart grid system. The smart grid system includes a meter 1U and a Meter Data Management System (MDMS) 2U. The meter 1U includes a semiconductor memory chip 10U and an electric power measuring unit 30U. Meters including the meter 1U are organized into groups each made up of a number of meters by relay devices (not shown) called concentrators and communicate with the MDMS 2U, which is a meter data management system, via a communication network. The MDMS 2U receives and stores therein electric power usage amounts at predetermined time intervals from the meters 1U installed at the households. The meters 1U may be particularly referred to as smart meters. Each of the smart meters measures an energy usage amount such as an electric power usage amount and records the measured value. Each of the smart meters is configured so as to transmit the data of the measured value to a meter management system or to accept a measured-value reading process performed by the meter management system. Each of the smart meters is a sophisticated meter that further records a control command such as a demand response signal provided from the system controlling side and that controls or supports the energy use at home.

The data that has been measured by the electric power measuring unit 30U in the meter 1U and the like is stored into the semiconductor memory chip 10U included in the meter 1U and is transmitted to the MDMS occasionally. In order for the MDMS 2U to utilize the measured data for controlling the electric power supply, it is desirable if the authenticity of the data is guaranteed. One of the means for guaranteeing the authenticity of the data is to structure a trust chain as shown in FIG. 1UB. In other words, the MDMS 40U serving as a reading device authenticates the semiconductor memory chip 10U included in the meter 1U, and also, the semiconductor memory chip 10U authenticates the electric power measuring unit 30U included in the meter 1U. It should be noted that the flow of data is in a direction that is opposite from the direction of the authentication (see FIG. 1UC). The semiconductor memory chip according to the embodiment is usable for the purpose of structuring the trust chain shown in FIG. 1UB.

The semiconductor memory chip 10U is configured, as shown in FIG. 1UB, so that the MDMS 2U (i.e., the reading device) authenticates the semiconductor memory chip 10U, and also, the semiconductor memory chip 10U authenticates the electric power measuring unit 30U (i.e., the writing device). It should be noted that the flow of data is in a direction that is opposite from the direction of the authentication, as shown in FIG. 1UC. In other words, the electric power measuring unit 30U (i.e., the writing device) that has been authenticated writes the data into the semiconductor memory chip 10U that has authenticated the electric power measuring unit 30U. The MDMS 2U (i.e., the reading device) reads the data stored in the semiconductor memory chip 10U. The semiconductor memory chip 10U according to the first embodiment constructs the trust chain shown in FIG. 1UB.

To structure the trust chain in the system including the meter 1U shown in FIG. 1UB, it is necessary to structure a reading authentication area, in addition to the writing authentication area described in the exemplary embodiments. The reading authentication area is a memory area that is in the semiconductor memory chip 10U and from which it is possible to read data only if the semiconductor memory chip 10U has been authenticated by the MDMS (i.e., the reading device) 2U. In other words, the data that has been read from the reading authentication area is the data that has been stored in the authentic semiconductor memory chip 10U. An example of such a system is shown in FIG. 1V.

The system shown in FIG. 1V includes a semiconductor memory chip 1V, an MDMS 2V, and a meter 4V. The semiconductor memory chip 1V includes a memory 10V, an encryption key sharing unit 11V, a sending control unit 12V, an ECC storing unit 13V, an encryption key sharing unit 15V, and a data converting unit 16V. The memory 10V includes the ECC storing unit 13V, a reading authentication area 112V, a writing authentication area 113V, a common area 114V, and a general area 115V. The memory 10V includes the reading authentication area 112V and the writing authentication area 113V. The reading authentication area 112V and the writing authentication area 113V are provided with the common area 114V. Information that is essential to the utilization of the data is recorded into the common area 114V. An example is shown in which the reading authentication area 112V and the writing authentication area 113V each include an area other than the common area 114V; however, as long as at least the common area 114V is present, it is possible to configure each of the areas in an arbitrary manner. For example, an arrangement is acceptable in which the reading authentication area 112V and the writing authentication area 113V coincide with each other (i.e., both the reading authentication area 112V and the writing authentication area 113V coincide with the common area 114V).

The writing authentication area is a predetermined memory area into which only writing devices that have been authenticated by the semiconductor memory chip are able to record the correct data. Alternatively, the writing authentication area is a predetermined memory area from which it is possible to correctly read only such data that has been written by writing devices that have been authenticated by the semiconductor memory chip.

The encryption key sharing unit 11V receives an MKB1 that has been sent by the MDMS 2V. Based on the MKB1, MKB processing is performed. A common key (i.e., a media key KM) that has been generated as a result of the MKB processing is sent to the sending control unit 12V. More specifically, in the case where the correct media key KM has been obtained, the encryption key sharing unit sends the media key KM to the sending control unit 12V.

Even more specifically, the encryption key sharing unit 11V includes an MKB reading unit 11-1V and an MKB processing unit 11-2V. The MKB reading unit 11-1V receives the MKB1 from the MDMS and sends the MKB1 to the MKB processing unit 11-2V. The MKB processing unit 11-2V generates the common key (i.e., the media key KM) from the MKB1 and the device key KD and sends the generated common key to the sending control unit 12V. In the case where the device key KD has not been revoked, the media key KM is obtained as a result of the MKB processing. In contrast, in the case where the device key KD has been revoked by the MKB1, it is not possible to obtain the media key KM. In that situation, the encryption key sharing unit 11V issues a notification of an error and cancels the processing. The sending control unit 12V sends the common key (i.e., the media key KM) to the reading control unit 22V included in the MDMS 2V. Even more specifically, the sending control unit 12V includes an encrypting unit 12-1V, a random number generating unit 12-2V, and a data sending unit 12-3V. The encrypting unit 12-1V receives the media key KM. The encrypting unit 12-1V reads data (e.g., an electric power measured value) from the reading authentication area 14V and receives the random number R from the random number generating unit 12-2V. The encrypting unit 12-1V concatenates the data (e.g., the electric power measured value) with the random number R and encrypts the concatenated result by using the media key KM. The encrypting unit 12-1V sends the encrypted data (e.g., the electric power measured value) to the data sending unit 12-3V. The random number generating unit 12-2V generates the random number R. The data sending unit 12-3V reads the ECC that corresponds to the data (e.g., the electric power measured value) from the ECC storing unit 13V and sends the ECC together with the encrypted data (e.g., the electric power measured value) to the MDMS.

The MDMS 2V includes an encryption key sharing unit 21V and the reading control unit 22V. The encryption key sharing unit 21V has the common key (i.e., the media key KM). The reading control unit 22V decrypts the encrypted data (e.g., the electric power measured value) by using the common key (i.e., the media key KM). Even more specifically, the reading control unit 22V includes a data receiving unit 22-1V, a decrypting unit 22-2V, and an error correcting unit 22-3V. The data receiving unit 22-1V sends the ECC to the error correcting unit 22-3V. The data receiving unit 22-1V sends the encrypted electric power measured value to the decrypting unit 22-2V. The decrypting unit 22-2V reads the media key KM from the encryption key sharing unit 21V and decrypts the encrypted electric power measured value by using the media key KM. The decrypting unit 22-2V discards the random number in the decryption result and sends the electric power measured value to the error correcting unit 22-3V. The error correcting unit 22-3V checks for errors in the electric power measured value by using the ECC. If there is no error or if the errors are correctable, the error correcting unit 22-3V outputs the electric power measured value. Otherwise, the error correcting unit issues a notification of errors and stops the process. The ECC storing unit 13V stores the ECC therein.

In FIG. 1XA, exemplary configurations of encryption key sharing units (15V and 41V) that are respectively included in a semiconductor memory chip and a meter are shown. The encryption key sharing unit 15V has a common key (i.e., a media key KM) and sends the common key (i.e., the media key KM) to the data converting unit 16V. The encryption key sharing unit 41V includes an MKB reading unit 41-1V and an MKB processing unit 41-2V. The encryption key sharing unit 41V receives the MKB2 (i.e., MKB data) from the semiconductor memory chip and generates the common key (i.e., the media key KM) based on the MKB2 (i.e., the MKB data). The encryption key sharing unit 41V sends the generated common key (i.e., the media key KM) to a data transmitting unit 42V. More specifically, the MKB reading unit 41-1V reads the MKB2 from the semiconductor memory chip and sends the read MKB2 to the MKB processing unit 41-2V. The MKB processing unit 41-2V generates the common key (i.e., the media key KM) by using the MKB2 and the device key KD. The MKB processing unit 41-2V transmits the generated common key (i.e., the media key KM) to the data transmitting unit 42V.

FIG. 1XB a diagram of exemplary configurations of the data converting unit 16V included in the semiconductor memory chip and the data transmitting unit 42V included in the meter. The data transmitting unit 42V encrypts the measured value from a measuring unit 43V by using the common key (i.e., the media key KM) that has been received from the encryption key sharing unit 41V. The data transmitting unit 42V transmits the encrypted measured value to the data converting unit 16V. Even more specifically, the data transmitting unit 42V includes an ECC generating unit 42-1V, an encrypting unit 42-2V, and a data sending unit 42-3V. The ECC generating unit 42-1V reads a measured value from the measuring unit 43V and generates an ECC. The ECC generating unit 42-1V sends the generated ECC to the encrypting unit 42-2V. The encrypting unit 42-2V encrypts the measured value and the ECC that has been generated by the ECC generating unit 42-1V and sends the encryption result to the data sending unit. The data sending unit 42-3V transmits the measured value and the ECC that have been encrypted to the data converting unit 16V.

The data converting unit 16V decrypts the measured value and the ECC that have been encrypted and received. The data converting unit 16V writes the decrypted measured value into the writing authentication area 113V in the memory 10V. The data converting unit 16V writes the decrypted ECC into the ECC storing unit 13V. More specifically, the data converting unit 16V includes a data receiving unit 16-1V, a decrypting unit 16-2V, and a writing unit 16-3V. The data receiving unit 16-1V receives the measured value and the ECC that have been encrypted, from the data sending unit 42-3V. The data receiving unit 16-1V sends the measured value and the ECC that have been encrypted to the decrypting unit 16-2V. The decrypting unit 16-2V receives the common key (i.e., the media key KM) from the encryption key sharing unit 15V. The decrypting unit 16-2V decrypts the measured value and the ECC that have been encrypted by using the received common key (i.e., the media key KM). The decrypting unit 16-2V sends the measured value and the ECC that have been decrypted to the writing unit 16-3V. The writing unit 16-3V writes the decrypted measured value into the writing authentication area 113V in the memory 10V. The writing unit 16-3V writes the decrypted ECC into the ECC storing unit 13V.

In FIG. 1WA, configurations of the encryption key sharing unit 11V included in the semiconductor memory chip 1V and the encryption key sharing unit 21V included in the MDMS 2V are shown. Further, in FIG. 1WB, configurations of the sending control unit 12V and the reading control unit 22V are shown. The electric power measured value has been recorded in the reading authentication area. The MDMS reads the recorded electric power measured value by performing the procedure described below. The procedure will be explained with reference to FIGS. 1YA and 1YB. THE MDMS sends the MKB1 to the encryption key sharing unit 11V included in the semiconductor memory chip (step S5000001). The MKB processing unit 11-2V included in the encryption key sharing unit 11V processes the MKB1 by using the device key KD stored in the encryption key sharing unit. In the case where the device key KD has not been revoked, the media key KM is obtained as a result of the MKB processing. In contrast, in the case where the device key KD has been revoked by the MKB1, it is not possible to obtain the media key KM. In that situation, the encryption key sharing unit 11V issues a notification of an error and stops the process (step S5000002). In the case where the correct media key KM has been obtained, the encryption key sharing unit sends the media key KM to the sending control unit 22V (step S5000003). The encrypting unit 12-1V receives the media key KM. The encrypting unit 12-1V reads the electric power measured value from the reading authentication area 14V and receives the random number R from the random number generating unit 12-2V. The encrypting unit 12-1V concatenates the electric power measured value with the random number R and encrypts the concatenated result by using the media key KM (step S5000004). The encrypting unit 12-1V sends the encrypted electric power measured value to the data sending unit 12-3V. The data sending unit 12-3V reads the ECC that corresponds to the electric power measured value from the ECC storing unit 13V and sends the ECC together with the encrypted electric power measured value to the MDMS (step S5000005). The electric power measured value and the ECC that have been encrypted are input to the data receiving unit 22-1V included in the MDMS (step S5000006). The data receiving unit 22-1V sends the ECC to the error correcting unit 22-3V. The data receiving unit 22-1V also sends the encrypted electric power measured value to the decrypting unit 22-2V (step S5000007). The decrypting unit 22-2V reads the media key KM from the encryption key sharing unit 21V (step S5000008) and decrypts the encrypted electric power measured value by using the media key KM (step S5000009). The decrypting unit 22-2V discards the random number in the decryption result and sends the electric power measured value to the error correcting unit 22-3V (step S5000010). The error correcting unit 22-3V checks for errors in the electric power measured value by using the ECC. If there is no error or if the errors are correctable, the error correcting unit 22-3V outputs the electric power measured value (step S5000011). Otherwise, the error correcting unit issues a notification of errors and stops the process (step S5000012).

The writing authentication area (11-3 or 11-3E or 113M or 14T or 113V), for example, corresponds to the “first area” defined in the claims. The MKB2, for example, corresponds to the “first key information”. The encryption key sharing unit (41M or 26T or 41V), for example, corresponds to the “first encryption key generating unit”. The common key that is generated by, for example, the encryption key sharing unit (41M or 26T or 41V) corresponds to the “first key”. The common key that is stored in, for example, the encryption key sharing unit (13M or 17T or 15V) that is in correspondence with the encryption key sharing unit (41M or 26T or 41V) corresponds to the “second key”. The area (11-4 or 11-4E or 114M or 16T or 114V), for example, that is common to the writing area and the reading area corresponds to the “second area”. The MKB 12-2E or the MKB1, for example, corresponds to the “second key information”. The encryption key sharing unit (51E or 21M or 11V), for example, corresponds to the “second encryption key generating unit”. The KM that is generated by, for example, the encryption key sharing unit (51E or 21M or 11V) corresponds to the “third key”. The KM that is stored in, for example, the encryption key sharing unit (12E or 11M or 21V) that is in correspondence with the encryption key sharing unit (51E or 21M or 11V) corresponds to the “fourth key”.

By using the first embodiment, it is possible to prevent data writing processes that are performed from malicious writing devices.

A memory chip (i.e., a semiconductor memory chip) according to a second embodiment is configured such that the semiconductor memory chip has a security function and the semiconductor memory chip itself is incorporated in a trust chain. With this arrangement, it is possible to prevent the semiconductor memory chip from being used in combination with an illegitimate controller. Semiconductor memory chips are advanced component parts, and it is not easy to manufacture or sell semiconductor memory chips, unlike controllers having illegitimate IDs.

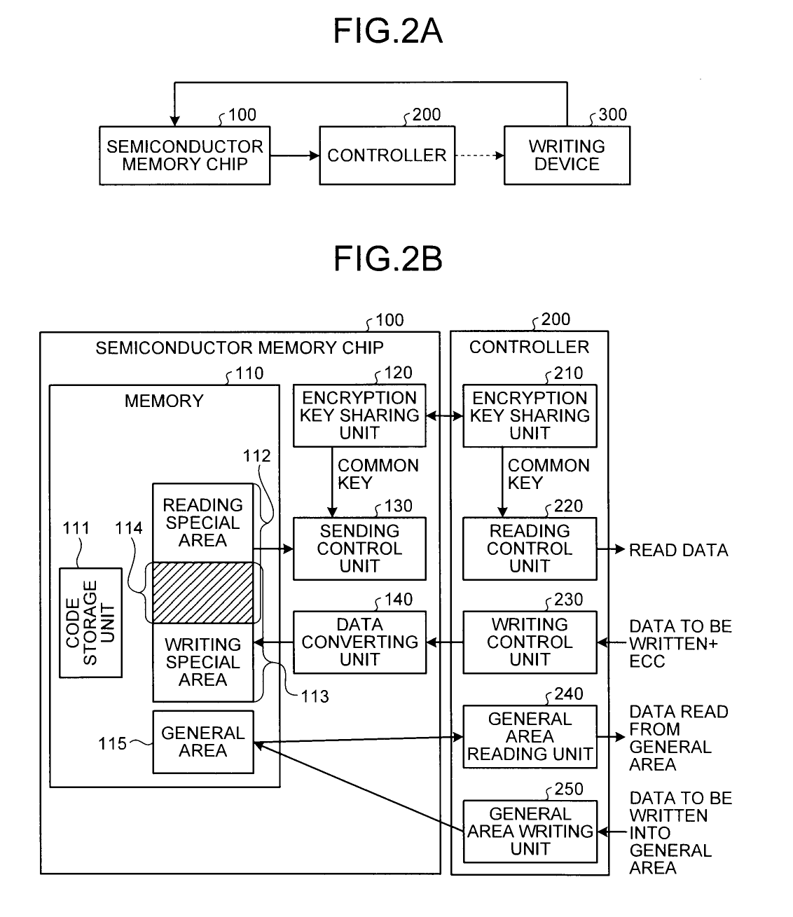

Next, a trust chain will be explained with reference to FIG. 2A. FIG. 2A is a diagram of an example of a system in which a semiconductor memory chip 100 is incorporated in a trust chain. The arrow shown in FIG. 2A indicates the direction of an authentication process. In other words, the semiconductor memory chip 100 authenticates a controller 200, whereas the controller 200 authenticates a writing device 300, and the writing device 300 authenticates the semiconductor memory chip 100. The authentication process shown with the broken line is optional. The writing device 300 is a starting point of the trust chain. An object of structuring the trust chain shown in FIG. 2A is to authenticate the controller 200 via the semiconductor memory chip 100. The data flow between the writing device 300 and the semiconductor memory chip 100 is always realized via the controller 200. Thus, the semiconductor memory chip 100 is authenticated by the writing device 300 indirectly.

According to the second embodiment, to incorporate the semiconductor memory chip 100 into the trust chain, the semiconductor memory chip 100 itself is provided with a security function. More specifically, a special area is structured in a memory included in the semiconductor memory chip 100. The special area includes a reading special area and a writing special area. The reading special area is a predetermined memory area within a storage area (i.e., a memory area) of the memory from which only the controller 200 that has been authenticated by the semiconductor memory chip 100 is able to read the stored value correctly. The writing special area is a predetermined memory area within the memory area into which, during a data writing process, data that has been decrypted by a data converting unit (explained later) is to be written.

Further, according to the second embodiment, to incorporate the semiconductor memory chip 100 into the trust chain, the reading special area and the writing special area are provided with a common area. Information that is essential to the utilization of the data is recorded into the common area. If it is possible to correctly record the information that is essential to the utilization of the data into the common area, it means that the semiconductor memory chip 100 has been authenticated by the writing device 300. Also, if the controller 200 is able to correctly read the information that is essential to the utilization of the data and that has been recorded in the common area, it means that the controller 200 has been authenticated by the semiconductor memory chip 100. The trust chain shown in FIG. 2A is thus completed.

FIG. 2B is a block diagram of exemplary configurations of the semiconductor memory chip 100 and the controller 200 according to the second embodiment. First, an overview of functions of the semiconductor memory chip 100 will be explained. As shown in FIG. 2B, the semiconductor memory chip 100 includes a memory 110, an encryption key sharing unit 120, a sending control unit 130, and a data converting unit 140.

The memory 110 is a storage unit that stores various types of data therein. The memory 110 may be configured with, for example, a NAND flash memory. The configuration of the memory 110 is not limited to this example; an arbitrary semiconductor memory that is configured with a semiconductor element (including any other type of flash memory) is applicable.

The memory 110 includes a code storage unit 111, a reading special area 112, a writing special area 113, a common area 114, and a general area 115.

The code storage unit 111 stores therein an Error Correction Code (ECC) of the data for which a writing process has been requested by the writing device 300. The code storage unit 111 may be provided on the outside of the memory 110, as a storage unit that is independent from the memory 110.

In FIG. 2B, an example is shown in which the reading special area 112 and the writing special area 113 each include an area other than the common area 114; however, as long as at least the common area 114 is present, it is possible to configure each of the areas in an arbitrary manner. For example, an arrangement is acceptable in which the reading special area 112 and the writing special area 113 coincide with each other (i.e., both the reading special area 112 and the writing special area 113 coincide with the common area 114).

The general area 115E is an area to and from which the controller 200 is able to write and read data directly, without an intermediation of the sending control unit 130 and the data converting unit 140.

The encryption key sharing unit 120 stores therein or generates an encryption key to be shared with the controller 200. The sending control unit 130 controls the process of sending the data that has been read from the memory 110 to the controller 200. The data converting unit 140 generates converted data obtained by converting the data for which a writing process has been requested by the writing device 300 via the controller 200. The encryption key sharing unit 120, the sending control unit 130, and the data converting unit 140 are structured on the same die as the one on which the memory 110 is provided. With these arrangements, it is possible to provide the semiconductor memory chip 100 with a security function and to prevent illegitimate use of data that is realized by, for example, counterfeiting memory cards. Details of the functions of the encryption key sharing unit 120, the sending control unit 130, and the data converting unit 140 will be explained later.

Next, an overview of functions of the controller 200 will be explained. The controller 200 includes an encryption key sharing unit 210, a reading control unit 220, a writing control unit 230, a general area reading unit 240, and a general area writing unit 250.

The encryption key sharing unit 210 stores therein or generates an encryption key to be shared with the semiconductor memory chip 100. The reading control unit 220 controls the process of reading data from the common area 114 in the semiconductor memory chip 100, in response to a request from an external device (not shown) such as a reading device or a playback device. The writing control unit 230 controls the process of writing data into the common area 114 in the semiconductor memory chip 100, in response to a request from an external device such as the writing device 300.

The general area reading unit 240 controls the reading of data from the general area 115. In other words, when data is to be read from the general area 115, the reading device inputs a designation of a reading target page to the general area reading unit 240 included in the controller 200.

The general area reading unit 240 reads the data in the designated page, and also, reads the ECC that corresponds to the designated page from the code storage unit 111. Also, the general area reading unit 240 checks for errors in the page that has been read, by using the ECC. If there is no error, the general area reading unit 240 outputs the data in the read page. If there are one or more errors, and the errors are correctable, the general area reading unit 240 corrects the data in the read page and outputs the data. Otherwise, the general area reading unit 240 outputs an error code.

The general area writing unit 250 controls the writing of data into the general area 115. In other words, when data is to be written into the general area 115, the writing device 300 inputs the data to the general area writing unit 250 included in the controller 200. In this situation, the writing device 300 also inputs a designation of the writing destination page (i.e., an area within the memory) to the general area writing unit 250.

The general area writing unit 250 generates an ECC of the input data, writes the data into the designated page within the general area 115, and records the generated ECC into the code storage unit 111 as the ECC that corresponds to the designated page.

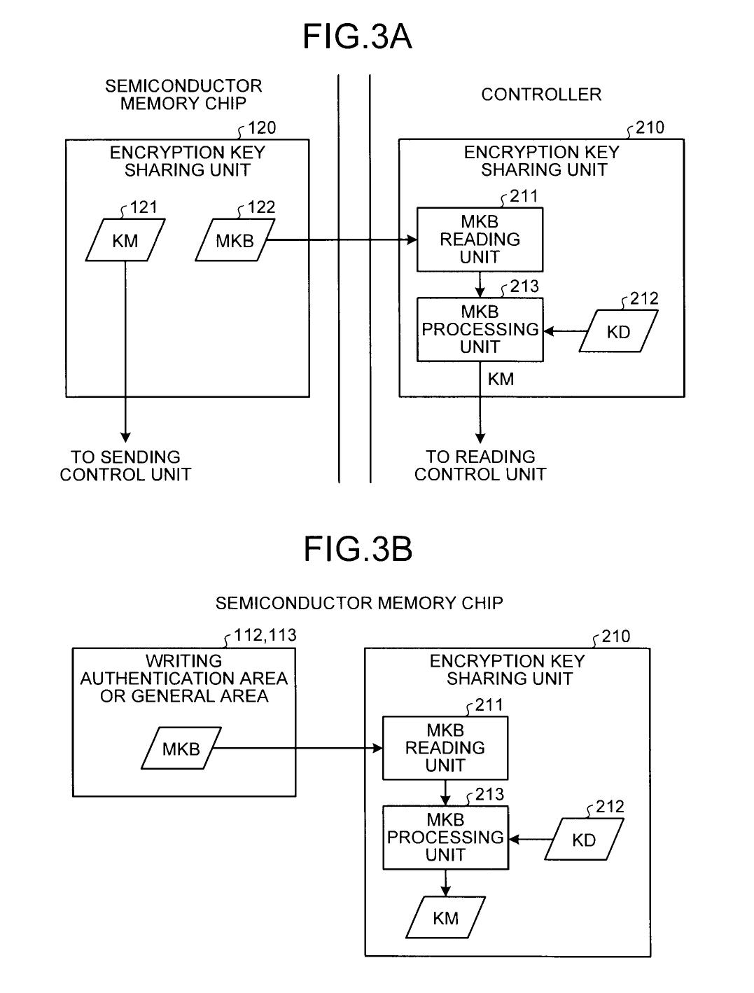

Next, exemplary configurations of the encryption key sharing unit 120 included in the semiconductor memory chip 100 and the encryption key sharing unit 210 included in the controller 200 will be explained with reference to FIG. 3A. As shown in FIG. 3A, the encryption key sharing unit 120 stores therein KM 121 (hereinafter, the “media key KM”) denoting a media key and a media key block (MKB) 122. For example, the MKB 122 is described in the following document: 4C Entity, LLC. “Content Protection for Recordable Media Specification, SD Memory Card Book, Common Part”, Revision 0.961, May 3, 2007. Further, the encryption key sharing unit 210 stores therein a KD 212 denoting a device key. Also, the encryption key sharing unit 210 includes an MKB reading unit 211 and an MKB processing unit 213.

The MKB reading unit 211 reads the MKB 122 from the encryption key sharing unit 120 included in the semiconductor memory chip 100. By processing the read MKB while using the device key KD 212, the MKB processing unit 213 performs MKB processing to derive the media key KM.

In the example shown in FIG. 3A, the encryption key sharing unit 120 included in the semiconductor memory chip 100 authenticates the encryption key sharing unit 210 included in the controller 200.

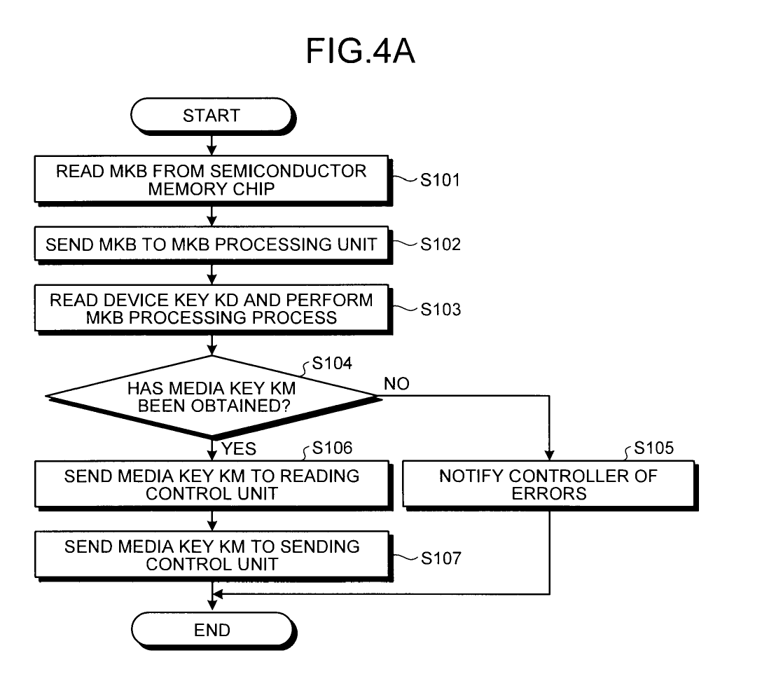

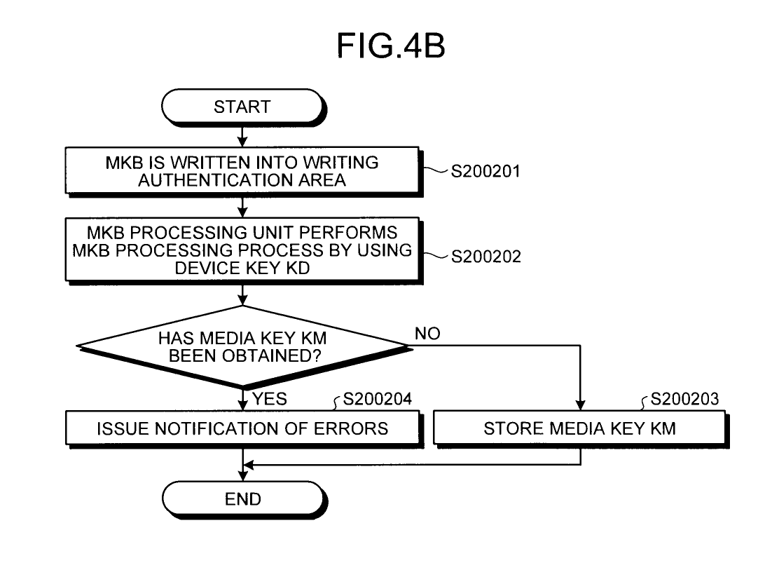

Next, an encryption key sharing process in which the encryption key sharing unit 120 and the encryption key sharing unit 210 that are configured as shown in FIG. 3A share the encryption key will be explained with reference to FIG. 4A. FIG. 4A is a flowchart of an entire flow in the encryption key sharing process according to the second embodiment.

When the controller 200 needs to read data from the reading special area 112 in the semiconductor memory chip 100, the MKB reading unit 211 included in the encryption key sharing unit 210 in the controller 200 reads the MKB 122 stored in the semiconductor memory chip 100 (step S101). The MKB 122 is always free to be read by the controller 200. The MKB reading unit 211 sends the read MKB 122 to the MKB processing unit 213 (step S102).

The MKB processing unit 213 reads the device key KD 212 stored in the encryption key sharing unit 210 included in the controller 200 and performs MKB processing (step S103). After that, the MKB processing unit 213 judges whether the media key KM has been obtained as a result of the MKB processing (step S104). In the case where the device key KD 212 has been revoked by the MKB 122, it is not possible to correctly obtain the media key KM as a result of the MKB processing. In that situation, the MKB processing unit 213 judges that the media key KM has not been obtained (step S104: No) and notifies the controller 200 of an error (step S105). When the controller 200 has received the notification of an error, the controller 200 cancels the reading operation.

In contrast, in the case where the device key KD 212 has not been revoked by the MKB 122, it is possible to obtain the correct media key KM as a result of the MKB processing. In that situation, the MKB processing unit 213 judges that the media key KM has been obtained (step S104: Yes) and sends the obtained media key KM to the reading control unit 220 included in the controller 200 (step S106). Also, on the semiconductor memory chip 100 side, the media key KM stored in the encryption key sharing unit 120 is sent to the sending control unit 130 (step S107).

Next, exemplary configurations of the sending control unit 130 included in the semiconductor memory chip 100 and the reading control unit 220 included in the controller 200 will be explained with reference to FIG. 5. As shown in FIG. 5, the sending control unit 130 includes a random number generating unit 131, a reading unit 132, an encrypting unit 133, and a sending unit 134.

The random number generating unit 131 generates a random number in response to a request from the encrypting unit 133. The reading unit 132 reads the data in the designated reading target page and the ECC of the data from the memory 110. The encrypting unit 133 encrypts the read data by using the media key KM. The sending unit 134 sends the data that has been encrypted (i.e., the encrypted data) and the ECC to a data receiving unit 221 included in the controller 200.

Further, as shown in FIG. 5, the reading control unit 220 includes the data receiving unit 221, a decrypting unit 222, and an error correcting unit 223. The data receiving unit 221 receives the encrypted data and the ECC from the sending unit 134 included in the semiconductor memory chip 100. The decrypting unit 222 decrypts the received encrypted data by using the media key KM. The error correcting unit 223 checks to see if there are any errors in the decrypted data and corrects the errors by using the received ECC.

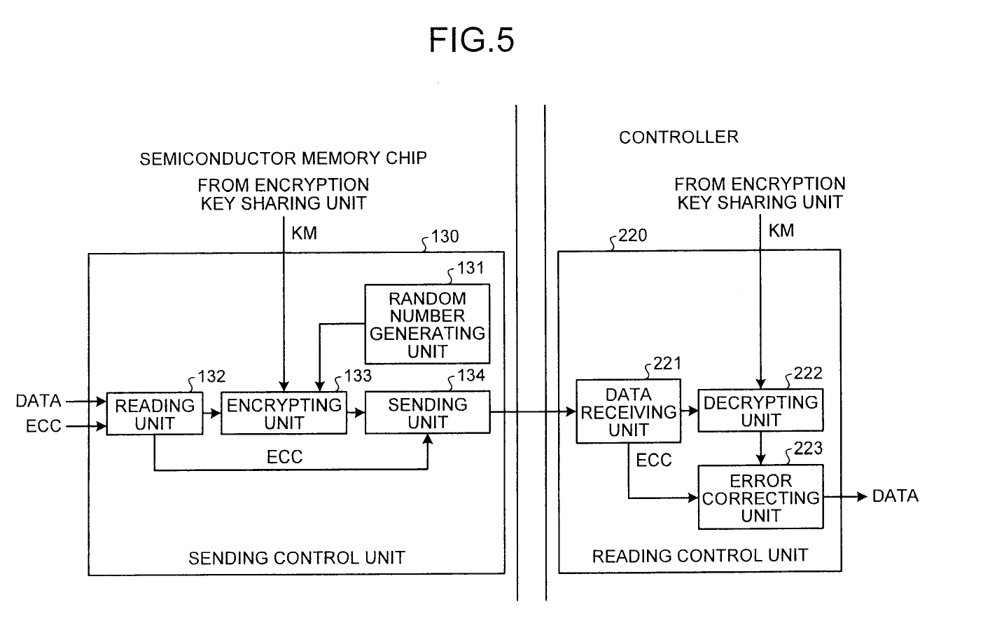

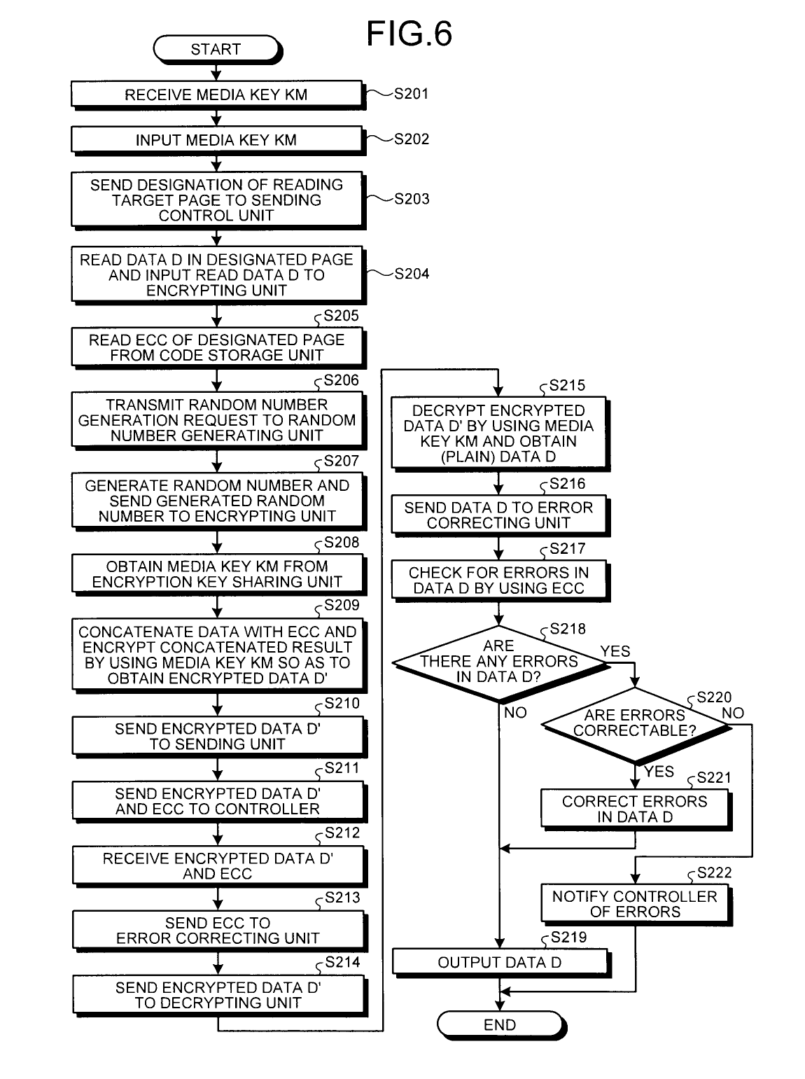

Next, a data reading process in which the data that has been read is transmitted and received between the sending control unit 130 and the reading control unit 220 that are configured as shown in FIG. 5 will be explained with reference to FIG. 6. FIG. 6 is a flowchart of an entire flow in the data reading process according to the second embodiment.

When the reading control unit 220 has received the media key KM from the encryption key sharing unit 210 (step S201), the reading control unit 220 inputs the received media key KM to the decrypting unit 222 (step S202). After that, the reading control unit 220 sends a data sending request to the sending control unit 130. At this time, a designation of the reading target page is also sent together (step S203). The reading unit 132 included in the sending control unit 130 reads the data in the designated page and inputs the read data to the encrypting unit 133 (step S204). Further, the reading unit 132 reads the ECC that corresponds to the reading target page from the code storage unit 111 and inputs the read ECC to the sending unit 134 (step S205).

Subsequently, the encrypting unit 133 sends a random number generation request to the random number generating unit 131 (step S206). The random number generating unit 131 generates a random number and sends the generated random number to the encrypting unit 133 (step S207). The encrypting unit 133 obtains the media key KM from the encryption key sharing unit 120 (step S208). The encrypting unit 133 concatenates the data in the designated page with the random number and generates encrypted data D′ by encrypting the data resulting from the concatenating process while using the media key KM (step S209). After that, the encrypting unit 133 sends the encrypted data D′ to the sending unit 134 (step S210). The sending unit 134 sends the encrypted data D′ that has been input thereto as well as the ECC that has been input thereto to the data receiving unit 221 included in the controller 200 (step S211).

There is a possibility that important data in the reading target page may only be in a part of the page. In that situation, another arrangement is acceptable in which the encrypting unit 133 encrypts only the part of the page that contains the important data. For example, in the case where only 48 bytes at the head of the page is important data, an arrangement is acceptable in which the encrypting unit 133 encrypts only 64-byte data obtained by concatenating the 48-byte data at the head of the page with a 16-byte random number. With this arrangement, it is possible to keep at minimum the increase in the processing load caused by the encrypting process.

Subsequently, the data receiving unit 221 included in the reading control unit 220 receives the encrypted data and the ECC (step S212). After that, the data receiving unit 221 sends the received ECC to the error correcting unit 223 (step S213). The error correcting unit 223 stores therein the received ECC. Further, the data receiving unit 221 sends the received encrypted data D′ to the decrypting unit 222 (step S214). The decrypting unit 222 decrypts the encrypted data D′ by using the media key KM that has been received from the encryption key sharing unit 210 included in the controller 200 (step S215).

As a result of the decrypting process, the read data D that is plain data and the random number are obtained. The decrypting unit 222 is able to distinguish, in the decrypted data, the read data D from the random number, according to a predetermined format. For example, in the example described above in which the encrypting unit 133 encrypts only the 64 bytes, the 48 bytes at the head of the decrypted data represent the read data D, whereas the following 16 bytes represent the random number.

The decrypting unit 222 transfers only the read data D to the error correcting unit 223 (step S216). The error correcting unit 223 checks for errors in the read data D by using the ECC stored therein (step S217). The error correcting unit 223 then judges whether there are any errors (step S218). In the case where there is no error (step S218: No), the controller 200 outputs the read data D to the external device that has requested the reading of the read data D (step S219).

In the case where there are one or more errors (step S218: Yes), the error correcting unit 223 further judges whether the errors are correctable (step S220). In the case where the errors are correctable (step S220: Yes), the error correcting unit 223 corrects the errors in the read data D by using the ECC stored therein (step S221). After that, the controller 200 outputs the read data D that has been corrected (step S219).

In the case where the errors are not correctable (step S220: No), the error correcting unit 223 notifies the controller 200 of the errors (step S222). In that situation, the controller 200 transmits information indicating that the errors have occurred to the external device that has requested the reading of the data.

As a result of the process explained with reference to FIG. 4A, only the legitimate controller 200 having the valid device key KD 212 is able to obtain the media key KM, which is the encryption key shared with the semiconductor memory chip 100. Also, as a result of the process explained with reference to FIG. 6, only the legitimate controller 200 is able to obtain the data that has properly been decrypted by using the common media key KM. In other words, it is possible to realize the configuration in which the controller 200 is authenticated by the semiconductor memory chip 100.

As explained above, the set made up of the encryption key sharing unit 120 and the sending control unit 130 that are included in the semiconductor memory chip 100 is an authenticating unit that authenticates the controller 200. The area in the memory 110 within the semiconductor memory chip 100 that stores therein the data read by the authenticating unit corresponds to the reading special area.

The configurations of the encryption key sharing unit 120 and the encryption key sharing unit 210 are not limited to the ones shown in FIG. 3A. Any other configurations are applicable as long as the configuration allows the encryption key to be shared between the semiconductor memory chip 100 and the controller 200.

As explained above, it is possible to use the MKB so that the semiconductor memory chip is able to authenticate the controller. The MKB is usually recorded into the writing special area or the general area in the semiconductor memory chip while the semiconductor memory chip is being manufactured. In some situations, a device including the semiconductor memory chip and the controller according to the embodiment can be connected to a writing device via a network. In some other situations, a memory card configured with the semiconductor memory chip and the controller according to the embodiment can be connected to a writing device provided at a store. When the semiconductor memory chip according to the embodiment is connected to a writing device via a controller, it is a good opportunity to update the MKB stored in the semiconductor memory chip. The MKB contains information used for revoking the device key stored in the controller. Thus, it is desirable to keep the MKB up-to-date. The method for updating the MKB by using the writing device is simple. For example, the writing device can overwrite the MKB stored in the writing authentication area (explained later) or in the general area via the controller.

To improve the frequency with which the MKB is updated, it is desirable to provide a mechanism in which the semiconductor memory chip itself is able to update the media key stored in the semiconductor memory chip. Such a mechanism is shown in FIG. 3B. In this mechanism, the media key KM stored in the encryption key sharing unit is updated. A new MKB is written at a predetermined address in a writing authentication area 200202 (step S200201). Being triggered by this writing process, an encryption key sharing unit 200201 reads the MKB and sends the MKB to an MKB processing unit 2002012. The MKB processing unit 2002012 reads the device key KD stored in the encryption key sharing unit and performs MKB processing (step S200202). In the case where the device key KD has not been revoked by the MKB, the media key KM is obtained. The encryption key sharing unit stores and holds the media key KM therein (step S200203). In the case where the device key KD has been revoked by the MKB, the encryption key sharing unit issues a notification of an error and stops the process (step S200204). For the operation described above, FIG. 4B should be referred to.

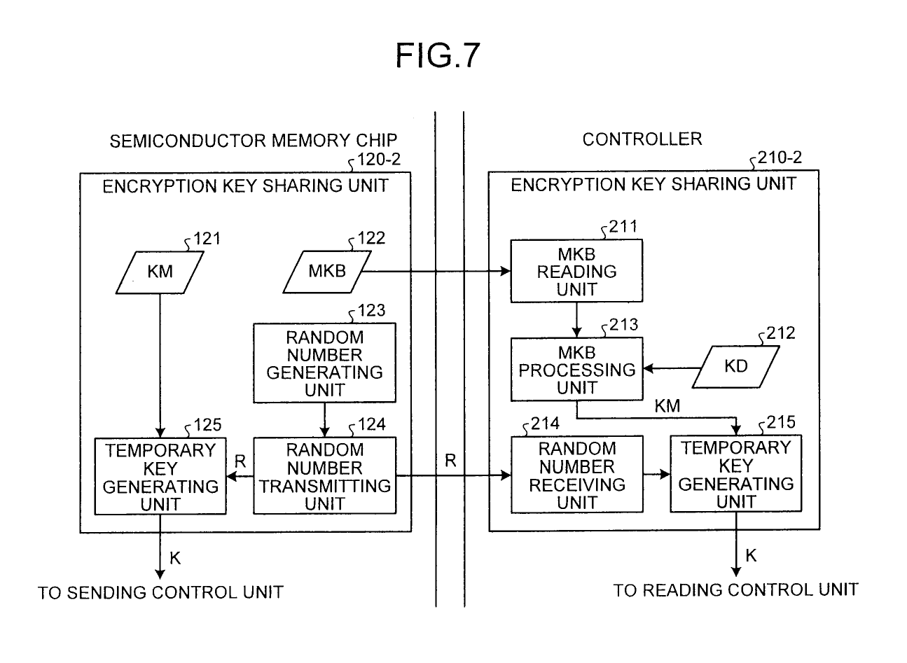

FIG. 7 is a block diagram of a modification example (i.e., an encryption key sharing unit 120-2) of the encryption key sharing unit 120 and a modification example (i.e., an encryption key sharing unit 210-2) of the encryption key sharing unit 210. As shown in FIG. 7, the encryption key sharing unit 120-2 stores therein the media key KM and the MKB 122. Further, the encryption key sharing unit 120-2 includes a random number generating unit 123, a random number transmitting unit 124, and a temporary key generating unit 125. Further, the encryption key sharing unit 210-2 includes a device key KD 212, an MKB reading unit 211, an MKB processing unit 213, as well as a random number receiving unit 214 and a temporary key generating unit 215.

The random number generating unit 123 generates a random number in response to a request from the random number transmitting unit 124. The random number transmitting unit 124 transmits the generated random number to the random number receiving unit 214 included in the controller 200 and to the temporary key generating unit 125 included in the semiconductor memory chip 100. The temporary key generating unit 125 generates a temporary key K by using the media key KM and the received random number. For example, the temporary key generating unit 125 generates the temporary key K from the media key KM and the random number, by using a one-way function such as Advanced Encryption Standard-G (AES-G).

The random number receiving unit 214 receives the random number from the random number transmitting unit 124. By using the same method as the one used by the temporary key generating unit 125 included in the semiconductor memory chip 100, the temporary key generating unit 215 generates the temporary key K from the media key that has been received from the MKB processing unit 213 and the random number that has been received by the random number receiving unit 214.

In the example shown in FIG. 7 also, the encryption key sharing unit 120-2 included in the semiconductor memory chip 100 authenticates the encryption key sharing unit 210-2 included in the controller 200.

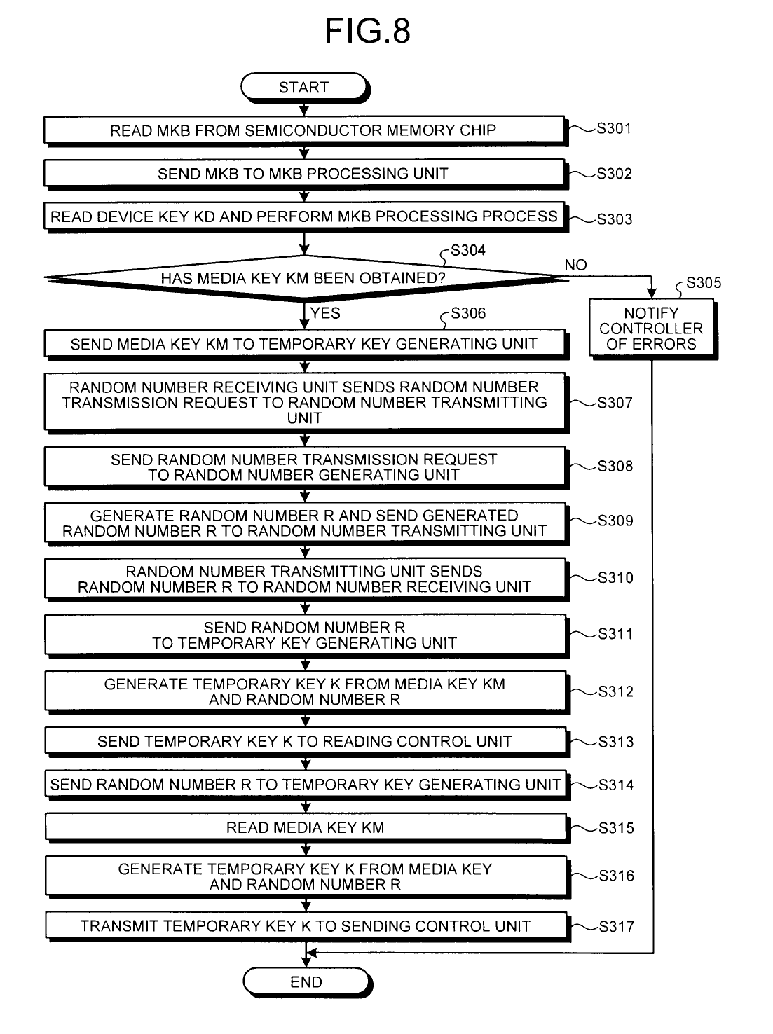

Next, an encryption key sharing process in which the encryption key sharing unit 120-2 and the encryption key sharing unit 210-2 that are configured as shown in FIG. 7 share the encryption key will be explained with reference to FIG. 8. FIG. 8 is a flowchart of an entire flow in the encryption key sharing process according to the modification example of the second embodiment.

The process performed at steps 5301 through 5305 is the same as the process performed at steps S101 through S105 shown in FIG. 4A. Thus, the explanation thereof will be omitted.

In the case where it has been judged, at step S304, that the correct media key KM has been obtained (step S304: Yes), the MKB processing unit 213 sends the obtained media key KM to the temporary key generating unit 215 (step S306). After that, the random number receiving unit 214 included in the encryption key sharing unit 210 in the controller 200 sends a random number transmission request to the random number transmitting unit 124 included in the semiconductor memory chip 100 (step S307). The random number transmitting unit 124 sends a random number generation request to the random number generating unit 123 (step S308). The random number generating unit 123 generates a random number R (step S309). The random number transmitting unit 124 receives the generated random number R and transmits the random number R to the random number receiving unit 214 included in the controller 200 (step S310). The random number receiving unit 214 included in the controller 200 transfers the received random number R to the temporary key generating unit 215 included in the controller 200 (step S311). The temporary key generating unit 215 generates the temporary key K from the media key KM that has been received from the MKB processing unit 213 and the random number R (step S312). Further, the temporary key generating unit 215 sends the generated temporary key K to the reading control unit 220 included in the controller 200 (step S313).

In addition, the random number transmitting unit 124 also sends the random number R to the temporary key generating unit 125 included in the semiconductor memory chip 100 (step S314). The temporary key generating unit 125 that has received the random number R reads the media key KM that is stored in advance in the encryption key sharing unit 120 included in the semiconductor memory chip 100 (step S315). After that, the temporary key generating unit 125 generates the temporary key K by combining the media key KM with the random number R (step S316). Further, the temporary key generating unit 125 sends the generated temporary key K to the sending control unit 130 included in the semiconductor memory chip 100 (step S317).

When the MKB processing has correctly been performed by the controller 200 so that the correct media key KM is generated, the temporary keys K that are generated by the semiconductor memory chip 100 and by the controller 200 independently should be the same.

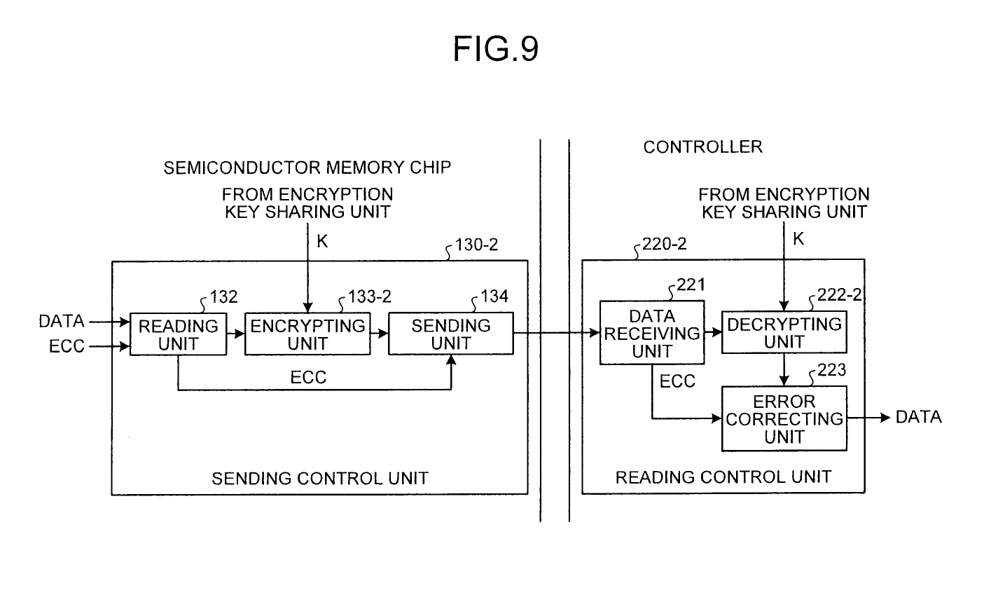

Next, a modification example (i.e., a sending control unit 130-2) of the sending control unit 130 and a modification example (i.e., a reading control unit 220-2) of the reading control unit 220 that correspond to the encryption key sharing unit 120-2 and the encryption key sharing unit 210-2 that are configured as shown in FIG. 7 will be explained with reference to FIG. 9. As shown in FIG. 9, the sending control unit 130-2 includes the reading unit 132, an encrypting unit 133-2, and the sending unit 134. The sending control unit 130-2 according to the present modification example is different from the sending control unit 130 shown in FIG. 5 in that the random number generating unit 131 is eliminated and that the encrypting unit 133-2 has a different function. A major difference between the encrypting unit 133-2 and the encrypting unit 133 shown in FIG. 5 is that the encrypting unit 133-2 encrypts the data by using the temporary key K, instead of the media key KM.

Further, as shown in FIG. 9, the reading control unit 220-2 includes the data receiving unit 221, a decrypting unit 222-2, and the error correcting unit 223. The reading control unit 220-2 according to the present modification example is different from the reading control unit 220 shown in FIG. 5 with respect to the function of the decrypting unit 222-2. A major difference between the decrypting unit 222-2 and the decrypting unit 222 shown in FIG. 5 is that the decrypting unit 222-2 decrypts the data by using the temporary key K, instead of the media key KM.

Next, a data reading process in which the data that has been read is transmitted and received between the sending control unit 130-2 and the reading control unit 220-2 that are configured as shown in FIG. 9 will be explained with reference to FIG. 10. FIG. 10 is a flowchart of an entire flow in the data reading process according to the modification example of the second embodiment.

When the decrypting unit 222-2 included in the reading control unit 220-2 has received the temporary key K from the encryption key sharing unit 210-2 (step S401), the decrypting unit 222-2 stores therein the received temporary key K. Further, the data receiving unit 221 sends a data sending request to the sending control unit 130-2 included in the semiconductor memory chip 100, together with a designation of the reading target page (step S402). The sending control unit 130 sends the designation of the reading target page and a data read instruction to the reading unit 132 (step S403). The reading unit 132 reads the data D from the reading target page in the memory 110 (step S404).

The encrypting unit 133-2 receives the temporary key K from the encryption key sharing unit 120-2 (step S405). After that, the encrypting unit 133-2 encrypts the data D by using the temporary key K and generates encrypted data D′=Enc(K, D) (step S406). Enc(K, D) signifies that the data D is encrypted by using the temporary key K. The encrypting unit 133-2 sends the generated encrypted data D′ to the sending unit 134 (step S407).

The reading unit 132 reads the ECC of the data D from the code storage unit 111 included in the memory 110 (step S408). The sending unit 134 stores therein the read ECC. The sending unit 134 sends the encrypted data D′ and the stored ECC to the data receiving unit 221 included in the reading control unit 220-2 (step S409).

When the data receiving unit 221 has received the encrypted data D′ and the ECC from the sending unit 134, the data receiving unit 221 sends the encrypted data D′ to the decrypting unit 222-2 (step S410) and sends the ECC to the error correcting unit 223 (step S411). The error correcting unit 223 stores therein the received ECC. When the decrypting unit 222-2 has received the encrypted data D′, the decrypting unit 222-2 decrypts the encrypted data D′ by using the stored temporary key K and obtains the data D (step S412). After that, the decrypting unit 222-2 sends the data D resulting from the decrypting process to the error correcting unit 223 (step S413).

The process performed at steps S414 through S419 is the same as the process performed at steps S217 through S222 shown in FIG. 6. Thus, the explanation thereof will be omitted.

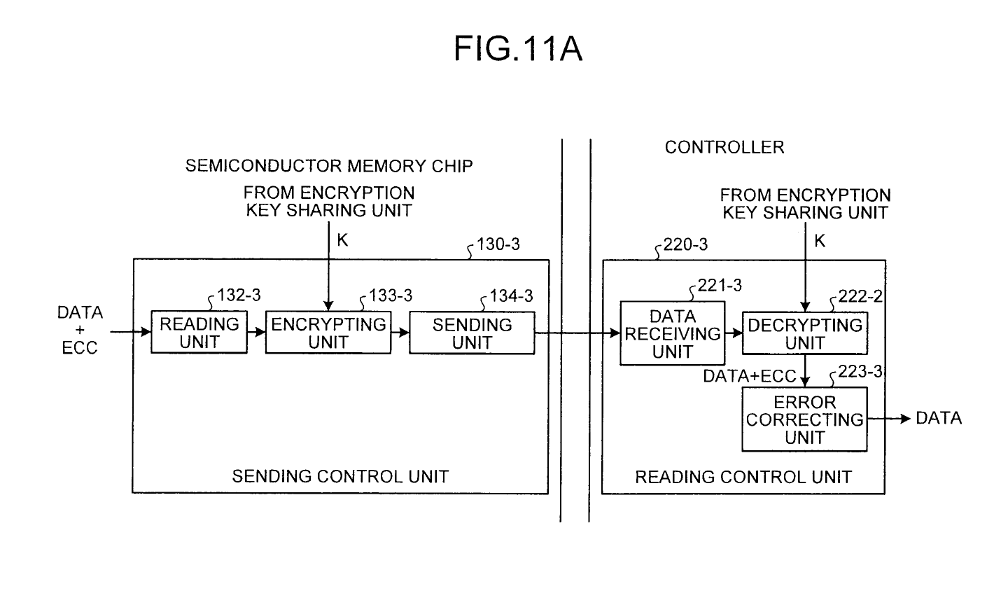

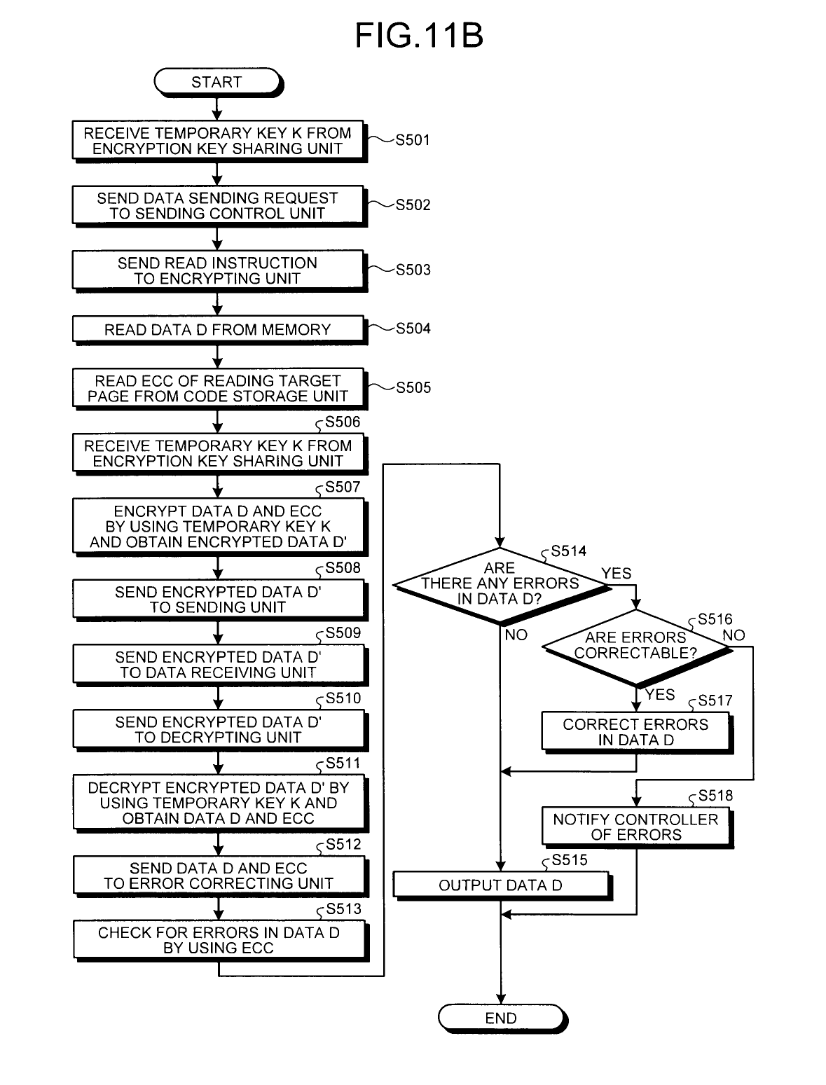

Next, other modification examples (i.e., a sending control unit 130-3 and a reading control unit 220-3) of the sending control unit 130 and the reading control unit 220 that correspond to the encryption key sharing unit 120-2 and the encryption key sharing unit 210-2 that are configured as shown in FIG. 7 will be explained, with reference to FIG. 11A. As shown in FIG. 11A, the sending control unit 130-3 includes a reading unit 132-3, an encrypting unit 133-3, and a sending unit 134-3.

The reading unit 132-3 transmits the read ECC to the encrypting unit 133-3, not to the sending unit 134-3. The encrypting unit 133-3 encrypts the data obtained by concatenating the data D with the ECC. The sending unit 134-3 sends the data that has been encrypted in this manner to the reading control unit 220-3.

As shown in FIG. 11A, the reading control unit 220-3 includes a data receiving unit 221-3, a decrypting unit 222-3, and an error correcting unit 223-3.

The data receiving unit 221-3 receives the encrypted data obtained by encrypting the data D and the ECC and transmits the received encrypted data to the decrypting unit 222-3. The decrypting unit 222-3 decrypts the encrypted data so as to obtain the data D and the ECC and transmits the data D and the ECC to the error correcting unit 223-3. The error correcting unit 223-3 performs a process to check for errors and to correct the errors, by using the data D and the ECC that have been received from the decrypting unit 222-3 in the manner described above.

Next, a data reading process in which the data that has been read is transmitted and received between the sending control unit 130-3 and the reading control unit 220-3 that are configured as shown in FIG. 11A will be explained, with reference to FIG. 11B. FIG. 11B is a flowchart of an entire flow in the data reading process according to the other modification examples of the second embodiment.

When the decrypting unit 222-3 included in the reading control unit 220 has received the temporary key K from the encryption key sharing unit 210-2 (step S501), the decrypting unit 222-3 stores therein the received temporary key K. Further, the data receiving unit 221-3 sends a data sending request to the sending control unit 130-3 included in the semiconductor memory chip 100, together with a designation of the reading target page (step S502). The sending control unit 130-3 sends the designation of the reading target page and a data read instruction to the reading unit 132-3 (step S503). The reading unit 132-3 reads the data D in the designated reading target page in the memory (step S504). Further, the reading unit 132-3 reads the ECC of the read data D from the code storage unit 111 included in the memory 110 (step S505). After that, the encrypting unit 133-3 receives the temporary key K from the encryption key sharing unit 120-2 (step S506). The encrypting unit 133-3 generates encrypted data D′=Enc(K, D∥ECC) by encrypting, while using the received temporary key K, data D∥ECC obtained by concatenating the data D with the ECC (step S507). After that, the encrypting unit 133-3 sends the encrypted data D′ to the sending unit 134 (step S508). The sending unit 134 sends the encrypted data D′ to the data receiving unit 221 included in the reading control unit 220 (step S509).

When the data receiving unit 221 has received the encrypted data D′ from the sending unit 134, the data receiving unit 221 sends the encrypted data D′ to the decrypting unit 222-3 (step S510). When the decrypting unit 222-3 has received the encrypted data D′, the decrypting unit 222-3 decrypts the encrypted data D′ by using the temporary key K stored therein and obtains the data D and the ECC (step S511). The decrypting unit 222-3 sends the data D and the ECC to the error correcting unit 223-3 (step S512).

The process performed at steps S513 through S518 is the same as the process performed at steps S217 through S222 shown in FIG. 6 (or at steps S414 through S419 shown in FIG. 10). Thus, the explanation thereof will be omitted.

The set made up of the encryption key sharing unit 120-2 shown in FIG. 7 and either the sending control unit 130-2 shown in FIG. 9 or the sending control unit 130-3 shown in FIG. 11A is considered to be an authenticating unit that authenticates the controller 200. The area in the memory 110 within the semiconductor memory chip 100 that stores therein the data read by the authenticating unit corresponds to the reading special area.

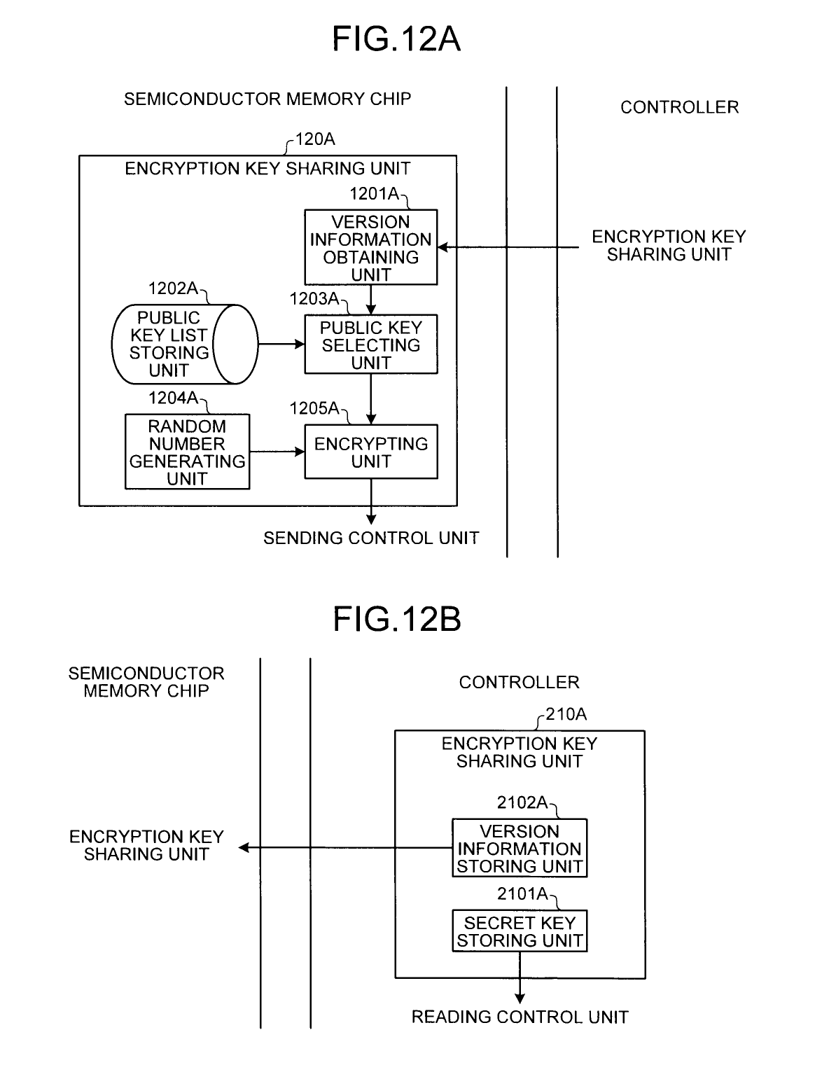

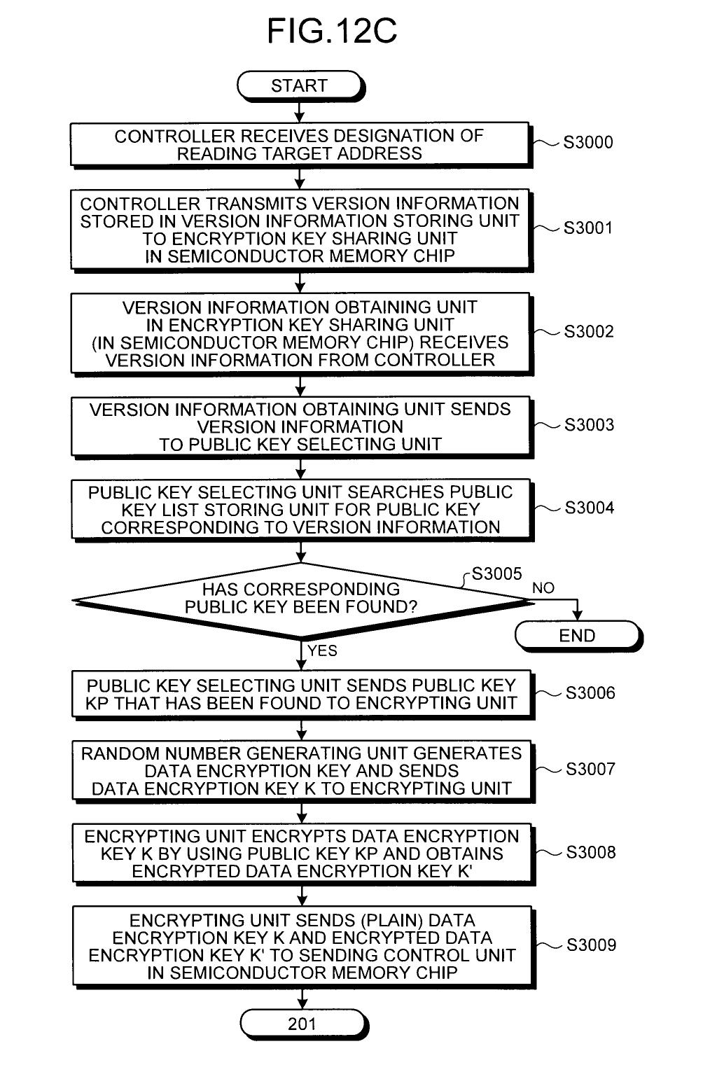

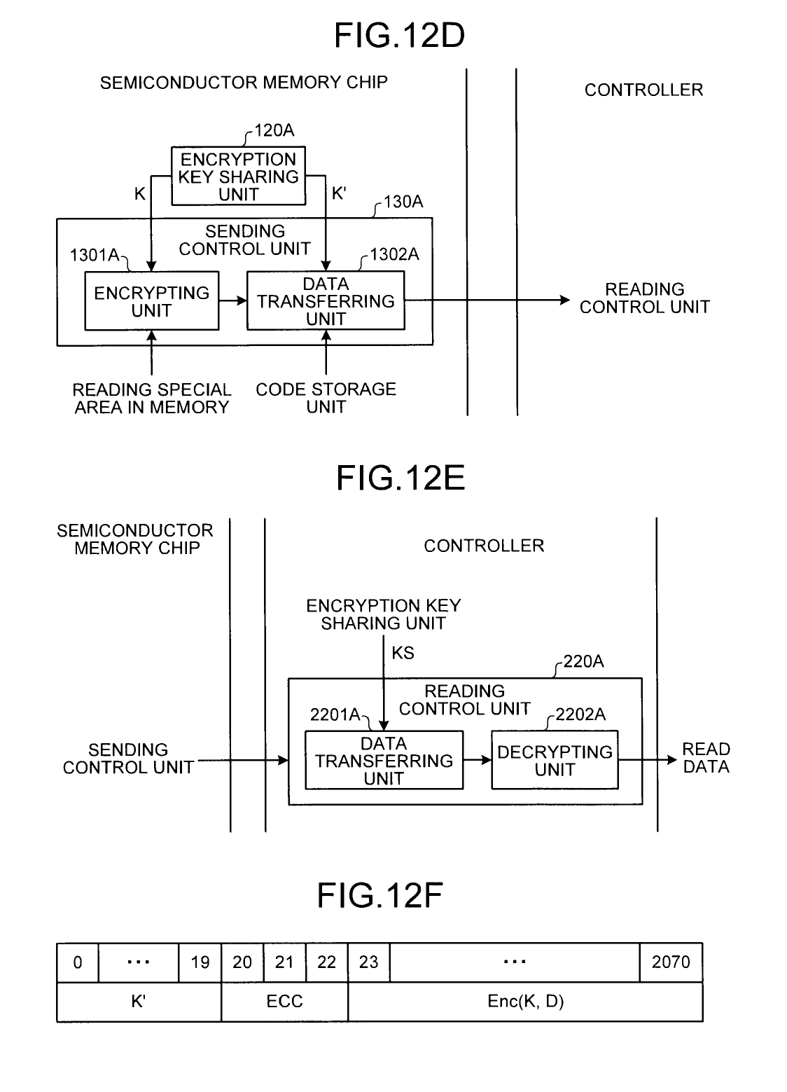

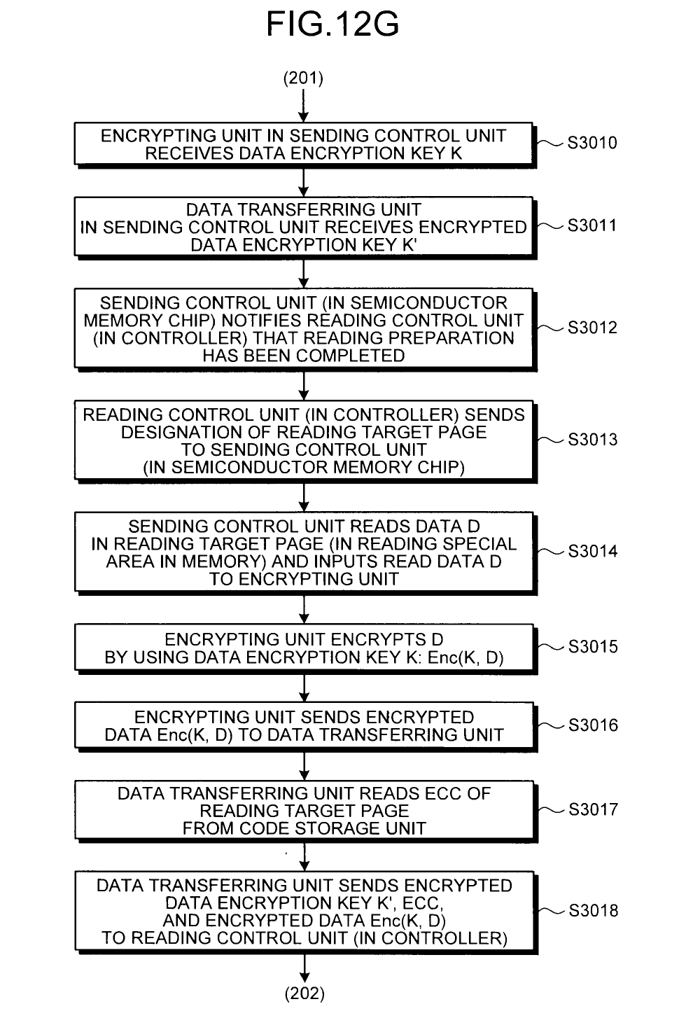

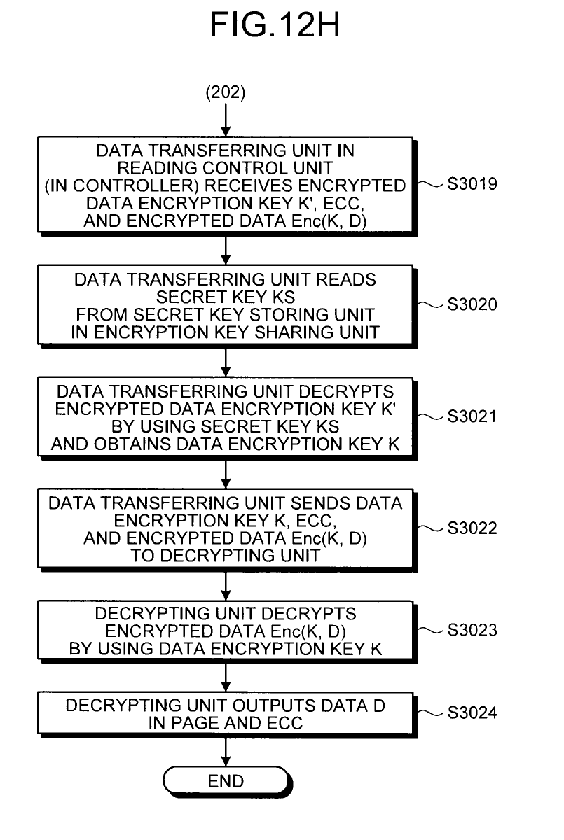

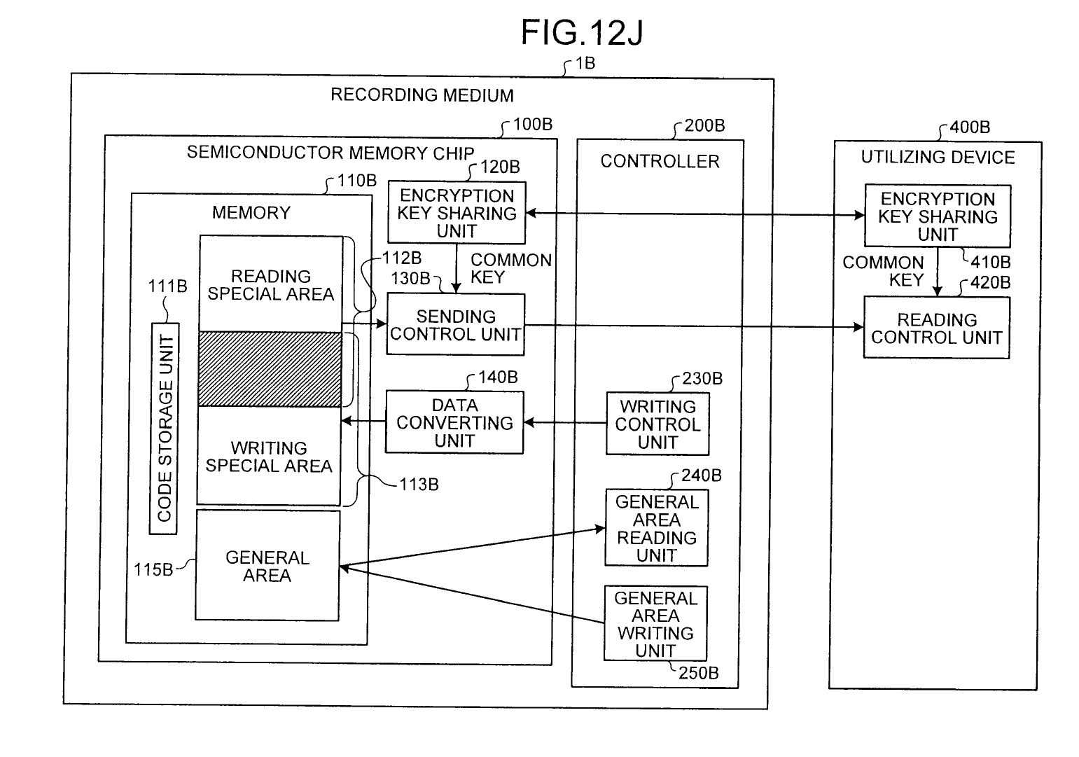

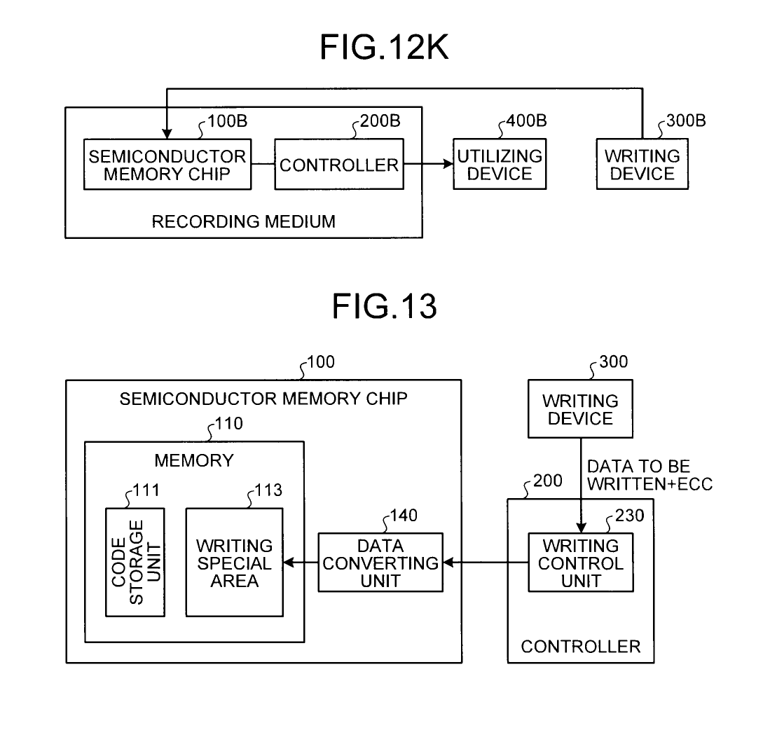

Next, an embodiment in which a semiconductor memory chip authenticates a controller by using a public key will be explained. FIG. 12A is a block diagram of the semiconductor memory chip and the controller according to the present embodiment. Configurations of encryption key sharing units included in the semiconductor memory chip and in the controller according to the present embodiment are shown in the block diagrams in FIGS. 12A and 12B, respectively. An encryption key sharing unit 120A included in a semiconductor memory chip 100A includes a version information obtaining unit 1201A that receives version information of a controller 200A. Also, the encryption key sharing unit 120A includes a public key list storing unit that stores therein one or more public keys. According to the present embodiment, the version information corresponds to a secret key stored in the controller 200A. In other words, by finding out the version information of the controller 200A, it is possible to determine the public key that corresponds to the secret key stored in the controller 200A. A random number generating unit included in the encryption key sharing unit 120A in the semiconductor memory chip 100A generates an encryption key used for encrypting the data in a page to be transferred. An encryption key sharing unit 210A included in the controller 200A includes a secret key storing unit 2101A that stores the secret key therein and a version information storing unit 2102A that stores therein the version information that corresponds to the secret key. The version information is, for example, a numerical value or a character string.

In FIG. 12C, an operation performed by the encryption key sharing units (120A and 210A) that are respectively included in the semiconductor memory chip 100A and the controller 200A is shown. A designation of a reading target page (within a reading special area) is input to the controller 200A (step S3000). The controller 200A sends the version information stored in the version information storing unit 2102A included in the encryption key sharing unit 210A in the controller 200A to the semiconductor memory chip 100A (step S3001). The version information obtaining unit 1201A included in the encryption key sharing unit 120A in the semiconductor memory chip 100A receives the version information (step S3002). The version information obtaining unit 1201A sends the received version information to a public key selecting unit 1203A (step S3003). The public key selecting unit 1203A searches for a public key that corresponds to the version information (step S3004). In the case where the public key that corresponds to the version information was not found, the encryption key sharing unit 120A cancels the operation and does not perform the process thereafter. Otherwise, the public key selecting unit 1203A sends the public key KP that has been found in the search to an encrypting unit 1205A (step S3006). A random number generating unit 1204A generates a data encryption key K and sends the data encryption key K to the encrypting unit 1205A (step S3007). The encrypting unit 1205A encrypts the data encryption key K by using the public key KP. The result of the encrypting process will be referred to as K′ (step S3008). In other words, K′=Enc(KP, K) is satisfied. The encrypting unit 1205A sends the data encryption key K and the encrypted data encryption key K′ to a sending control unit 130A included in the semiconductor memory chip 100A (step S3009).

FIG. 12D is a block diagram of the sending control unit 130A included in the semiconductor memory chip 100A according to the present embodiment. FIG. 12E is a block diagram of the reading control unit 220A included in the controller 200A according to the present embodiment. A part of the operation according to the present embodiment is shown in FIGS. 12G and 12H. The operation shown in FIGS. 12G and 12H is continued from the operation shown in FIG. 12C. At step S3009 in FIG. 12C, the sending control unit 130A included in the semiconductor memory chip 100A receives the data encryption key K and the encrypted data encryption key K′. In this situation, an encrypting unit 1301A included in the sending control unit 130A receives the encryption key K (step S3010), whereas a data transferring unit 1302A included in the sending control unit 130A receives the encrypted data encryption key K′ (step S3011). After that, the sending control unit 130A included in the semiconductor memory chip 100A notifies the reading control unit 220A included in the controller 200A that a preparation for a reading process has been completed (step S3012). When having received the notification, the reading control unit 220A included in the controller 200A sends a designation of the reading target page to the sending control unit 130A included in the semiconductor memory chip 100A (step S3013). The sending control unit 130A reads the data D in the reading target page (in the reading special area within the memory) and inputs the read data D to the encrypting unit 1301A (step S3014). The encrypting unit 1301A encrypts the data D by using the data encryption key K so as to obtain Enc(K, D) (step S3015) and sends the encrypted data Enc(K, D) to the data transferring unit 1302A (step S3016). The data transferring unit 1302A reads the ECC of the reading target page from the code storage unit (step S3017). The data transferring unit 1302A sends the encrypted data encryption key K′, the ECC, and the encrypted data Enc(K, D) to the reading control unit 220A included in the controller 200A (step S3018).

A format of the data that is sent by the data transferring unit 1302A to the controller is shown in FIG. 12F. The encrypted data encryption key has a size of 20 bytes. The size of the data encryption key itself is 16 bytes; however, according to the present embodiment, because 160-bit elliptic curve cryptography is adopted as a public key encrypting method, the size of the encrypted data encryption key is 20 bytes. The size of each of the pages in the memory is 2 K bytes=2048 bytes. The size of an ECC of the data in each of the pages is 3 bytes. In the example shown in FIG. 12F, the pieces of data are arranged in a row in the following order: the 20-byte encrypted data encryption key, the ECC, and the encrypted data.

Subsequently, as shown in FIG. 12H, the data transferring unit included in the reading control unit in the controller receives the encrypted data encryption key K′, the ECC, and the 2K-byte encrypted data that are in the data format described above (step S3019). The data transferring unit reads a secret key KS from the secret key storing unit included in the encryption key sharing unit (step S3020). The data transferring unit decrypts the encrypted data encryption key K′ by using the secret key KS and obtains the data encryption key K (step S3021). The data transferring unit sends the data encryption key K, the ECC, and the encrypted data Enc(K, D) to the decrypting unit (step S3022). The decrypting unit decrypts the encrypted data Enc(K, D) by using the data encryption key K and obtains the data D (step S3023). The decrypting unit outputs the data D and the ECC as data that has been read (step S3024). A utilizing device corrects errors in the data D by using the ECC, as necessary.

As described above, because the authenticating unit that authenticates the controller 200 by using the reading special area is provided, it is possible to prevent illegitimate use of the data that is realized by, for example, counterfeiting memory cards.

In the embodiment above, the controller is authenticated by the semiconductor memory chip; however, another arrangement is acceptable in which the semiconductor memory chip authenticates a utilizing device such as a playback device. In that situation, the utilizing device performs the same operation as the one performed by the controller (e.g., to read the MKB from the semiconductor memory chip and process the read MKB) and reads the data from the reading special area in the semiconductor memory chip so as to utilize the read data. A configuration in a situation where a utilizing device is authenticated is shown in the block diagram in FIG. 12J. A characteristic of the configuration shown in FIG. 12J that is different from the configuration shown in FIG. 2B is that the utilizing device includes an encryption key sharing unit and a reading control unit. The operations performed by the constituent elements are the same as those in the example shown in FIG. 2B. During the operation to read the data from the reading special area, the controller only relays the data simply. With the configuration shown in FIG. 12J, a trust chain as shown in FIG. 12K is structured. The writing device authenticates the semiconductor memory, whereas the semiconductor memory authenticates the utilizing device.

Next, in the following sections, a configuration to realize a situation where a semiconductor memory chip 100B is authenticated by a writing device 300B by using a writing special area 113B will be explained. With this configuration also, it is possible to prevent illegitimate use of data that is realized by, for example, counterfeiting memory cards. Further, by having an arrangement in which both the function to read data from a reading special area 112B (i.e., a common area) and the function to write data into a writing special area 113B (i.e., the common area) are provided, it is possible to incorporate the semiconductor memory chip 100B into a trust chain as described above. As a result, it is possible to further enhance the security function.

FIG. 13 is a diagram explaining a manner in which data is written into the writing special area 113 in the semiconductor memory chip 100, while the writing device 300 is connected to the controller 200. It should be noted that only the part that is related to the writing process is shown in FIG. 13.

First, the writing device 300 transmits encrypted data obtained by encrypting the data (i.e., the data to be written) for which a writing process has been requested, a designation of a writing destination page, and an ECC that corresponds to the data to be written, to the controller 200. The writing control unit 230 included in the controller 200 sends the encrypted data and the ECC to the data converting unit 140 included in the semiconductor memory chip 100. The data converting unit 140 converts (i.e., decrypts) the encrypted data, writes the converted data that has been obtained (i.e., the data to be written) into the writing special area 113, and writes the ECC into the code storage unit 111.

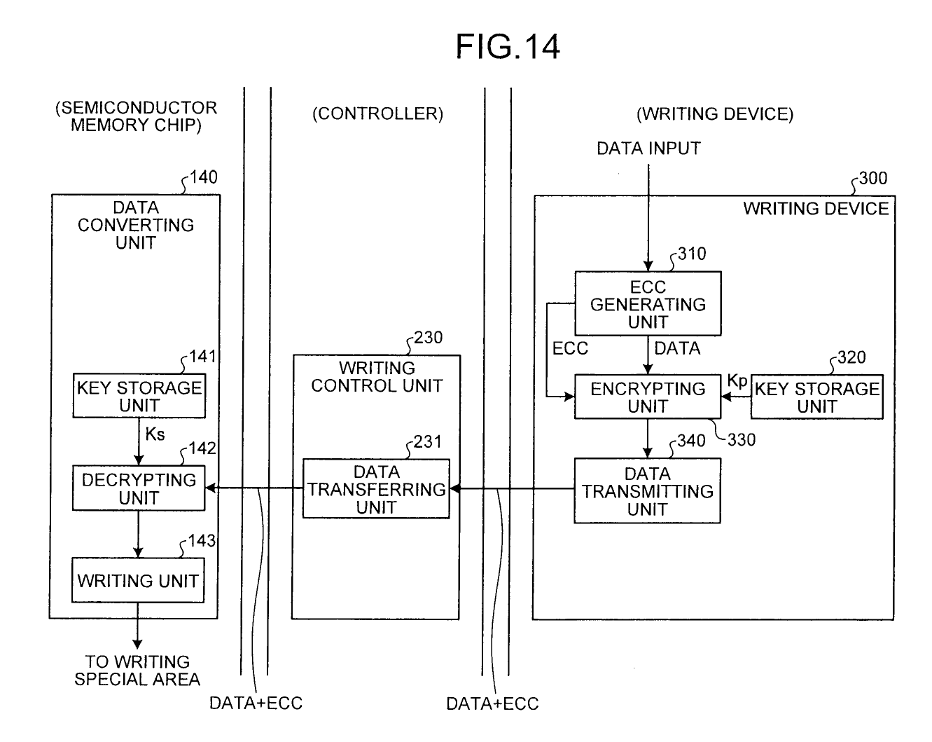

Next, exemplary configurations of the writing device 300, the writing control unit 230 included in the controller 200, and the data converting unit 140 included in the semiconductor memory chip 100 shown in FIG. 13 will be explained, with reference to FIG. 14. As shown in FIG. 14, the writing device 300 includes an ECC generating unit 310, a key storage unit 320, an encrypting unit 330, and a data transmitting unit 340.

The ECC generating unit 310 generates an ECC of the data to be written that has been input as the data that needs to be written. The key storage unit 320 stores therein a data conversion key (i.e., a first key) to be used for converting the data to be written. According to the second embodiment, the key storage unit 320 stores therein a public key Kp according to a public key method as the data conversion key. The public key Kp is a public key that corresponds to a secret key Ks, which is a data conversion key (i.e., a second key) stored in a key storage unit 141 (explained later) included in the semiconductor memory chip 100.

The encrypting method that is applicable is not limited to the public key method. In the following sections, an example will be explained in which the writing device 300 encrypts the data to be written by using the data conversion key (i.e., the public key Kp), whereas the semiconductor memory chip 100 decrypts the data to be written by using the corresponding data conversion key (i.e., the secret key Ks) and stores the decrypted data into the memory 110. As long as the writing device 300 converts the data by using the data conversion key (i.e., the first key), whereas the semiconductor memory chip 100 converts the converted data by using the data conversion key (i.e., the second key) corresponding to the first key, it is acceptable to apply any other converting method. For example, another arrangement is acceptable in which the writing device 300 performs a converting process being equivalent to a decrypting process by using the first key, whereas the semiconductor memory chip 100 performs a converting process being equivalent to an encrypting process by using the second key that corresponds to the first key.

The encrypting unit 330 encrypts the data to be written by using the public key Kp. Also, the encrypting unit 330 generates a code (i.e., a converted code) obtained by encrypting the ECC by using the public key Kp. In the following sections, the data to be written that has been encrypted may be referred to as “encrypted data”, whereas the converted code obtained by encrypting the ECC may be referred to as “encrypted ECC”. The data transmitting unit 340 transmits the encrypted data, the encrypted ECC, and a designation of the writing destination page to the writing control unit 230 included in the controller 200.

Next, an exemplary configuration of the writing control unit 230 included in the controller 200 will be explained. As shown in FIG. 14, the writing control unit 230 includes a data transferring unit 231. The data transferring unit 231 receives the encrypted data, the encrypted ECC, and the designation of the writing destination page and transmits these pieces of information to the data converting unit 140 included in the semiconductor memory chip 100.

Next, an exemplary configuration of the data converting unit 140 will be explained. As shown in FIG. 14, the data converting unit 140 includes a key storage unit 141, a decrypting unit 142, and a writing unit 143.

The key storage unit 141 stores therein the secret key Ks according to the public key method. The decrypting unit 142 decrypts the encrypted data and the encrypted ECC by using the secret key Ks stored in the key storage unit 141. The data to be written that has been obtained by decrypting the encrypted data corresponds to the converted data. The writing unit 143 records the data to be written that has been decrypted into the designated page in the writing special area 113 in the memory 110. Also, the writing unit 143 stores the decrypted ECC into the code storage unit 111 in the memory 110.

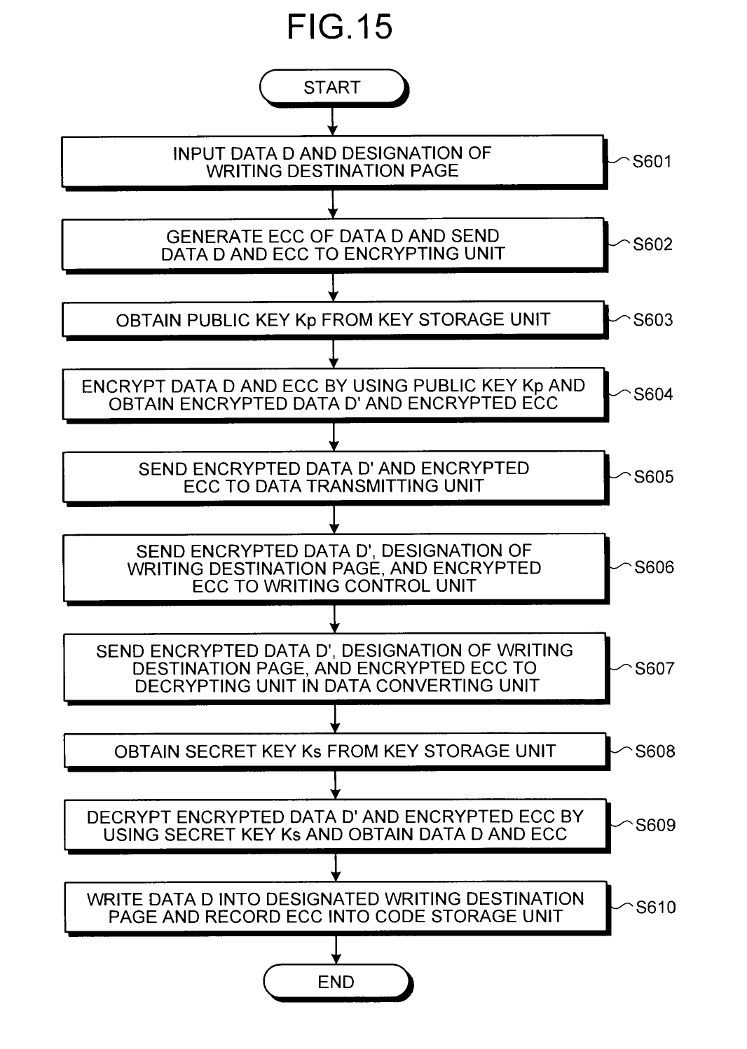

Next, a writing process that is performed on the data to be written and is performed by the writing device 300, the writing control unit 230, and the data converting unit 140 that are configured as shown in FIG. 14 will be explained, with reference to FIG. 15. FIG. 15 is a flowchart of an entire flow in the writing process according to the second embodiment.

The writing device 300 receives an input of the data to be written (i.e., the data D) and a designation of the writing destination page (step S601). After that, the ECC generating unit 310 generates an ECC of the data D and transfers the generated ECC and the data D to the encrypting unit 330 (step S602). The encrypting unit 330 obtains the public key Kp from the key storage unit 320 (step S603). Subsequently, the encrypting unit 330 encrypts the data D and the ECC by using the public key Kp and obtains encrypted data D′ and an encrypted ECC (step S604). The encrypting unit 330 sends the encrypted data D′ and the encrypted ECC to the data transmitting unit 340 (step S605). The data transmitting unit 340 transmits the encrypted data D′, the designation of the writing destination page, and the encrypted ECC to the writing control unit 230 included in the controller 200 (step S606).

The data transferring unit 231 included in the writing control unit 230 receives the encrypted data D′, the designation of the writing destination page, and the encrypted ECC and transmits these pieces of information to the data converting unit 140 included in the semiconductor memory chip 100 (step S607).

The encrypted data D′ and the encrypted ECC that have been received by the data converging unit 140 are input to the decrypting unit 142. The decrypting unit 142 obtains the secret key Ks from the key storage unit 141 (step S608). After that, the decrypting unit 142 decrypts the encrypted data D′ and the encrypted ECC by using the secret key Ks and obtains the data D and the ECC (step S609). Subsequently, the writing unit 143 records the data D resulting from the decrypting process into the page in the memory 110 that has been designated by the designation of the writing destination page. Also, the writing unit 143 stores the decrypted ECC into the code storage unit 111 included in the memory 110, as the ECC that corresponds to the designated page (step S610).

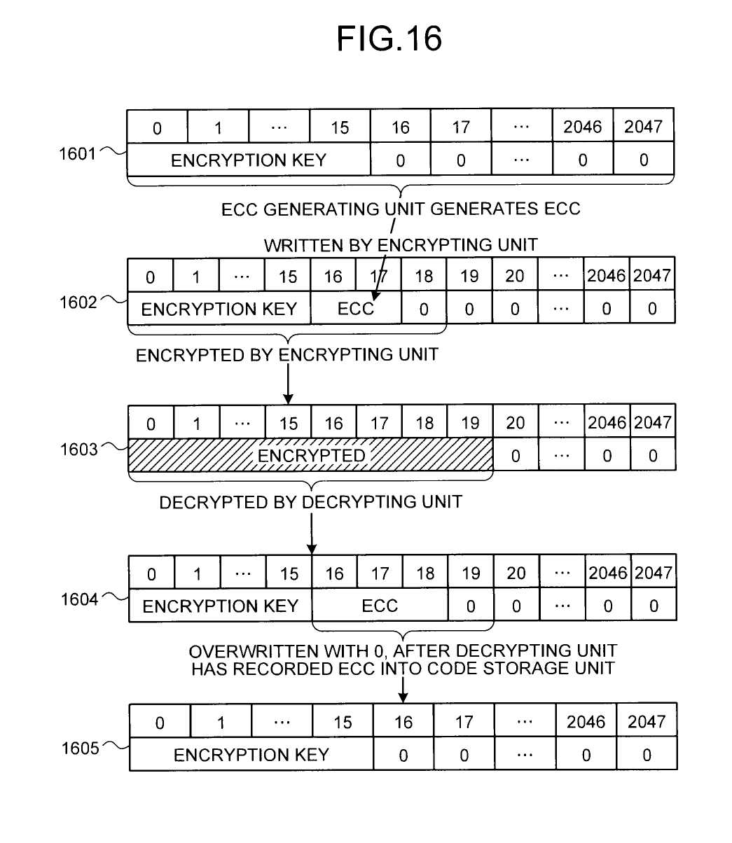

Generally speaking, an encrypting process and a decrypting process that use a public key require a large amount of calculation. Although the size of a page is, for example, approximately 2 kilobytes, the data that is actually written is a small piece of data such as an encryption key (e.g., approximately 16 bytes). Accordingly, to avoid a load from the decrypting process in the semiconductor memory chip 100 in particular, a configuration as explained below, for example, may be used. In other words, an arrangement is acceptable in which only minimum data is encrypted and decrypted. FIG. 16 is a drawing explaining changes in the data with such an arrangement.

First, as an example, let us assume that the size of a page is 2048 bytes, whereas the size of the data to be written is 16 bytes, and the size of the ECC is 3 bytes. Data corresponding to one page that is made up of 16-byte key data at the head and 0's corresponding to the remaining 2032 bytes is input to the ECC generating unit 310 (1601). After recording the 3-byte ECC starting from the 17th byte in the data corresponding to the one page, the encrypting unit 330 encrypts only the 20 bytes at the head (1602). After decrypting only the 20 bytes at the head (1603), the decrypting unit 142 stores, into the code storage unit 111, the 3 bytes starting from the 17th byte in the data corresponding to the one page, as the ECC (1604). Subsequently, after the 3 bytes starting from the 17th byte are overwritten with 0's, the data corresponding to the one page is recorded into the writing special area 113 in the memory 110 (1605).

The writing of the data into the writing special area 113 is always performed via the data converting unit 140 included in the semiconductor memory chip 100. According to the second embodiment, when the data D has been input to the writing device 300, the data D and the ECC of the data D (i.e., ECC (D)) are encrypted by using the public key Kp stored in the writing device 300. Further, the encrypted data D′=Enc(Kp, D) and the encrypted ECC=Enc(Kp, ECC(D)) are input to the data converting unit 140 included in the semiconductor memory chip 100.

In order for the data D to be correctly recorded into the writing special area 113, and also, in order for the ECC(D) to be correctly recorded into the code storage unit 111, the semiconductor memory chip 100 needs to store therein the secret key Ks. In other words, the writing device 300 authenticates the semiconductor memory chip 100. The memory area into which the data is written via the data converting unit 140 in the explanation above corresponds to the writing special area 113.

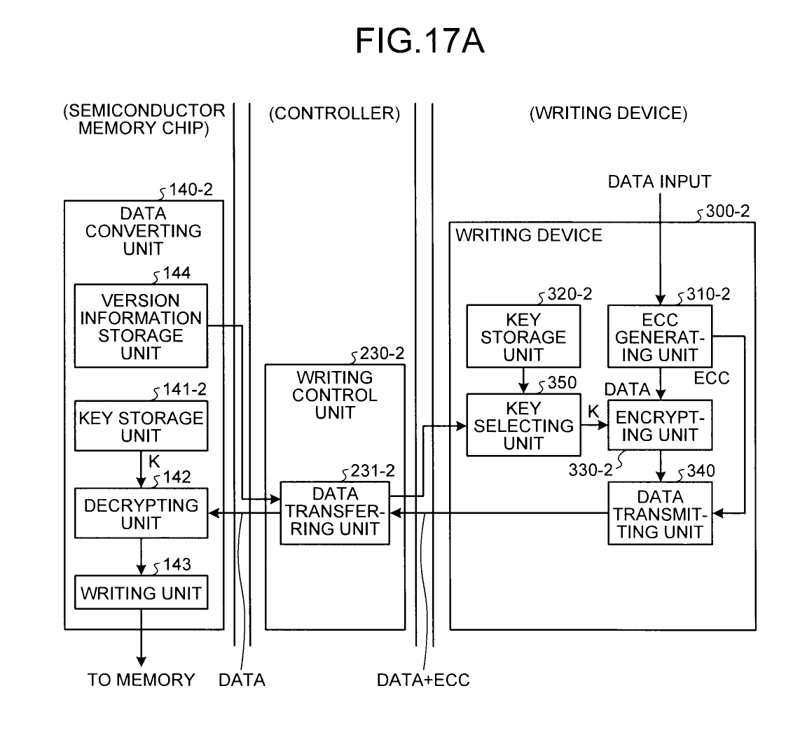

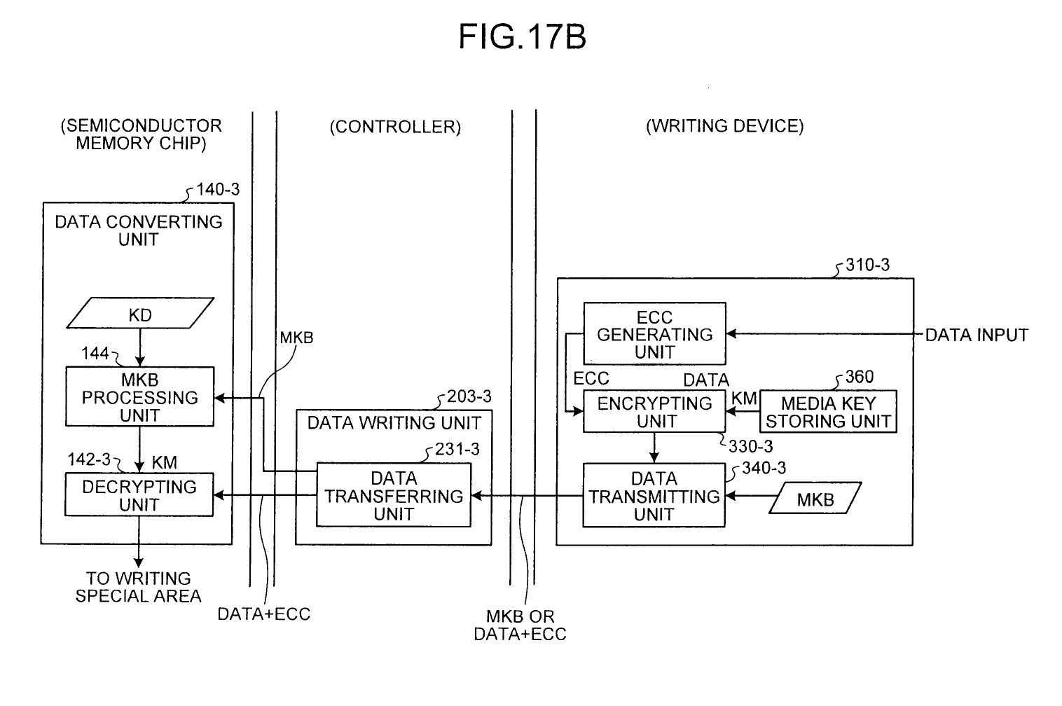

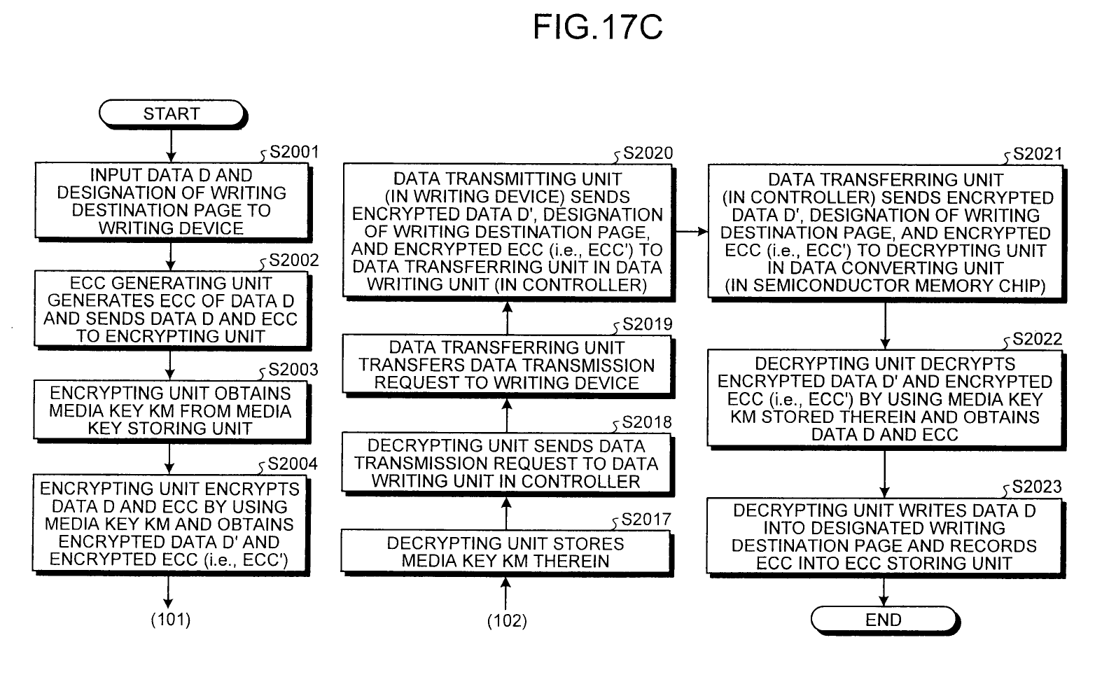

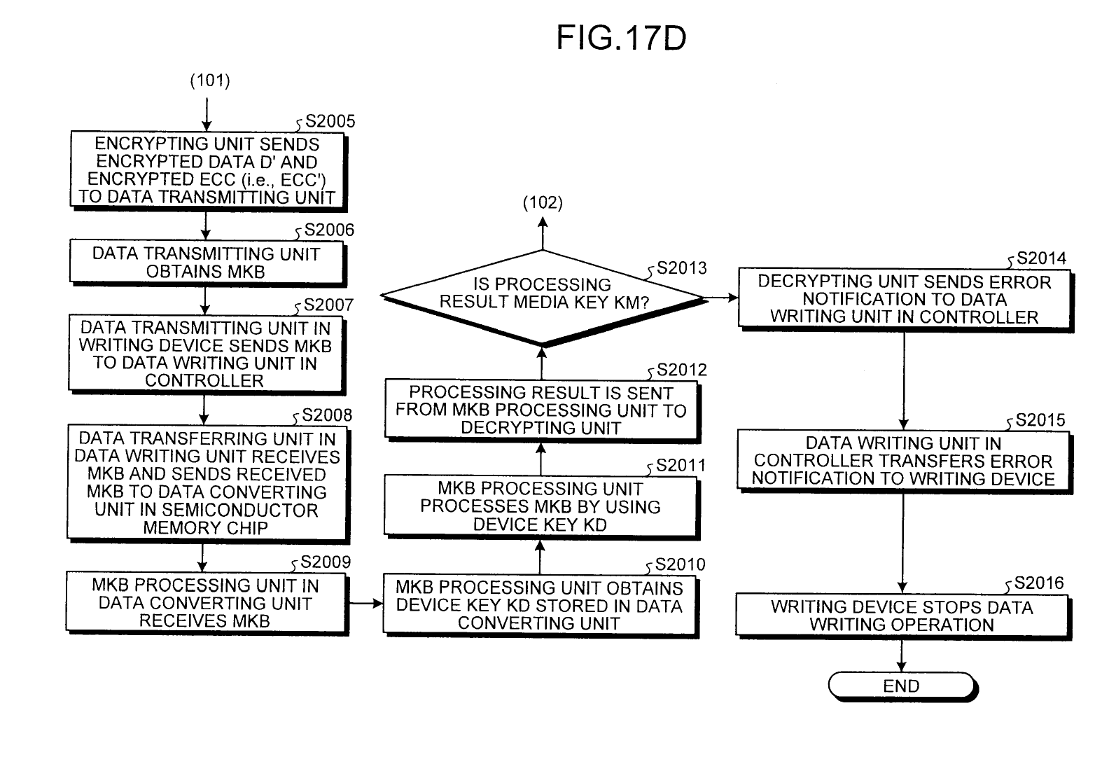

Next, modification examples of the data converting unit 140, the writing control unit 230, and the writing device 300 shown in FIG. 14 will be explained, with reference to FIG. 17A. FIG. 17A is a block diagram of exemplary configurations of a writing device 300-2, a writing control unit 230-2, and a data converting unit 140-2 according to the present modification example.

As shown in FIG. 17A, the writing device 300-2 includes an ECC generating unit 310-2, a key storage unit 320-2, an encrypting unit 330-2, the data transmitting unit 340, and a key selecting unit 350. The functions of the data transmitting unit 340 are the same as those shown in FIG. 14. Thus, the same reference characters are assigned thereto, and the explanation thereof will be omitted.

The ECC generating unit 310-2 is different from the ECC generating unit 310 shown in FIG. 14 in that the ECC generated thereby is transmitted to the data transmitting unit 340, instead of to the encrypting unit 330-2.

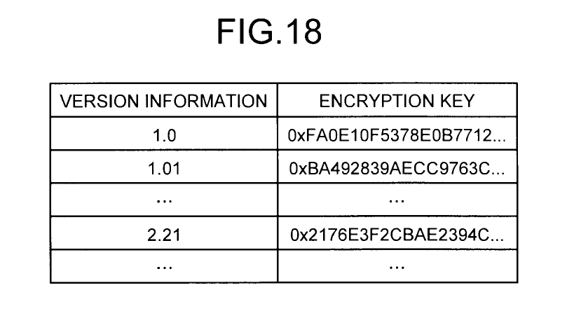

The key storage unit 320-2 stores therein encryption keys K, which are data conversion keys that use a symmetric key method. According to the present modification example, the key storage unit 320-2 stores therein a plurality of encryption keys K for mutually different versions of the semiconductor memory chip 100, respectively. FIG. 18 is a drawing of an example of a data structure of the data stored in the key storage unit 320-2. As shown in FIG. 18, the key storage unit 320-2 stores therein data in which the versions of the semiconductor memory chip 100 are kept in correspondence with the encryption keys.

Returning to the description of FIG. 17A, the key selecting unit 350 selects one of the encryption keys K that matches the version of the semiconductor memory chip 100 out of the key storage unit 320-2. The encrypting unit 330-2 encrypts the data to be written and the ECC by using the selected encryption key K.

Next, an exemplary configuration of the writing control unit 230-2 will be explained. As shown in FIG. 17A, the writing control unit 230-2 includes a data transferring unit 231-2. The data transferring unit 231-2 is different from the data transferring unit 231 shown in FIG. 14 in that the data transferring unit 231-2 additionally has a function of transferring the version information that has been read from the semiconductor memory chip 100, in response to a request from the key selecting unit 350.

Next, an exemplary configuration of the data converting unit 140-2 will be explained. As shown in FIG. 17A, the data converting unit 140-2 includes a key storage unit 141-2, the decrypting unit 142, the writing unit 143, and a version information storage unit 144. The functions of the data converting unit 140-2, the decrypting unit 142, and the writing unit 143 are the same as those shown in FIG. 14. Thus, the same reference characters are assigned thereto, and the explanation thereof will be omitted.

The version information storage unit 144 stores therein version information of the semiconductor memory chip 100. The key storage unit 141-2 stores therein the encryption keys K that use a symmetric key method. The encryption keys K are encryption keys that correspond to the version information stored in the version information storage unit 144 included in the semiconductor memory chip 100.

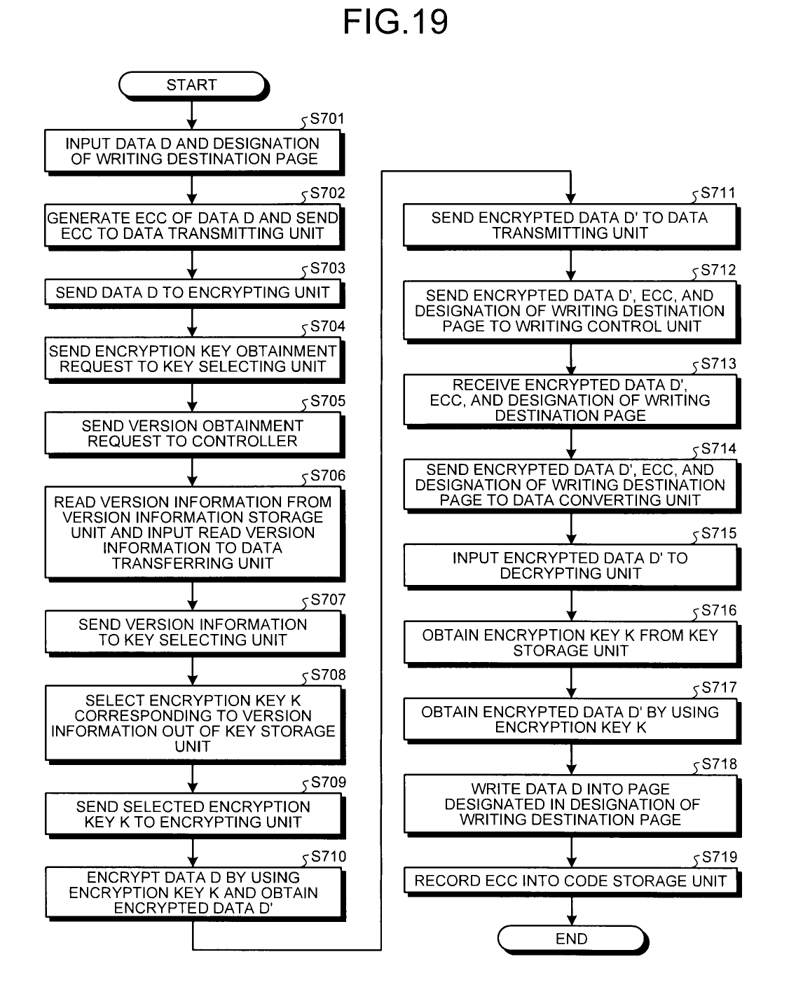

Next, a writing process that is performed on the data to be written and is performed by the writing device 300-2, the writing control unit 230-2, and the data converting unit 140-2 that are configured as shown in FIG. 17A will be explained, with reference to FIG. 19. FIG. 19 is a flowchart of an entire flow in the writing process according to the present modification example.

The writing device 300-2 receives an input of the data to be written (i.e., the data D) and a designation of the writing destination page (step S701). The ECC generating unit 310-2 generates an ECC of the data D and transfers the generated ECC to the data transmitting unit 340 (step S702). Also, the ECC generating unit 310-2 transfers the data D to the encrypting unit 330 (step S703). Subsequently, the encrypting unit 330-2 sends an encryption key obtainment request to the key selecting unit 350 (step S704).

According to the second embodiment, the encryption keys are in correspondence with the versions of the semiconductor memory chip 100. If the version is different, the encryption key is different, too. The key storage unit 320-2 included in the writing device 300 stores therein the encryption keys that are respectively in correspondence with the versions of the semiconductor memory chip 100. If the version of the semiconductor memory chip is unknown, it is not possible to obtain the corresponding encryption key.

For this reason, when the key selecting unit 350 has received the encryption key obtainment request from the encrypting unit 330-2, the key selecting unit 350 sends a version obtainment request to the controller 200 (step S705). The controller 200 reads the version information of the semiconductor memory chip 100 from the version information storage unit 144 included in the data converting unit 140 in the semiconductor memory chip 100 and inputs the read version information to the data transferring unit 231 (step S706). The data transferring unit 231 transmits the version information to the key selecting unit 350 included in the writing device 300 (step S707). The key selecting unit 350 selects an encryption key K that corresponds to the received version information out of the key storage unit 320-2 (step S708). After that, the key selecting unit 350 transmits the selected encryption key K to the encrypting unit 330-2 (step S709).

The encrypting unit 330-2 encrypts the data to be written (i.e., the data D) by using the transmitted encryption key K and obtains encrypted data D′ (step S710). The encrypting unit 330-2 sends the encrypted data D′ to the data transmitting unit 340 (step S711). The data transmitting unit 340 transmits the encrypted data D′, the designation of the writing destination page, and the ECC to the writing control unit 230-2 included in the controller 200 (step S712). The data transferring unit 231-2 included in the writing control unit 230-2 receives the encrypted data D′, the designation of the writing destination page, and the ECC (step S713) and transmits these pieces of information to the data converting unit 140-2 included in the semiconductor memory chip 100 (step S714).

The data converting unit 140-2 inputs the received encrypted data D′ to the decrypting unit 142 (step S715). The decrypting unit 142 obtains the encryption key K from the key storage unit 141-2 (step S716). The decrypting unit 142 decrypts the encrypted data D′ so as to obtain the data D, by using the encryption key K (step S717). The writing unit 143 records the data D resulting from the decrypting process into the page in the memory 110 that has been designated by the designation of the writing destination page (step S718). Also, the writing unit 143 stores the received ECC into the code storage unit 111, as the ECC that corresponds to the designated page (step S719).

The process to record the data into the memory area via the data converting unit 140-2 shown in FIG. 17A is always subject to the converting process performed by the data converting unit 140-2. The area into which the data is recorded via the data converting unit 140-2 corresponds to the writing special area 113.

When the data D has been input to the writing device 300, the data D is encrypted by using the encryption key K that has been selected in correspondence with the version of the semiconductor memory chip 100. Further, the encrypted data D′=Enc(K, D) is input to the data converting unit 140-2 included in the semiconductor memory chip 100. In order for the data D to be correctly recorded into the writing special area 113, the semiconductor memory chip 100 needs to store therein the encryption key K. In other words, in this situation also, the writing device 300 authenticates the semiconductor memory chip 100.

In the following sections, another method for writing data into a writing special area will be explained. An MKB is used in this method. In FIG. 17B, a configuration is shown in which a writing device writes data, via a controller, into a writing special area 1 in a semiconductor memory chip according to an embodiment.

A media key storing unit included in the writing device stores therein a media key KM for the MKB stored in the writing device. Also, a data converting unit included in the semiconductor memory chip stores therein a device key KD. An example of an operation that is performed when the writing device shown in FIG. 17B writes data into the writing special area in the semiconductor memory chip shown in FIG. 17B via the controller shown in FIG. 17B is shown in FIG. 17C. When the data D and a designation of the writing target address have been input to the writing device (step S2001), the data D is input to the ECC generating unit included in the writing device. The ECC generating unit generates an ECC (i.e., ECC(D)) of the data D and sends the generated ECC(D) to the encrypting unit, together with the data (step S2002). The encrypting unit obtains the media key KM from the media key storing unit (step S2003) and encrypts the data D and the ECC(D) by using the media key KM so as to obtain D′ and ECC′ (step S2004). After that, the encrypting unit sends the encrypted data D″ and the encrypted ECC (i.e., ECC′) to the data transmitting unit (step S2005).

The data transmitting unit obtains the MKB (step S2006) and sends the MKB to the controller (step S2007). The MKB is input to the data transferring unit included in the data writing unit in the controller. The data transferring unit sends the MKB to the data converting unit included in the semiconductor memory chip (step S2008). The data converting unit inputs the received MKB to the MKB processing unit (step S2009). The MKB processing unit obtains the device key KD stored in the data converting unit (step S2010) and processes the MKB by using the device key KD (step S2011). If and only if the device key KD has not been revoked by the MKB, the MKB processing unit outputs the media key KM. Otherwise, the MKB processing unit outputs an error message. The result of the processing (i.e., the media key KM that has correctly been obtained or the error message) is sent from the MKB processing unit to the decrypting unit (step S2012). The decrypting unit judges whether the result of the processing is the media key KM (step S2013). In the case where the decrypting unit has received the error message, the decrypting unit sends a notification of an error to the data writing unit included in the controller (step S2014). The data writing unit transfers the notification of an error to the writing device (step S2015). When the writing device has received the notification of an error, the writing device stops the data writing operation (step S2016).

In contrast, in the case where the decrypting unit has received the media key KM from the MKB processing unit, the decrypting unit stores therein the media key KM (step S2017). Also, the decrypting unit sends a data transmission request to the data writing unit included in the controller (step S2018). The data transferring unit transfers the data transmission request to the writing device (step S2019). When the writing device has received the data transmission request, the data transmitting unit included in the writing device sends the data D that has been encrypted (i.e., the encrypted data D′) and the ECC that has been encrypted (i.e., the ECC′) to the controller (step S2020). The encrypted data D′ and the encrypted ECC (i.e., the ECC′) are sent to the data converting unit included in the semiconductor memory chip via the data writing unit included in the controller. The encrypted data D′ and the encrypted ECC (i.e., the ECC′) are sent to the decrypting unit included in the data converting unit (step S2021). The decrypting unit decrypts the encrypted data D′ and the encrypted ECC (i.e., the ECC′) by using the media key KM stored therein and obtains the data D and the ECC (step S2022). The decrypting unit writes the data D into the writing special area and writes the ECC into the ECC storing unit (step S2023).

The reading special area is used for the semiconductor memory chip 100's authenticating the controller 200. In contrast, the writing special area is used for the writing device 300's authenticating the semiconductor memory chip 100. Let us discuss the trust chain shown in FIG. 1 again. To structure the trust chain starting from the writing device 300 to the semiconductor memory chip 100, and to the controller 200, it is necessary that the reading special area and the writing special area have an overlapping area. In other words, if the controller 200 is able to read the data correctly (i.e., in the manner intended by the writing device 300) that has been recorded in the overlapping area (i.e., the common area), it means that the trust chain is completed. Hereinafter, the overlapping area (i.e., the common area) between the reading special area and the writing special area may simply be referred to as a special area.

In the example shown in FIG. 18, the version information is simply a numerical value; however, the version information is not limited to this example. Further, another arrangement is acceptable in which a corresponding encryption key is selected out of a plurality of encryption keys, according to the version information and one or more pieces of information other than the version information. For example, it is acceptable to determine the version information based on the time period in which the semiconductor memory chip 100 was manufactured or a lot number used during the manufacture.

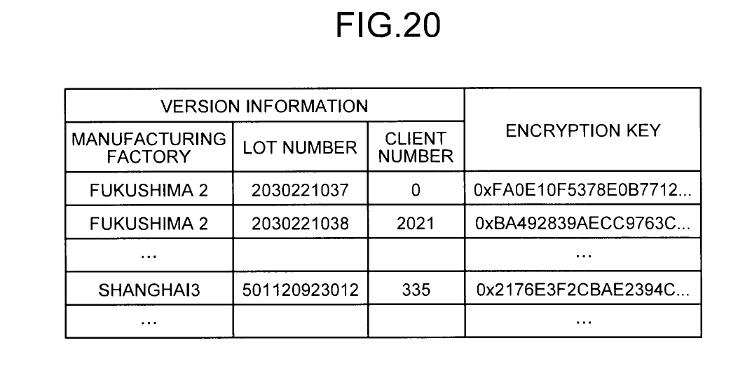

Further, the version information does not necessarily have to be a numerical value. For example, the version information may be a character string or a sequence that is made up of one or more numerical values and one or more character strings. FIG. 20 is a drawing of a modification example of the version information that has such a structure. In FIG. 20, an example is shown in which a sequence that is made up of the name of the manufacturing factory of the semiconductor memory chip 100, the lot number managed in the manufacturing factory, and the client number is used as the version information. In this situation, the client number is, for example, a number that is assigned to a large-scale customer by the manufacturer of the semiconductor memory chip 100. As for products that are not for large-scale customers, the numerical value expressing the client number may be a fixed value (e.g., 0). The correspondence table as shown in FIG. 20 is stored in the key storage unit 320-2 included in the writing device 300.

As explained above, the semiconductor memory chip according to the second embodiment includes the encryption key sharing unit and the sending control unit that are provided on the same die as the one on which the memory is provided and that function as an authenticating unit to authenticate the controller. Further, only the controller that has been authenticated is able to correctly read the data stored in the memory. In addition, the semiconductor memory chip includes the key storage unit that is provided on the same die as the one on which the memory is provided and that stores therein the predetermined encryption key as well as the data converting unit that decrypts the data by using the encryption key and that stores the decrypted data into the memory. Unless the correct encryption key is stored, it is not possible to correctly record the data. With this arrangement, it is possible to prevent illegitimate use of the data that is realized by, for example, counterfeiting memory cards.

According to the second embodiment, the data to be written is decrypted before the data is written into the writing special area. In contrast, a semiconductor memory chip according to a third embodiment decrypts data that has been read from the writing special area (i.e., the encrypted written data). In this situation also, in order for the data that has been read from the writing special area to be correctly decrypted, the semiconductor memory chip needs to store therein the encryption key that corresponds to the encryption key used by the writing device in the encrypting process. In other words, in this situation also, the writing device authenticates the semiconductor memory chip.

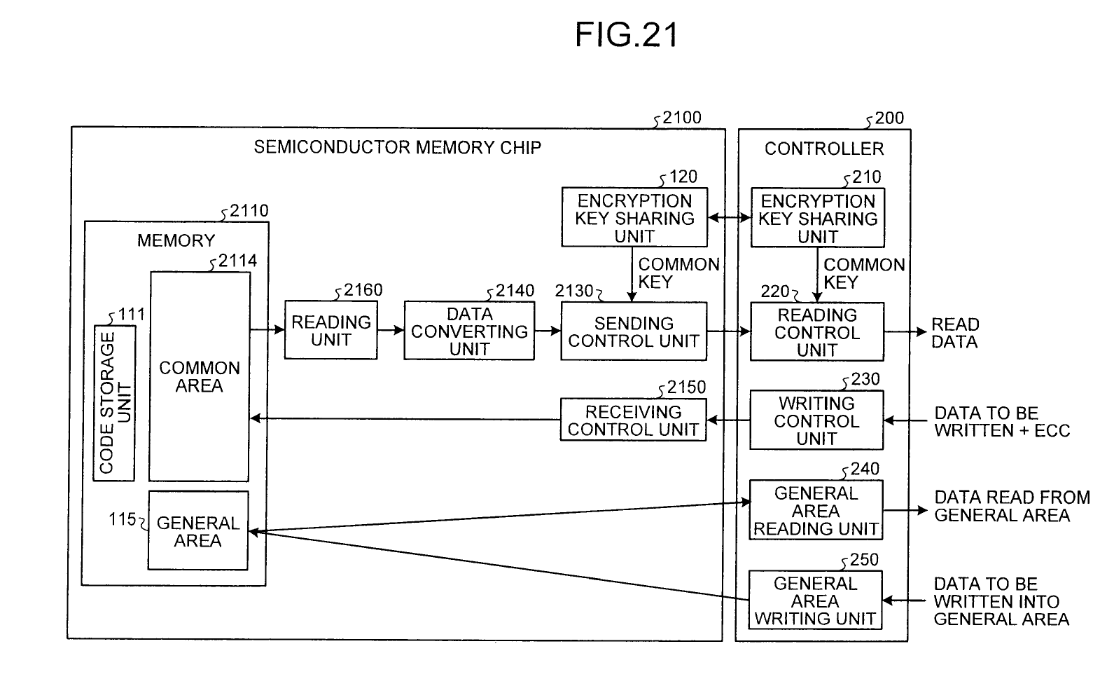

FIG. 21 is a block diagram of an example of a configuration of a semiconductor memory chip 2100 according to the third embodiment. The controller 200 has the same configuration as in the second embodiment. As shown in FIG. 21, the semiconductor memory chip 2100 includes a memory 2110, the encryption key sharing unit 120, a sending control unit 2130, a data converting unit 2140, a receiving control unit 2150, and a reading unit 2160.

One of the differences from the second embodiment is the position in which the data converting unit 140 is provided. As shown in FIG. 2, according to the second embodiment, the data converting process (i.e., the decrypting process) is performed with a data writing process. In contrast, according to the third embodiment, the data converting process (i.e., the decrypting process) is performed with a data reading process. Further, the third embodiment is different from the second embodiment with respect to the configurations of the memory 2110 and the sending control unit 2130, and also, in that the receiving control unit 2150 and the reading unit 2160 are additionally provided. Other configurations and functions are the same as those shown in FIG. 2, which is a block diagram of the semiconductor memory chip 100 according to the second embodiment. Thus, the same reference characters are assigned thereto, and the explanation thereof will be omitted.

The sending control unit 2130 is different from the sending control unit 130 shown in FIG. 5 in that the reading unit 132 is eliminated therefrom. The sending control unit 2130 receives, as an input, the data that has been read by the reading unit 2160 and converted by the data converting unit 140, instead of receiving the data that has been read by the reading unit 132 as an input.

The memory 2110 includes the code storage unit 111, a common area 2114, and the general area 115. According to the third embodiment, the writing special area is a predetermined memory area within the memory area into which the data that is decrypted by the data converting unit 2140 is written during a data reading process. According to the third embodiment, during the data reading process, the data that has been decrypted by the data converting unit 2140 is input to the sending control unit 2130, so that the controller 200 can be authenticated. Accordingly, the writing special area into which the data to be decrypted by the data converting unit 2140 is written coincides with the reading special area from which only the authenticated controller 200 is able to correctly read the data. Thus, only the common area 2114 is shown in the memory 2110 in the example in FIG. 21.

The receiving control unit 2150 controls a process of receiving encrypted data obtained by encrypting the data to be written and writing the encrypted data into the common area 2114 without decrypting the encrypted data.

The reading unit 2160 reads the data in the page that has been designated as a reading target page from the reading special area (i.e., the common area 2114) and transmits the read data to the data converting unit 2140. Further, the reading unit 2160 reads the ECC that corresponds to the data in the designated page from the code storage unit 111 and transmits the ECC to the sending control unit 2130.

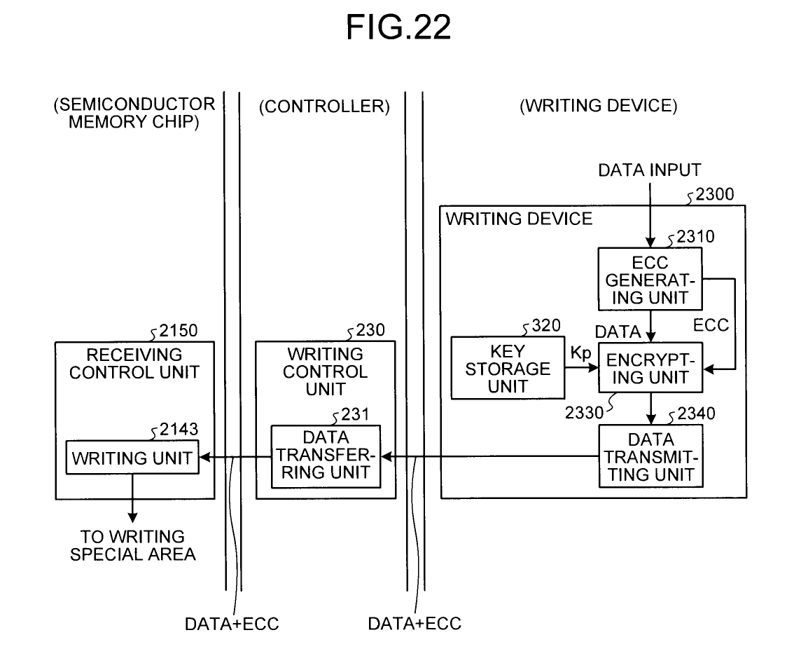

Next, an exemplary configuration of the receiving control unit 2150 shown in FIG. 21 and an exemplary configuration of a writing device 2300 according to the third embodiment will be explained, with reference to FIG. 22. It should be noted that only the part that is related to the writing process is shown in FIG. 22.

First, a configuration of the writing device 2300 will be explained. As shown in FIG. 22, the writing device 2300 includes an ECC generating unit 2310, the key storage unit 320, an encrypting unit 2330, and a data transmitting unit 2340. The key storage unit 320 has the same configuration as the key storage unit 320 shown in FIG. 14. Thus, the same reference character is assigned thereto, and the explanation thereof will be omitted.

The ECC generating unit 2310 generates an ECC of the data to be written that has been input as the data that needs to be written. The encrypting unit 2330 encrypts the data to be written by using the public key Kp. The data transmitting unit 2340 transmits the encrypted data, the ECC, and a designation of the writing destination page to the writing control unit 230 included in the controller 200.

Next, a configuration of the receiving control unit 2150 will be explained. As shown in FIG. 22, the receiving control unit 2150 includes a writing unit 2143. The writing unit 2143 records the encrypted data into the designated page in the common area 2114. Also, the writing unit 2143 stores the ECC into the code storage unit 111.

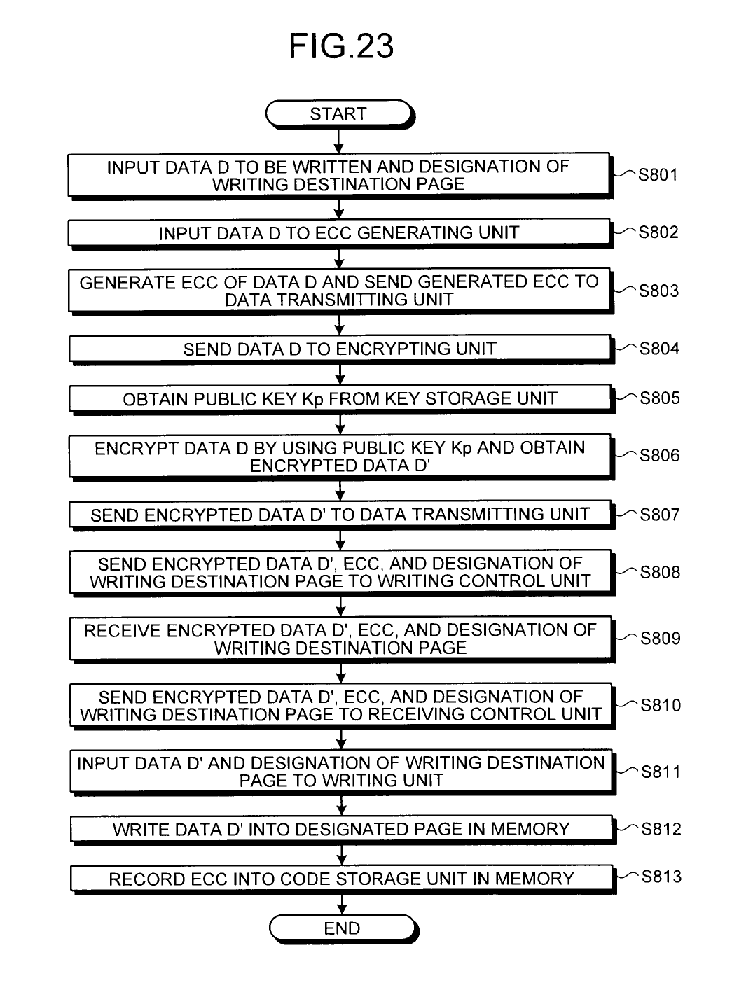

Next, a writing process that is performed on the data to be written and is performed by the writing device 2300, the writing control unit 230, and the receiving control unit 2150 that are configured as shown in FIG. 22 will be explained, with reference to FIG. 23. FIG. 23 is a flowchart of an entire flow in the writing process according to the third embodiment.

The writing device 2300 receives an input of the data to be written (i.e., the data D) and a designation of the writing destination page (step S801). The writing device 2300 inputs the input data D to the ECC generating unit 2310 (step S802). After that, the ECC generating unit 2310 generates an ECC of the data D and transfers the generated ECC to the data transmitting unit 2340 (step S803). Also, the ECC generating unit 2310 transfers the data D to the encrypting unit 2330 (step S804).

The encrypting unit 2330 obtains the public key Kp from the key storage unit 320 (step S805). Further, the encrypting unit 2330 encrypts the data D by using the obtained public key Kp so as to obtain encrypted data D′ (step S806). Subsequently, the encrypting unit 2330 sends the encrypted data D′ to the data transmitting unit 2340 (step S807). The data transmitting unit 340 transmits the encrypted data D′, the designation of the writing destination page, and the ECC to the writing control unit 230 included in the controller 200 (step S808).

The data transferring unit 231 included in the writing control unit 230 receives the encrypted data D′, the designation of the writing destination page, and the ECC (step S809) and transmits these pieces of information to the receiving control unit 2150 included in the semiconductor memory chip 100 (step S810).

The receiving control unit 2150 inputs the encrypted data D′ and the designation of the writing destination page to the writing unit 2143 (step S811). The writing unit 2143 records the input encrypted data D′ to the page in the memory 110 that has been designated by the designation of the writing destination page (step S812). Further, the receiving control unit 2150 stores the ECC into the code storage unit 111, as the ECC that corresponds to the designated page (step S813).

As explained above, according to the third embodiment, when the data D has been input to the writing device 2300, the data D is encrypted by using the public key Kp stored in the writing device 2300. Further, the encrypted data D′=Enc(Kp, D) and the ECC(D) related to the data D are input to the receiving control unit 2150 included in the semiconductor memory chip 100. As a result, the data Enc(Kp, D) is recorded in the writing special area (i.e., the common area 2114), whereas the ECC(D) is recorded in the code storage unit 111.

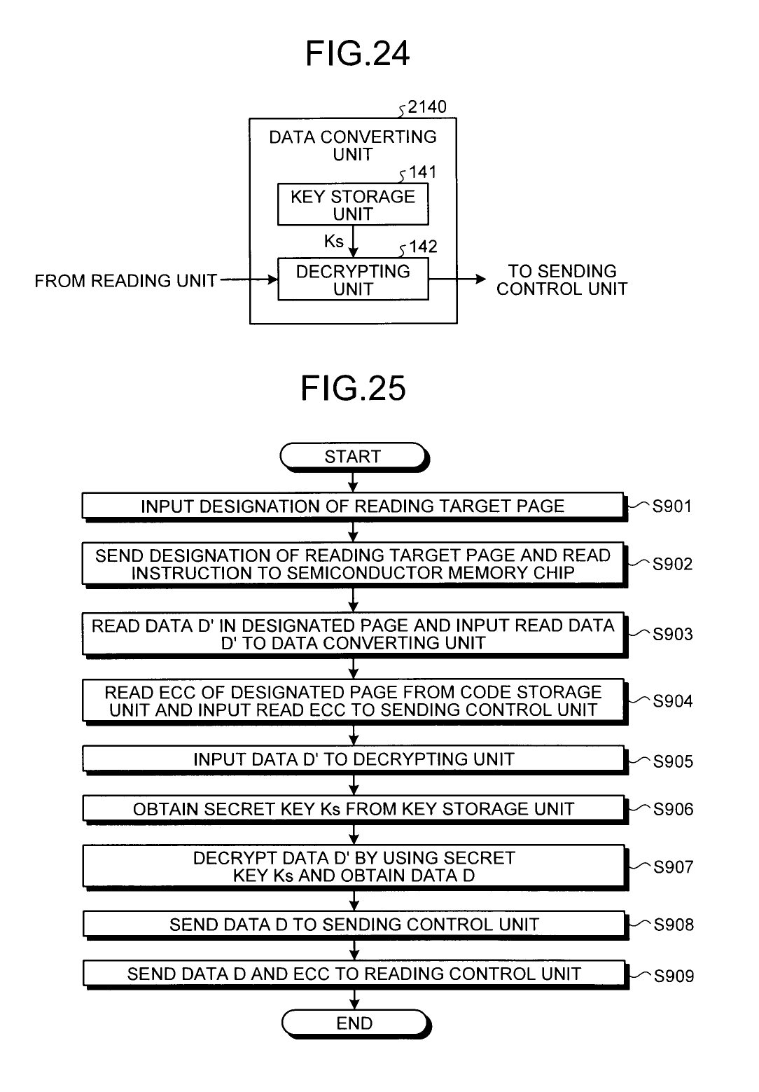

Next, an exemplary configuration of the data converting unit 2140 shown in FIG. 21 will be explained, with reference to FIG. 24. As shown in FIG. 24, the data converting unit 2140 includes the key storage unit 141 and a decrypting unit 2142. The configuration and the function of the key storage unit 141 are the same as those shown in FIG. 14. Thus, the same reference characters are assigned thereto, and the explanation thereof will be omitted. The decrypting unit 2142 decrypts the data that has been read by the reading unit 2160 by using the secret key Ks stored in the key storage unit 141.

Next, a data reading process that is performed by the data converting unit 2140 configured as shown in FIG. 24 will be explained, with reference to FIG. 25. FIG. 25 is a flowchart of an entire flow in the data reading process according to the third embodiment.

First, the controller 200 receives, as an input, a designation of a reading target page from an external device such as a playback device (step S901). The reading control unit 220 included in the controller 200 sends a read instruction indicating that data should be read from the designated reading target page in the memory 110 to the semiconductor memory chip 100 (step S902). The reading unit 2160 included in the semiconductor memory chip 100 reads the data in the designated reading target page and inputs the read data to the data converting unit 2140 (step S903). Also, the reading unit 2160 reads the ECC that corresponds to the designated reading target page from the code storage unit 111 and sends the ECC to the sending control unit 2130 (step S904).

As explained above, according to the third embodiment, the encrypted data is written into the common area 2114 without being decrypted. Thus, the data that has been read is encrypted. In the following sections, the data that has been read will be referred to as the “data D′”.

The data converting unit 2140 inputs the input data D′ to the decrypting unit 2142 (step S905). The decrypting unit 2142 obtains the secret key Ks from the key storage unit 141 (step S906). The decrypting unit 2142 decrypts the input data D′ by using the obtained secret key Ks and obtains the data D (step S907). After that, the decrypting unit 2142 sends the data D resulting from the decrypting process to the sending control unit 2130 (step S908).

The sending control unit 2130 sends the data D that has been decrypted and received from the data converting unit 2140 and the ECC that has been read from the code storage unit 111 to the reading control unit 220 included in the controller 200 (step S909). The process performed thereafter is the same as the process performed at step S212 and thereafter shown in FIG. 6. Thus, the process is omitted from FIG. 25.

According to the third embodiment, the reading of the data from the writing special area (i.e., the common area 2114) is always performed via the data converting unit 2140 included in the semiconductor memory chip 100. Let us assume that, as a result of the writing process described above, the data in the reading target page in the writing special area (i.e., the common area 2114) is Enc(Kp, D), whereas the ECC(D) has been recorded in the code storage unit 111 as the ECC of the page. In that situation, the data that is sent from the data converting unit 2140 included in the semiconductor memory chip 100 to the sending control unit 2130 is Dec(Ks, Enc(Kp, D))=D. Further, the controller 200 receives the data D and the ECC(D). In this situation, Dec(A, B) signifies that data B is decrypted by a key A used in the decrypting process.

In the situation where the writing device 300 has written Enc(Kp, D) and the ECC(D) as described above, in order for the controller 200 to correctly receive the intended data D and the corresponding ECC(D), the semiconductor memory chip 100 needs to store therein the secret key Ks. In other words, in this situation also, the writing device 300 authenticates the semiconductor memory chip 100. The memory area from which the data is read via the data converting unit 2140 corresponds to the writing special area according to the third embodiment.

As explained above, the memory chip according to the third embodiment includes the key storage unit that is provided on the same die as the one on which the memory is provided and that stores therein the predetermined encryption key as well as the data converting unit that decrypts the data that has been read from the memory by using the encryption key. Further, unless the correct encryption key is stored, it is not possible to correctly reconstruct the data that has been written. With this arrangement, it is possible to prevent illegitimate use of the data that is realized by, for example, counterfeiting memory cards.

As explained in the description of the second and the third embodiments, when the writing device has written data into the special area (i.e., the common area), and also, the controller has read the data from the special data, the trust chain is structured. The judgment of whether the controller is able to correctly read the data that has been written into the special area by the writing device is actually made by judging whether it is possible to properly utilize the data (e.g., to play back the contents).

As a fourth embodiment, an embodiment related to a specific data utilization will be explained, including a device (e.g., a player) that utilizes the data stored in the semiconductor memory chip according to the embodiments described above.

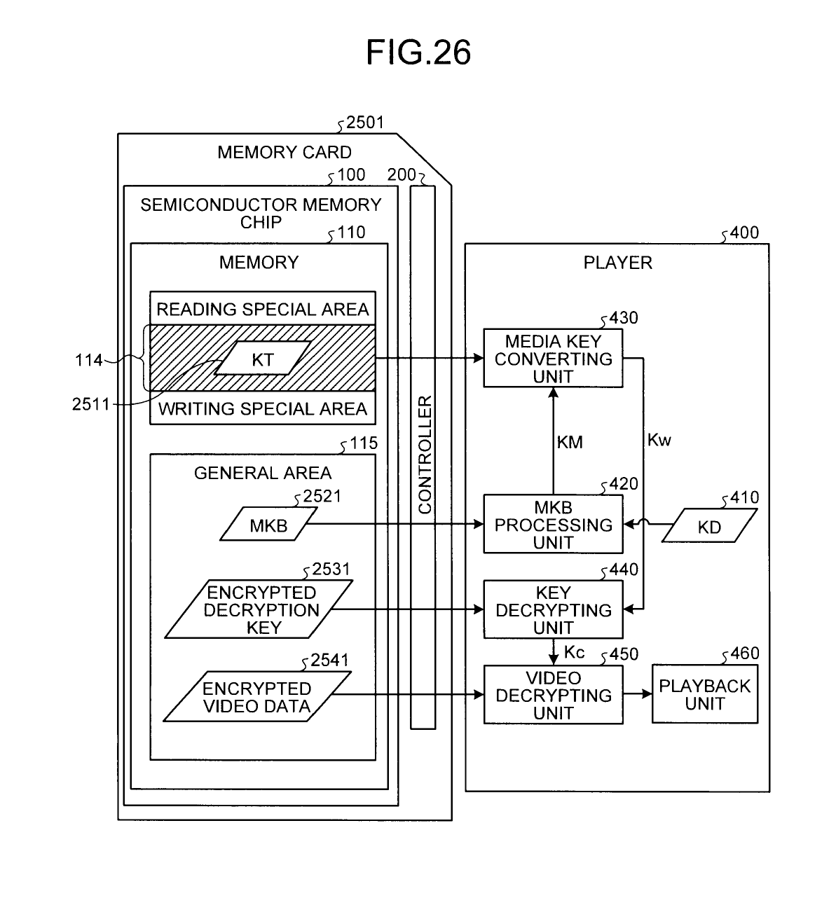

FIG. 26 is a block diagram of examples of configurations of a player 400 that is a device that utilizes the data and a memory card 2501 from which the data is read by the player 400 according to the fourth embodiment.

As shown in FIG. 26, the memory card 2501 includes the semiconductor memory chip 100 and the controller 200. The semiconductor memory chip 100 and the controller 200 have the same configurations as those described in the second embodiment or the third embodiment. For example, the controller 200 shown in FIG. 26 includes the encryption key sharing unit 210 shown in FIG. 3A and the reading control unit 220 shown in FIG. 5. The memory card 2501 may be configured with, for example, an SD memory card.

According to the fourth embodiment, encrypted video data 2541, an encrypted decryption key 2531 obtained by encrypting a decryption key Kc used for decrypting the encrypted video data 2541, and an MKB 2521 (hereinafter, simply referred to as the “MKB”) have been recorded into the general area 115 in the memory 110 included in the semiconductor memory chip 100. Further, a media key conversion key 2511 (hereinafter, the “media key conversion key KT”) is stored in the special area (i.e., the common area 114) within the memory 110.

The decryption key Kc is recorded as the encrypted decryption key 2531 that has been encrypted. The key used in this encrypting process is obtained by converting the media key KM that is derived when the MKB has correctly been processed, while using the media key conversion key KT. For example, the encrypted decryption key 2531=AES-E(AES-G(KT, KM), Kc) is satisfied. In the present example, a one-way function AES-G is used in the converting process, whereas AES-E is used in the encrypting process.

The player 400 stores therein a KD 410 (hereinafter, the “device key KD”) denoting a device key and also includes an MKB processing unit 420, a media key converting unit 430, a key decrypting unit 440, a video decrypting unit 450, and a playback unit 460.

The MKB processing unit 420 performs MKB processing to derive the media key KM by processing the MKB that has been read from the general area 115 while using the device key KD. The media key converting unit 430 generates a key Kw by converting the derived media key KM while using the media key conversion key KT that has been read from the special area. The key decrypting unit 440 generates the decryption key Kc by decrypting the encrypted decryption key 2531 that has been read from the general area 115, while using the key Kw. The video decrypting unit 450 decrypts the encrypted video data by using the decryption key Kc. The playback unit 460 plays back the decrypted video data.

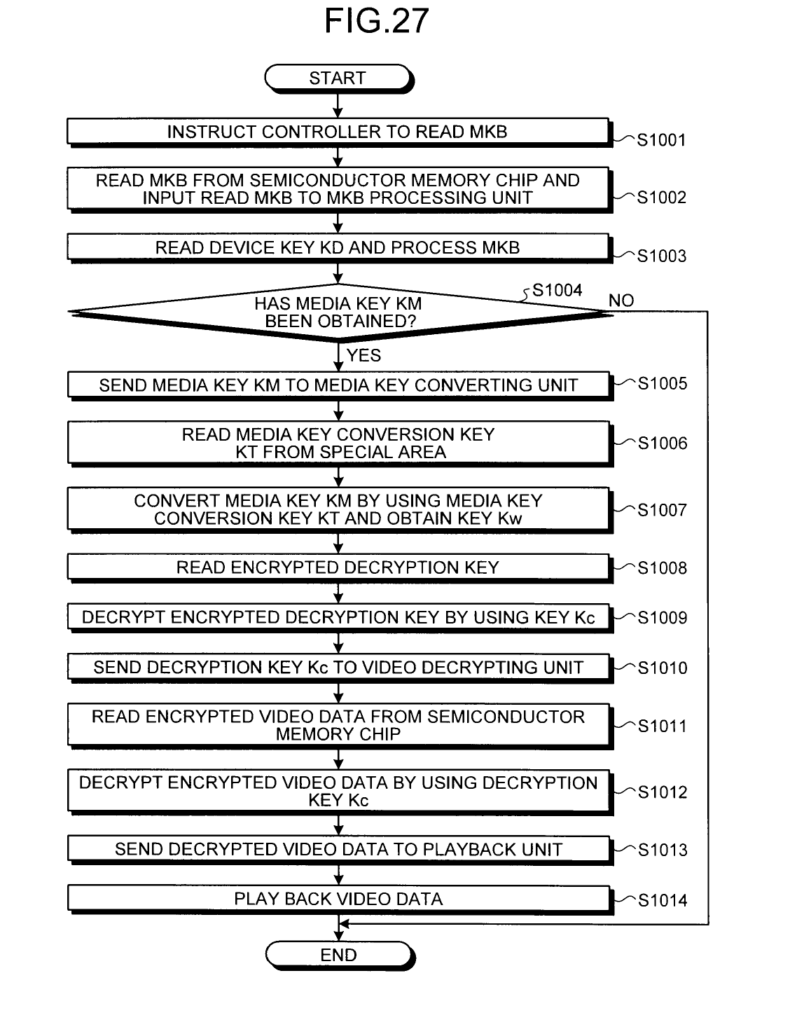

Next, a data playback process that is performed in the memory card 2501 by the player 400 configured as shown in FIG. 26 will be explained, with reference to FIG. 27. FIG. 27 is a flowchart of an entire flow in the playback process according to the fourth embodiment.

The player 400 instructs the controller 200 included in the memory card 2501 to read the MKB contained in the general area 115 (step S1001). For example, the player 400 provides the controller 200 with a designation of the head address and the size of the MKB.

The controller 200 reads the page that includes the designated area from the semiconductor memory chip 100 and sends the data (i.e., the value of the MKB) in the designated area to the player 400. The player 400 inputs the received MKB to the MKB processing unit 420 (step S1002). The MKB processing unit 420 reads the device key KD stored in the player 400, performs the MKB processing on the input MKB by using the device key KD, and derives and outputs the media key KM (step S1003).

After that, the MKB processing unit 420 judges whether the media key KM has been obtained as a result of the MKB processing (step S1004). In the case where the device key KD has been revoked by the MKB, the MKB processing unit 420 is not able to derive the correct media key KM. In that situation, the MKB processing unit 420 judges that the media key KM has not been obtained (step S1004: No) and outputs an error message. In the case where the error message has been output by the MKB processing unit 420, the player 400 displays an alert message and stops the operation.

In the case where the media key KM has been obtained (step S1004: Yes), the player 400 sends the media key KM to the media key converting unit 430 (step S1005). After that, the player 400 instructs that the media key conversion key KT contained in the special area (i.e., the common area 114) should be read (step S1006). For example, the player 400 provides the controller 200 with a designation of the head address and the size of the media key conversion key KT.

The controller 200 reads the page that includes the designated area from the semiconductor memory chip 100 and sends the data (i.e., the value of the media key conversion key KT) in the designated area to the player 400. The player 400 inputs the value of the media key conversion key KT that has been received from the controller 200 to the media key converting unit 430.

The media key converting unit 430 converts the media key KM by using the input media key conversion key KT and obtains the key Kw=AES-G(KT, KM) (step S1007). The player 400 sends the value of the key Kw to the key decrypting unit 440.

After that, the player 400 reads the encrypted decryption key 2531 from the general area 115 in the semiconductor memory chip 100, via the controller 200 (step S1008). For example, the player 400 provides the controller 200 with a designation of the head address and the size of the encrypted decryption key 2531.

The controller 200 reads the page that includes the designated area from the general area 115 and sends the data (i.e., the value of the encrypted decryption key 2531) in the designated area to the player 400. The player 400 inputs the value of the encrypted decryption key 2531 that has been received from the controller 200 to the key decrypting unit 440.

The key decrypting unit 440 decrypts the input encrypted decryption key 2531 by using the key Kw (step S1009). As a result, the value of the decryption key Kc is obtained. The formula to obtain the decryption key Kc can be expressed as shown in Expression (1) below.

$$Dec ( Kw , encrypted decryption key ) = Dec ( Kw , Enc ( AES - G ( KT , KM ) , Kc ) ) = Dec ( Kw , Enc ( Kw , Kc ) ) = Kc$$

The key decrypting unit 440 sends the value of the decryption key Kc to the video decrypting unit 450 (step S1010). The video decrypting unit 450 stores therein the value of the decryption key Kc that has been received.

After that, the player 400 sequentially reads the pieces of encrypted video data from the general area 115 via the controller 200 and sequentially inputs the read pieces of encrypted video data to the video decrypting unit 450 (step S1011). The video decrypting unit 450 sequentially decrypts the pieces of encrypted video data by using the decryption key Kc (step S1012) and sends the decrypted pieces of video data to the playback unit 460 (step S1013). The playback unit 460 sequentially plays back (displays) the received pieces of video data (step S1014).

The media key conversion key KT is data that is necessary for obtaining the correct content decryption key (i.e., the decryption key Kc). For example, the value of the media key conversion key KT may be different for each semiconductor memory chip 100. Alternatively, the value of the media key conversion key KT may be different for each memory card 2501. Further, the value of the media key conversion key KT may be statistically different for each memory card 2501. To be “statistically different” means that there is a possibility that the value may not be different in a strict sense, but the value is considered to be different based on statistics. For example, in the situation where a random number having an extremely large number of digits has been generated and the value of the random number is being used, the value is considered to be statistically different.

In the case where the media key conversion key KT recorded in the special area is (at least statistically) different for each memory card 2501, it is possible to consider the media key conversion key KT to be a type of ID of the memory card 2501. Another arrangement is acceptable in which, instead of the media key conversion key KT, the MKB is stored as the data that is necessary for decrypting the encrypted content data (e.g., the video data).

To correctly record the media key conversion key KT into the writing special area in the semiconductor memory chip 100, the semiconductor memory chip 100 needs to be authenticated by the writing device 300. In order for the player 400 to be able to correctly read, via the controller 200, the media key conversion key KT that has been recorded in the reading special area, the controller 200 needs to be authenticated by the semiconductor memory chip 100. To summarize, unless the trust chain in which the writing device 300 authenticates the controller 200 via the semiconductor memory chip 100 has been established, the player 400 is not able to correctly read the media key conversion key KT. In other words, the player 400's being able to play back the video is assumed to be a proof that the trust chain has been established.

An arrangement is acceptable in which the MKB according to the fourth embodiment is supplied by the video supplier for each of the videos. Generally speaking, MKBs are configured by using a symmetric key encrypting method; however, in the situation where the MKB is supplied by the video supplier for each of the videos, it is desirable to configure the MKB by using a public key encrypting method. The reason for this will be explained in the following sections.

In the case where an MKB is configured by using a symmetric key encrypting method, it is necessary to know, generally speaking, all the values of the device keys to generate the MKB. To allow the video supplier to generate the MKB, it is necessary to provide the video supplier with all the values of the device keys KD. If the values of the device keys KD have been leaked to a malicious player manufacturer, revocation of players by using the MKB is substantially meaningless. The reason is that, even if vicious or inferior players have been revoked by using the MKB, the malicious player manufacturer is able to keep manufacturing as many vicious or inferior players as desired by using the device keys KD that have not been revoked.

For this reason, there is an advantage in configuring the MKB by using a public key encrypting method. In the case where a public key encrypting method is used, the device key KD is configured by using a secret key. Each of the player manufacturers knows only the value of the device key KD that has been assigned to the player manufacturer. In contrast, a public key is distributed to the video supplier for the purpose of generating the MKB. The video supplier is able to freely generate the MKB by using the public key. Even if the public key used for generating the MKB has been leaked to a malicious player manufacturer, the malicious player manufacturer is not able to learn the value of the device key KD that is configured by using a secret key, because of the basic characteristics of the public key encrypting method. For this reason, the MKB shown in FIG. 26 may be an MKB that is configured based on a public key encrypting method.

As explained above, according to the fourth embodiment, the encrypted data is stored in the general area, whereas the data that is necessary for decrypting the encrypted data is stored in the special area, so that it is possible to decrypt and utilize the encrypted data by using the data stored in the special area. With this arrangement, it is possible to realize the situation in which the content suppliers are able to revoke the playback devices.

As a fifth embodiment, an example will be explained in which revocation of a controller by using an MKB associated with a content is combined with individualization of encrypted video data for each memory card.

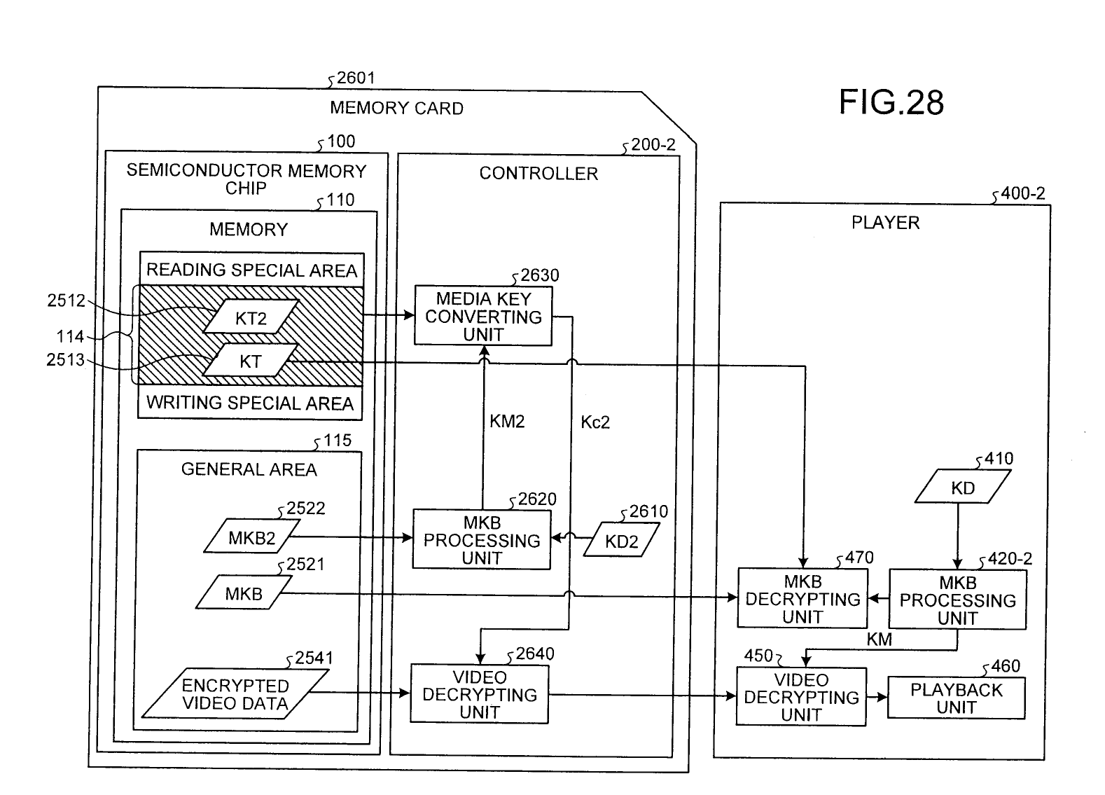

FIG. 28 is a block diagram of an example of configurations of a player 400-2 and a memory card 2601 according to the fifth embodiment.

As shown in FIG. 28, the memory card 2601 includes the semiconductor memory chip 100 and a controller 200-2. The semiconductor memory chip 100 has the same configuration as in the second embodiment or the third embodiment.

According to the fifth embodiment, the encrypted video data 2541, encrypted MKB 2521-2 (hereinafter, the “MKB′”), and an MKB 2522 (hereinafter, the “MKB2”) have been recorded in the general area 115. Also, an MKB decryption key 2513 (hereinafter, the “MKB decryption key KT”) used for obtaining the MKB by decrypting the MKB′, as well as a media key conversion key 2512 (hereinafter, the “media key conversion key KT2”) are stored in the special area (i.e., the common area 114). As explained here, according to the fifth embodiment, instead of the media key conversion key 2511 (i.e., the media key conversion key KT), the MKB decryption key KT used for obtaining the MKB through the decrypting process is provided.

Next, an exemplary configuration of the controller 200-2 will be explained. In addition to the configuration of the controller 200 according to the second embodiment or the third embodiment, the controller 200-2 according to the fifth embodiment includes a device key KD 2610 (hereinafter, the “device key KD2”), an MKB processing unit 2620, a media key converting unit 2630, and a video decrypting unit 2640. The constituent elements that are explained in the second embodiment or the third embodiment are omitted from FIG. 28. It should be noted, however, that the controller 200-2 includes, for example, the encryption key sharing unit 210-2 shown in FIG. 7 and the reading control unit 220-3 shown in FIG. 11A. Further, the reading process to read the MKB decryption key KT and the media key conversion key KT2 that are stored in the reading special area is performed by using the encryption key sharing unit 210-2 and the reading control unit 220-3.

The MKB processing unit 2620 performs MKB processing to derive the media key KM2 by processing, while using the device key KD2, the MKB2 that has been read from the general area 115. The media key converting unit 2630 generates a decryption key Kc2 by converting the derived media key KM2 while using the media key conversion key KT2 that has been read from the special area. The video decrypting unit 2640 decrypts the encrypted video data by using the decryption key Kc2.

Next, an exemplary configuration of the player 400-2 will be explained. The player 400-2 stores therein a device key 410 (hereinafter, the “device key KD”) and includes an MKB processing unit 420-2, the video decrypting unit 450, the playback unit 460, and an MKB decrypting unit 470.

The player 400-2 according to the fifth embodiment is different from the player 400 according to the fourth embodiment in that the MKB decrypting unit 470 is additionally provided, that the MKB processing unit 420-2 has different functions, and that the key decrypting unit 440 and the media key converting unit 430 are eliminated.

The MKB decrypting unit 470 generates the MKB by decrypting the MKB′ that has been read from the general area 115 while using the MKB decryption key KT. The MKB processing unit 420-2 performs MKB processing to derive the media key KM by processing the generated MKB while using the device key KD.

As explained above, according to the fifth embodiment, the two MKBs (i.e., the MKB′ obtained by encrypting the MKB and the MKB2) are recorded in the general area 115. The MKB obtained by decrypting the MKB′ is used for authenticating and revoking the player 400-2 in the same manner as described in the fourth embodiment. In contrast, the MKB2 is used for authenticating and revoking the controller 200.

Further, according to the fifth embodiment, the special area (i.e., the common area 114) stores therein the MKB decryption key KT and the media key conversion key KT2. The MKB decryption key KT is an MKB decryption key for the player 400-2. The media key conversion key KT2 is a media key conversion key for the controller 200. Each of these keys may be different for each memory card 2601. The relationship between the keys and the data can be explained as follows:

(1) When the MKB is processed by using the device key KD that has not been revoked, the media key KM is obtained. Further, when the MKB2 is processed by using the device key KD2 that has not been revoked, the media key KM2 is obtained.

(2) When (plain) video data is expressed as C, whereas encrypted video data is expressed as C′, the video data C is dually encrypted by using the media key KM and the decryption key Kc2. This process can be expressed as follows: C′=AES-E(Kc2, AES-E(KM, C)).

(3) The MKB is obtained by decrypting the MKB′ by using the MKB decryption key KT. This process can be expressed as follows: MKB=AES-D(KT, MKB′).

(4) The decryption key Kc2 is obtained by converting the media key KM2 while using the media key conversion key KT2. This process can be expressed as follows: Kc2=AES-G(KT2, KM2).

(5) The process in which the encrypted video data C′ is decrypted can be expressed as follows:

$$AES - D ( KM , AES - D ( Kc 2 , {C}^{′} ) = AES - D ( KM , AES - D ( Kc 2 , AES - E ( Kc 2 , AES - E ( KM , C ) ) ) ) = AES - D ( KM , AES - E ( KM , C ) ) = C$$

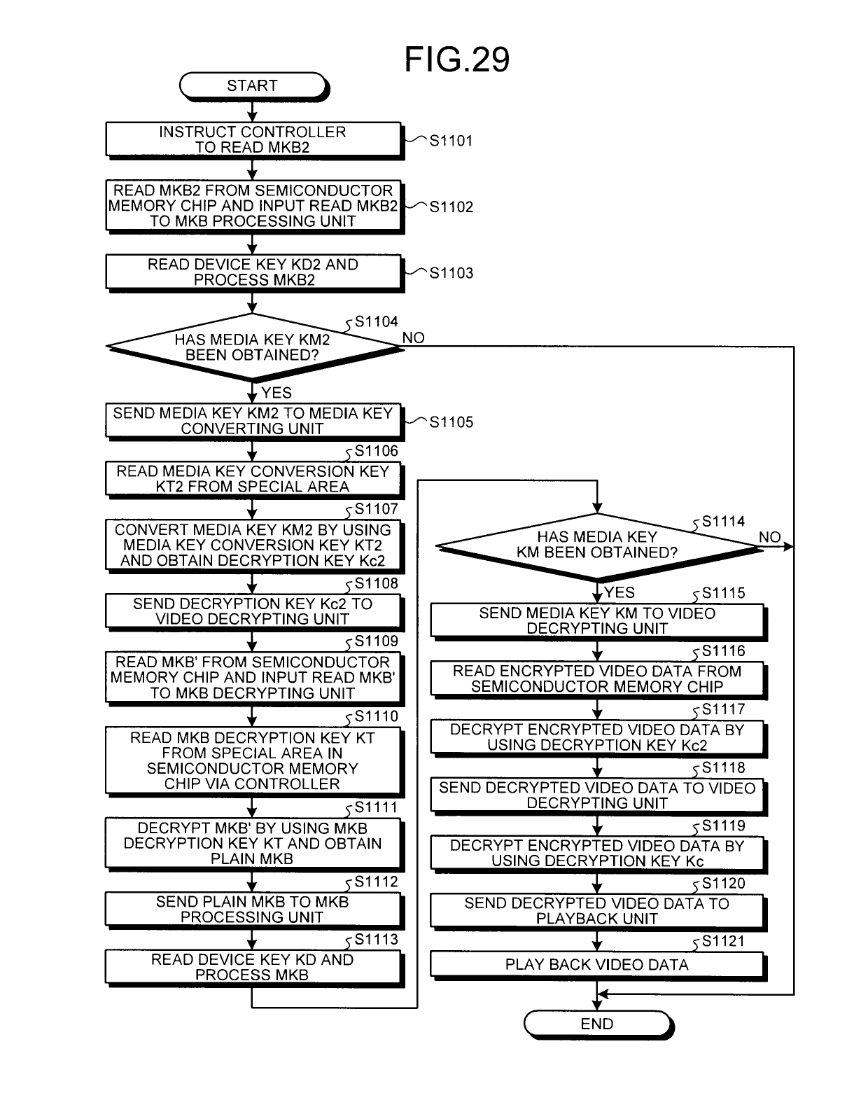

Next, a data playback process that is performed in the memory card 2601 by the player 400-2 configured as shown in FIG. 28 will be explained, with reference to FIG. 29. FIG. 29 is a flowchart of an entire flow in the playback process according to the fifth embodiment.

The player 400-2 instructs the controller 200-2 included in the memory card 2601 to read the MKB2 contained in the general area 115 (step S1101). For example, the player 400-2 provides the controller 200-2 with a designation of the head address and the size of the MKB2.

The controller 200-2 reads the page that includes the designated area from the semiconductor memory chip 100 and inputs the data (i.e., the value of the MKB2) in the designated area to the MKB processing unit 2620 (step S1102). The MKB processing unit 2620 reads the device key KD2 stored in the controller 200-2, performs the MKB processing on the input MKB2 by using the device key KD2, and derives and outputs the media key KM2 (step S1103).

After that, the MKB processing unit 2620 judges whether the media key KM2 has been obtained as a result of the MKB processing (step S1104). In the case where the device key KD has been revoked by the MKB2, the MKB processing unit 2620 is not able to derive the correct media key KM2. In that situation, the MKB processing unit 2620 judges that the media key KM2 has not been obtained (step S1104: No) and outputs an error message.

In the case where the media key KM2 has been obtained (step S1104: Yes), the MKB processing unit 2620 sends the media key KM2 to the media key converting unit 2630 (step S1105). The media key converting unit 2630 reads the media key conversion key KT2 contained in the special area (i.e., the common area 114) (step S1106). After that, the media key converting unit 2630 generates the decryption key Kc2 by converting the media key KM2 while using the read media key conversion key KT2 (step S1107). The media key converting unit 2630 sends the generated decryption key Kc2 to the video decrypting unit 2640 (step S1108). The video decrypting unit 2640 stores therein the value of the decryption key Kc that has been received.

After that, the player 400-2 reads the MKB′ from the general area 115 in the semiconductor memory chip 100 via the controller 200-2 and inputs the read MKB′ to the MKB decrypting unit 470 (step S1109). The MKB decrypting unit 470 reads the MKB decryption key KT from the special area (i.e., the common area 114) in the semiconductor memory chip 100 via the controller 200-2 (step S1110). After that, the MKB decrypting unit 470 decrypts the input MKB′ by using the read MKB decryption key KT and obtains plain MKB (step S1111). The MKB decrypting unit 470 sends the plain MKB to the MKB processing unit 420-2 (step S1112).

The MKB processing unit 420-2 reads the device key KD stored in the player 400-2, performs the MKB processing on the input MKB by using the device key KD, and derives the media key KM (step S1113).

Subsequently, the MKB processing unit 420-2 judges whether the media key KM has been obtained as a result of the MKB processing (step S1114). In the case where the device key KD has been revoked by the MKB, the MKB processing unit 420-2 is not able to derive the correct media key KM. In that situation, the MKB processing unit 420-2 judges that the media key KM has not been obtained (step S1114: No) and outputs an error message. In the case where the media key KM has been obtained (step S1114: Yes), the MKB processing unit 420-2 sends the media key KM to the video decrypting unit 450 (step S1115).

Subsequently, the video decrypting unit 2640 included in the controller 200-2 sequentially reads the pieces of encrypted video data 2541 from the general area 115 (step S1116). The video decrypting unit 2640 decrypts the read encrypted video data by using the decryption key Kc2 stored therein (step S1117). The video decrypting unit 2640 sends the decrypted video data to the video decrypting unit 450 included in the player 400-2 (step S1118).

The video decrypting unit 450 sequentially decrypts the pieces of video data by using the decryption key Kc (step S1119) and sends the decrypted pieces of video data to the playback unit 460 (step S1120). The playback unit 460 sequentially plays back (displays) the received pieces of video data (step S1121).

When the media key conversion key KT2 is different for each memory card 2601, it means that the decryption key Kc2 is also different for each memory card 2601. Accordingly, when the media key KM or the media key conversion key KT2 is different for each memory card 2601, the encrypted video data itself is different for each memory card 2601. In other words, it is possible to individualize the encrypted video data for each memory card 2601.

As explained above, by using the memory chip according to the fifth embodiment, it is possible to combine (in the manner of the dual encrypting process) the revocation of the controller by using the MKB associated with the content (i.e., the revocation of playback devices by the content supplier) with the individualization of the encrypted video data for each memory card (i.e., the revocation of controllers by the content supplier).

In the sections above, exemplary embodiments are applied to the protection of the contents have been explained; however, it is also possible to apply an embodiment to other industrial fields. As a sixth embodiment, an embodiment is applied to a smart grid. The smart grid is a next-generation electric power grid that is structured for the purpose of stabilizing the quality of electric power, when renewable energy such as sunlight or wind power is used together with conventional electric-power generating methods such as nuclear power generation and thermal power generation.

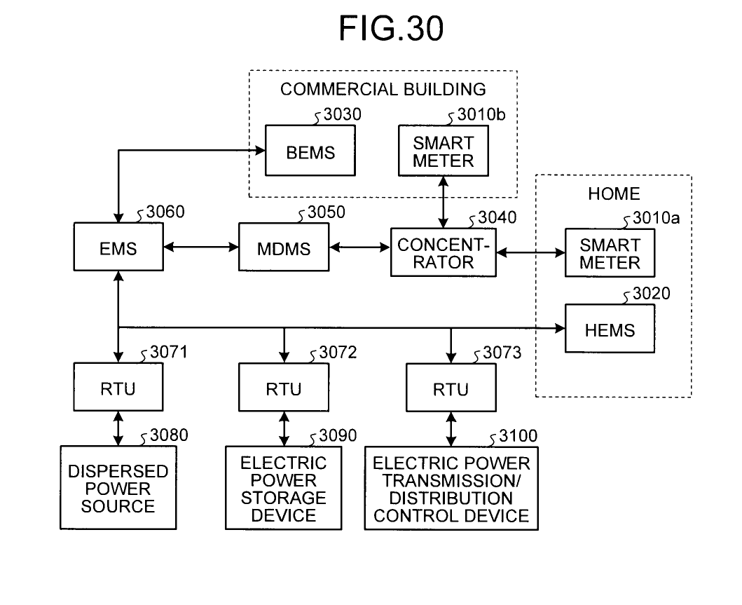

FIG. 30 is a diagram of an exemplary configuration of a next-generation electric power grid according to the sixth embodiment. In the next-generation electric power grid, a meter 3010a that counts an electric power usage amount and a Home Energy Management System (HEMS) 3020 that is a home server that manages electric home appliances are installed at each household. Further, as for commercial buildings, a Building Energy Management System (BEMS) 3030 that is a server that manages electric devices in the building is installed for each of the buildings. For each of the commercial buildings, a meter 3010b that is configured like the meter 3010a is installed. In the following sections, the meters 3010a and 3010b will be simply referred to as the “meters 3010”.

The meters 3010 are organized into groups each made up of a number of meters by relay devices called concentrators (e.g., a concentrator 3040). The meters 3010 communicate with a Meter Data Management System (MDMS) 3050 via a communication network. The MDMS 3050 receives and stores therein electric power usage amounts at predetermined time intervals from the meters 3010 installed at the households. An Energy Management System (EMS) 3060 exercises electric-power control by, for example, requesting the meters 3010 installed at the households and the HEMS 3020 that the electric power consumption should be reduced, based on the electric power usage amounts of a plurality of households that have been gathered in the MDMS 3050 or information collected from sensors that are installed in electric-power systems. Further, the EMS 3060 exercises control to stabilize the voltage and the frequency of the entire grid, by controlling the following elements: a dispersed power source 3080 for solar power generation or wind power generation that is connected to a Remote Terminal Unit (RTU) 3071; an electric power storage device 3090 that is similarly connected to an RTU 3072; and an electric power transmission/distribution control device 3100 that is connected to an RTU 3073 and exercises control over the operation between the power generation side.

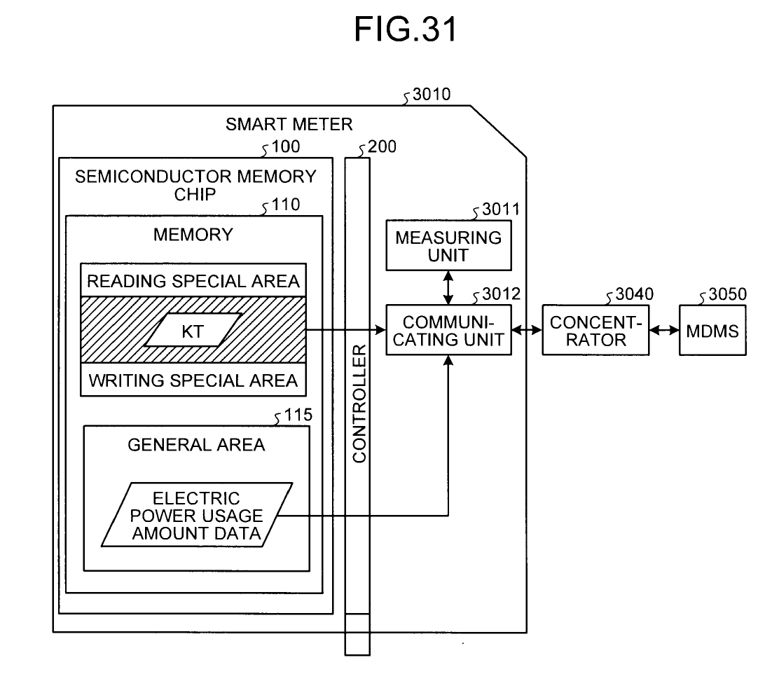

FIG. 31 is a block diagram of an exemplary configuration of the meter 3010. The meter 3010 performs an encrypted communication with the MDMS 3050. Although the concentrator 3040 is present on the communication path, the concentrator 3040 only relays the encrypted communication. The MDMS 3050 and the meter 3010 each store therein the common key K and perform the encrypted communication by using the common key K.

For example, a communicating unit 3012 connected to a measuring unit 3011 encrypts a measured value by using the common key K and sends the encrypted measured value to the MDMS 3050. The MDMS 3050 decrypts the encrypted measured value by using the common key K stored therein. With this arrangement, even if the communication is intercepted on the communication path, the person who intercepts the communication is not able to learn the measured value. As another example, there are situations in which the MDMS 3050 sends a control-purpose command to the measuring unit 3011. The command is, for example, a control command that is used for instructing that a measuring process should be canceled or started or that measured data should be sent. The MDMS 3050 encrypts the control command by using the common key K and transmits the encrypted control command to the communicating unit 3012 included in the meter 3010. The communicating unit 3012 decrypts the encrypted control command by using the common key K and sends the control command to the measuring unit 3011. As yet another example, electric power usage amount data is stored in the general area in the memory 110 included in the semiconductor memory chip 100, so that the communicating unit 3012 encrypts the electric power usage amount data by using the common key K and transmits the encrypted electric power usage amount data to the MDMS 3050. The MDMS 3050 decrypts the encrypted electric power usage amount data by using the common key K.

In the meter 3010, the common key K is stored in the special area in the memory included in the semiconductor memory chip. It is desirable if the common key K is updated regularly or occasionally. An update-purpose common key will be referred to as K′. The MDMS 3050 writes the update-purpose common key K′ into the writing special area in the memory 110 included in the semiconductor memory chip 100. To realize this configuration, the semiconductor memory chip 100 needs to be authenticated by the MDMS 3050, as explained above. In addition, in order for the communicating unit 3012 included in the meter 3010 to be able to read the (updated) common key K′ via the controller 200, the controller 200 needs to be authenticated by the semiconductor memory chip 100. Through the common key updating process and the utilization of the updated common key, the entirety of the meter 3010 that uses the semiconductor memory chip 100 is, as a result, authenticated by the MDMS 3050.

Serving as, for example, the writing device 300 shown in FIG. 14, the MDMS 3050 writes the update-purpose common key K′ into the writing special area in the semiconductor memory chip 100. Further, the controller 200 included in the meter 3010 includes, for example, the encryption key sharing unit 210-2 shown in FIG. 7 and the reading control unit 220-2 shown in FIG. 9.

As explained above, according to the sixth embodiment, it is possible to prevent illegitimate use of data such as the data used in the next-generation electric power grid, which is in a different field from that of the protection of the contents.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A writing device connected to a memory chip that has a memory including a first area that is a predetermined data storage area, the writing device comprising:
a storage unit that store data to be written into the first area;
a first encryption key generating unit that receives first key information stored in the memory and generates a first key by using the first key information; and
a data transmitting unit that transmits, to the memory chip, first encrypted data obtained by encrypting the data using the first key, wherein
the first encrypted data is converted by using a second key that is stored in the memory chip and that corresponds to the first key, and is written into the first area.

2. An information storing system in which a reading device and a writing device are connected to a memory chip that has a memory, wherein
the writing device comprises:
a storage unit that store data to be written into the first area;
a first encryption key generating unit that receives first key information stored in the memory and generates a first key by using the first key information; and
a data transmitting unit that transmits, to the memory chip, first encrypted data obtained by encrypting the data using the first key, and
the memory chip comprises:
the memory including a first area that is a predetermined data storage area;
a converting unit that receives the first encrypted data and converts the first encrypted data by using a second key that corresponds to the first key stored in the writing device;
a writing unit that writes the data converted into the first area;
a second encryption key generating unit that receives second key information stored in the reading device and generates a third key; and
a sending unit that transmits, to the reading device, second encrypted data obtained by encrypting data stored in the first area using the third key, and
the reading device receives the second encrypted data and decrypts the second encrypted data by using a fourth key that is stored in the reading device and that corresponds to the third key.

3. The information storing system according to claim 2, wherein
the reading device is incorporated in a meter data management system, and
the memory chip and the writing device are incorporated in a meter.

4. A memory chip connected to a writing device that transmits data and to a reading device that receives data, the memory chip comprising:
a memory including a first area that is a predetermined data storage area;
a second encryption key generating unit that receives second key information stored in the reading device and generates a third key; and
a sending unit that transmits, to the reading device, second encrypted data obtained by encrypting data stored in the memory using the third key, wherein
the second encrypted data is received by the reading device and is decrypted by using a fourth key that is stored in the reading device and that corresponds to the third key.

5. A memory chip connected to a controller that controls reading and writing of data in response to a request from an external device, the memory chip comprising:
a memory including a first area that is a predetermined data storage area;
a key storage unit that stores therein a public key that corresponds to a secret key used by the external device to convert the data;
a converting unit that receives data to be written into the first area from the controller and generates converted data by converting the data to be written using the public key; and
a writing unit that writes the converted data into the first area.
